(19) United States
(12) Patent Application Publication
(10) Pub. No.: US 2021/0092981 A1
(43) Pub. Date: Apr. 1, 2021

(54) SUGAR REDUCED PRODUCTS AND METHOD OF PRODUCING THEREOF

(71) Applicant: Commonwealth Scientific and Industrial Research Organisation, Acton (AU)

(72) Inventors: Mary Ann AUGUSTIN, Victoria (AU); Netsanet SHIFERAW TEREFE, Victoria (AU); Mya Myintzu HLAING, Victoria (AU)

(21) Appl. No.: 15/733,172

(22) PCT Filed: Dec. 7, 2018
(86) PCT No.: PCT/AU2018/051316

§ 371 Date: Jun. 3, 2020

(30) Foreign Application Priority Data
Dec. 7, 2017 (AU) 2017904938

(51) Int. Cl. A23L 2/84; A23L 2/02; A23L 5/20; A23L 5/30; A23L 33/135; A23L 2/60; A23L 33/16; A23L 33/125; A23L 27/12

(52) U.S. Cl. CPC A23L 2/84; A23V 2002/00; A23L 5/25; A23L 5/34; A23L 33/135; A23L 2/60; A23L 33/16; A23L 33/125; A23L 27/12; C12Y 204/0114; C12Y 204/0101; C12Y 204/01009; C12Y 204/01005; C12Y 101/01255; C12Y 302/01023; A23Y 2260/35; A23L 2/02

(57) ABSTRACT

The present invention relates to methods of producing a sugar reduced product from biomass comprising treating the biomass with fermentation enzymes. In an embodiment, treating with fermentation enzymes comprises fermentation. The present invention also relates to sugar reduced products produced by such methods and methods of producing fermentation enzymes.

### FIELD OF THE INVENTION

The present invention relates to methods of producing a sugar reduced product from biomass comprising treating the biomass with fermentation enzymes. In an embodiment, treating with fermentation enzymes comprises fermentation. The present invention also relates to sugar reduced products produced by such methods and methods of producing fermentation enzymes.

### BACKGROUND OF THE INVENTION

Fruit and vegetable juices are increasing in popularity in the global market. Traditionally, fruit and vegetable juices are considered healthy beverages, as they provide nutrients such as vitamins, minerals and phytochemicals. Some types of fruit juices like pomegranate juice, blueberry juice, and orange juice, etc. are rich sources of antioxidant phytochemicals. It is also reported that drinking fruit juices is also associated with reduced incidence of certain types of cancer and other chronic diseases. For instance, red grape juice contains flavonoids and resveratrol, which are associated with reduced gastric carcinoma risk in women, and reduced aerodigestive tract cancer risk in smokers (Scalbert et al., 2005).

However, the perception that fruit juices are healthy is gradually changing owing to the high sugar (mainly fructose) content of fruit juices. This has led to a decline in the consumption of fruit juices in western countries in recent decades (Gose et al., 2016; Rehm et al., 2016; Ridoutt et al., 2016). The sugar content of fruit juice is the same as, or even higher than soft drinks. For instance, comparing the calories and sugar content of 350 ml portion of Coca Cola and apple juice, Coca Cola contains 140 calories and 40 grams of sugar (10 teaspoons), while apple juice contains more calories (165 calories) and 39 grams of sugar (Gunners, 2016). The consumption of fruit juices loaded with high amounts of calorie and sugar content provide low satiety and have a high potential to lead to high energy intake, which has been associated with increased risk of chronic diseases, such as type II diabetes, obesity and cardiovascular diseases (Mattes and Campbell, 2009; Malik et al., 2010).

Manufacturers and marketers usually overemphasize the benefits of fruit and vegetable juices to human health neglecting to mention that juices have very high sugar content, often higher than sweetened soft drinks. Even 100% fruit juices without extra added sweeteners can contain up to 140 g sugars per litre (USDA, National Nutrient Database for Standard Reference Release). The traditional approach to produce functional commercial fruit and/or vegetable beverages is to add functional ingredients like oligosaccharides into the food matrix. However, in this way, oligosaccharides need to be produced, separated and purified before addition to the beverages, which incurs more production cost and additional energy input (Da Silva et al., 2014). Sugars can be reduced in plant based products such as fruit and vegetable juices by separation technologies such as membrane or chromatography processes. For example, fructose can be reduced via membrane or chromatography based separation processes to produce low sugar and hence low calorie products such as juices. However, such technologies may lead to the unintended removal of vitamins and phytochemicals, potentially reducing the nutritional quality of the product. Other approaches include removal of the simple sugars in the fruit by solvent extraction (EP 2 796 058) or dilution of the juice and addition of artificial sweeteners (U.S. Pat. No. 7,037,539).

Thus, there is a requirement for new processes to reduce the sugar content of plant based products, such as fruit and/or vegetable beverages.

### SUMMARY OF THE INVENTION

The present inventors have developed methods of preparing a sugar reduced product from biomass and the products produced by such methods.

In an aspect, the present invention provides a method of preparing a sugar reduced product from a biomass comprising:

i) treating the biomass with fermentation enzymes to reduce the sugar concentration; and

ii) post-treating the material obtained by step i) to further reduce the sugar concentration.

In an embodiment, step i) comprises fermentation of the biomass with one or more bacteria selected from lactic acid, acetic acid, propionic acid and bifido bacteria.

In an embodiment, the lactic acid bacteria is from one or more of the Genera Lactobacillus, Leuconostoc, Pediococcus, Lactococcus, Streptococcus, Aerococcus, Carnobacterium, Enterococcus, Oenococcus, Fructobacillus, Sporolactobacillus, Tetragenococcus, Vagococcus and Weissella.

In an embodiment, the acetic acid bacteria is Acetobacteraceae.

In an embodiment, the concentration of an oligosaccharide is increased in the material obtained by step ii) compared to the biomass.

In an embodiment, the concentration of a polysaccharide is increased in the material obtained by step ii) compared to the biomass.

In an embodiment, the sugar in the material obtained in step i) is reduced by at about 10 to about 70% compared to the biomass.

In an embodiment, the sugar in the material obtained in step ii) is reduced by about 5 to about 50% compared to the sugar in the material obtained in step i). In an embodiment, the sugar in the material obtained by step ii) is reduced by at least 30%, or at least 40%, or at least 50%, or at least 60% compared to the biomass.

In an aspect, the present invention provides a method of preparing a sugar reduced product from carrot biomass comprising treating the biomass with fermentation enzymes to reduce the sugar concentration and increase the carotenoid concentration. In an embodiment, the fermentation enzymes are from Leuconostoc mesenteroides or Lactobacillus gasseri. In an embodiment, treating with fermentation enzymes comprises fermentation.

In an aspect, the present invention provides a method of preparing fermentation enzymes for reducing the sugar concentration of a biomass comprising:

i) inoculating the biomass with one or more bacteria selected from: lactic acid, acetic acid, propionic acid and bifido bacteria which have previously been cultured in biomass,

ii) fermenting for a sufficient time for fermentation enzymes to be produced,

iii) removing the bacteria or isolating fermentation enzymes secreted by the bacteria.

In an aspect, the present invention provides a sugar reduced product produced by the method as described herein.

In an aspect, the present invention provides a low calorie sweetener produced by the method as described herein.

Any embodiment herein shall be taken to apply mutatis mutandis to any other embodiment unless specifically stated otherwise. For instance, as the skilled person would understand examples of sugars reduced by the above for the methods of the invention equally apply to products of the invention.

The present invention is not to be limited in scope by the specific embodiments described herein, which are intended for the purpose of exemplification only. Functionally-equivalent products, compositions and methods are clearly within the scope of the invention, as described herein.

Throughout this specification, unless specifically stated otherwise or the context requires otherwise, reference to a single step, composition of matter, group of steps or group of compositions of matter shall be taken to encompass one and a plurality (i.e. one or more) of those steps, compositions of matter, groups of steps or group of compositions of matter.

The invention is hereinafter described by way of the following non-limiting Examples and with reference to the accompanying figures.

### BRIEF DESCRIPTION OF THE ACCOMPANYING DRAWINGS

FIG. 1 Shows the effect of apple juice concentration on the extent of sugar conversion during 24 hours of fermentation.

FIG. 2 Shows the effect of initial fermentative pH on the extent of sugar conversion during 24 hour apple juice fermentation.

FIG. 3 Shows the effect of nitrogen source addition on sugar conversion in apple juice fermentation.

FIG. 4 Shows the effect of different phosphate concentrations on sugar conversion during apple juice fermentation.

FIG. 5 Shows the effects of CaCl₂ and maltose on sugar conversion during 24 hour apple juice fermentation.

FIG. 6 Shows the effect of apple juice concentration in the secondary inoculum on sugar conversion during 24 hour apple juice fermentation.

FIG. 7 Shows the effect of the comparison of Leuconostoc mesentroides strains ATCC 8293 and NRRL B-512F on sugar conversion in apple juice during 24 hour apple juice fermentation process under the same condition.

FIG. 8 Shows the effect of different types of nutrient sources (including phosphate) addition on sugar conversion during apple juice fermentation under the same fermentative conditions.

FIG. 9 A) Shows the effects of fermentation time on sucrose reduction during apple juice fermentation at different conditions. B) Shows the effects of fermentation time on total sugar reduction during apple juice fermentation at different conditions.

FIG. 10 Shows the effects of fermentation time on mannitol production during apple juice fermentation at different conditions.

FIG. 11 A) Shows the effect of apple juice concentrations on cell growth rate during fermentation. B) Shows the effect of extra nutrient source (including phosphate) addition on cell growth rate during fermentation.

FIG. 12 A) Shows the effect of apple juice concentration on relative changes in titratable acidity of apple juice after 24 hour fermentation under the same conditions. B) Shows the effects of different types of extra nutrient sources and phosphate on titratable acidity of 13° Brix apple juice samples after 24 hour fermentation.

FIG. 13 Shows the activities of levansucrase (right bars) and dextransucrase (left bars) in apple juice samples fermented at different conditions.

FIG. 14 A) Shows a contour plot describing the effects of juice concentration and fermentation temperature on the activity of dextransucrase in fermented apple juice samples at pH 7. B) Shows a contour plot describing the effects of juice concentration and fermentation temperature on the activity of levansucrase in fermented apple juice at pH 7.

FIG. 15 Shows the effects of post-fermentation microwave (left) and conventional heating treatment (right) on total reduction in selected apple juice samples fermented at different conditions.

FIG. 16 Shows the effects of post-fermentation microwave treatment time on total sugar reduction in 39° Brix apple juice sample fermented at pH 6 and 30° C.

FIG. 17 Shows the relative effects of fermentation and post-fermentation microwave processing on total sugar reduction in 39° Brix apple juice fermented at pH 6 and 30° C.

FIG. 18 A) Shows a change in sugar profile of carrot puree after sterilisation and fermentation with Leu. mesenteroides (C15) for 13.8 hrs. B) Shows total sucrose, sugar reduction and mannitol formation in carrot puree samples after fermentation with different Leu. meseneteroides isolates.

FIG. 19 Shows the effect of fermentation (at initial pH ˜4.0, natural pH of the juice) followed by high pressure processing (HPP) for 15 minutes on sugar content of cloudy apple juice concentrate (21° Brix).

FIG. 20 Shows the effect of fermentation (at initial pH 4.0) and post-processing by high pressure processing (HPP), ultrasound processing and microwave processing on the concentration of sugar alcohols in cloudy apple juice concentrate (21° Brix).

FIG. 21 Shows the effect of fermentation (initial pH ˜6.0) followed by high pressure processing (HPP) on sugar content of cloudy apple juice concentrate (21° Brix).

FIG. 22 Shows the effect of fermentation (initial pH 6.0) and post-processing by high pressure processing (HPP), ultrasound processing and microwave processing on the concentration of sugar alcohols in cloudy apple juice concentrate (21° Brix).

FIG. 23 Shows the HPLC profile of cloudy apple juice concentrate fermented at pH 6.0 and post-processed by ultrasound (40 kHz, ˜0.02 kW/L). Bottom line shows the fermentation only. Top line shows fermentation and post-processing.

FIG. 24 Shows the effect of fermentation (initial pH ˜6.0) followed by high pressure processing (HPP) on sugar content of cloudy apple juice concentrate (21° Brix) with 0.3% yeast extract.

FIG. 25 Shows the effect of fermentation (initial pH 6.0) and post-processing by high pressure processing (HPP), ultrasound processing and microwave processing on the concentration of sugar alcohols in cloudy apple juice concentrate (21° Brix) with 0.3% yeast extract.

FIG. 26 Shows the effect of fermentation (initial pH ˜6.0) followed by high pressure processing (HPP) on sugar content of cloudy apple juice (10° Brix) with 0.3% yeast extract.

FIG. 27 Shows the effect of fermentation (initial pH 6.0) and post-processing by HPP, ultrasound and microwave on the concentration of sugar alcohols in cloudy apple juice (10° Brix) with 0.3% yeast extract.

FIG. 28 Shows the effect of fermentation (initial pH ˜6.0) followed by high pressure processing (HPP) on sugar content of cloudy apple juice concentrate (21° Brix) with 0.3% yeast extract and 2% maltose.

FIG. 29 Shows the effects of high pressure processing (HPP) on the activity of dextransucrase in fermented apple juice samples.

FIG. 30 Shows the effects of high pressure processing (HPP) on the activity of levansucrase in fermented apple juice samples.

FIG. 31 Shows the cell growth rate with (right) and without nitrogen source (left) in carrot juice.

FIG. 32 A) Compares sugar reduction during 24-hour fermentation under different fermentation temperature and different strains. B) Compares sugar reduction during 24-hour fermentation at 30° C. of carrot juice at different juice concentrations with two L. gasseri strains.

FIG. 33 A) Compares sugar reduction in carrot juice during 24-hour fermentation under transient aerobic and anaerobic conditions during fermentation by L. gasseri DSM 20604 and DSM 20077. B) Shows the polysaccharide concentration in fermented and unfermented carrot juice.

FIG. 34 A) Shows the SEC-HPLC profile of total sugar composition of unfermented concentrated carrot juice, 20604 fermented concentrated carrot juice and 20077 fermented concentrated carrot juice respectively. Samples were fermented at 30° C. B) Shows SEC-HPLC profile of total sugar composition of unfermented straight carrot juice, 20604 fermented straight carrot juice and 20077 fermented straight carrot juice. Samples were fermented at 30° C.

FIG. 35 A) Shows SEC-HPLC profile of polysaccharides of unfermented concentrated carrot juice, 20604 fermented concentrated carrot juice and 20077 fermented concentrated carrot juice. Fermentation was conducted at 30° C. B) Shows the proportion of polysaccharides in the samples within different retention time ranges and hence molecular weight ranges.

FIG. 36 A) Shows the reference Raman spectra of main polysaccharides. B) Shows the Raman spectra of unfermented and fermented carrot juice and concentrate samples.

FIG. 37 A) Shows the PCA scores scatter plots comparing fermented carrot juice with control. B) Shows the PCA loadings plots of unfermented straight and concentrated samples, fermented straight and concentrated samples by 20604 and fermented straight and concentrated samples by 20077.

FIG. 38 A) Shows reference Raman spectra for carotenoids and polysaccharides. B) Shows the Raman spectra of unfermented and fermented samples.

FIG. 39 A) Shows the PCA scatter plot and PCA loading plots of unfermented straight and concentrated samples, fermented straight and concentrated samples by 20604 and fermented straight and concentrated samples by 20077. B) Shows the PCA scatter plot and PCA loading plots of (fermented) concentrated juice.

FIG. 40 Shows the relative changes in titratable acidity of carrot juice after 24-hour fermentation at 30° C.

FIG. 41 Shows the total sugar reduction after 30 sec and 60 sec microwave treatment of fermented carrot juice.

### DETAILED DESCRIPTION

### General Techniques and Definitions

Unless specifically defined otherwise, all technical and scientific terms used herein shall be taken to have the same meaning as commonly understood by one of ordinary skill in the art (e.g., inoculum).

The term “and/or”, e.g., “X and/or Y” shall be understood to mean either “X and Y” or “X or Y” and shall be taken to provide explicit support for both meanings or for either meaning.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

As used herein, the term “about”, unless stated to the contrary, refers to +/−10%, more preferably +/−5%, even more preferably +/−1%, of the designated value.

As used herein “sugar” refers to a sweet soluble carbohydrate. In an embodiment, the sugar is a monosaccharide and/or a disaccharide. In an embodiment, sugar comprises one or more or all of sucrose, glucose and fructose. In an embodiment, sugar further comprises one or more or all of xylose, arabinose, mannose and lactose.

As used herein “total sugar” refers to the combination of sucrose, glucose and fructose. In an embodiment, total sugar may also comprise one or more of xylose, arabinose, mannose and lactose. In an embodiment, when the biomass is animal milk and the total sugar comprises lactose.

As used herein “oligosaccharide” refers to a saccharide polymer comprising three to ten monosaccharides. Oligosaccharides are considered functional food ingredients and can be a pre-biotic (Dominguez et al., 2014).

As used herein “polysaccharide” refers to a saccharide polymer comprising more than ten monosaccharides. For example, but not limited, to dextran, levan and/or inulin type fructans.

As used herein “pre-biotic” refers to a non-viable food component that confers a health benefit to the host associated with the modulation of the microbiota in the gastrointestinal tract (Piñeiro et al., 2008). As used herein, a “pre-biotic oligosaccharide” or “pre-biotic polysaccharide” refers to an oligosaccharide or polysaccharide” that confers a health benefit to the host associated with the modulation of the microbiota in the gastrointestinal tract.

As used herein “pro-biotic” refers to a food product or supplement comprising a microorganism, for example a bacteria that confers a health benefit to host. For example, the bacteria may aid the digestion of a particular macromolecule.

As used herein “Brix” or “Brix value” refers to the sugar content of an aqueous solution. In an embodiment, “1° Brix” or “1° Bx” or “one degree Brix” is 1 gram of sucrose in 100 grams of solution. In an embodiment, a solution with “1° Brix” or “1° Bx” or “one degree Brix” comprises 1% total soluble solids.

As used herein “increase” or “increased” means that the level of an indicated component (e.g. sugar, an oligosaccharide or polysaccharide) is higher than that present in a material before a step in the method commenced. In an embodiment, the material is the biomass. In an embodiment, the material is the material from step i). In some embodiments, the indicated component may not be present in the material and increased means that it is now present. In an embodiment, the level of the indicated component is increased from about 5% to about 100%. In an embodiment, the level of the indicated component is increased by about 5%. In an embodiment, the level of the indicated component is increased by about 10%. In an embodiment, the level of the indicated component is increased by about 15%. In an embodiment, the level of the indicated component is increased by about 20%. In an embodiment, the level of the indicated component is increased by about 30%. In an embodiment, the level of the indicated component is increased by about 40%. In an embodiment, the level of the indicated component is increased by about 50%. In an embodiment, the level of the indicated component is increased by about 60%. In an embodiment, the level of the indicated component is increased by about 70%. In an embodiment, the level of the indicated component is increased by about 80%. In an embodiment, the level of the indicated component is increased by about 90%. In an embodiment, the level of the indicated component is increased by about 100%.

As used herein “reduced” means that the level of an indicated component (e.g. sugar) in a material is lower than was present in the material before a step in the method commenced. In an embodiment, the level of the indicated component is reduced from about 5% to about 100% (e.g. in some embodiments sorbitol is reduced 100% by post-treating). In an embodiment, the level of the indicated component is reduced from about 5% to about 90%. In an embodiment, the level of the indicated component is increased by about 5%. In an embodiment, the level of the indicated component is reduced by about 10%. In an embodiment, the level of the indicated component is reduced by about 15%. In an embodiment, the level of the indicated component is reduced by about 20%. In an embodiment, the level of the indicated component is reduced by about 30%. In an embodiment, the level of the indicated component is reduced by about 40%. In an embodiment, the level of the indicated component is reduced by about 50%. In an embodiment, the level of the indicated component is reduced by about 60%. In an embodiment, the level of the indicated component is reduced by about 70%. In an embodiment, the level of the indicated component is reduced by about 80%. In an embodiment, the level of the indicated component is reduced by about 90%. In an embodiment, the level of the indicated component is reduced by about 100%.

### Biomass

A person skilled in the art will appreciate that the biomass suitable for the methods of preparing a sugar reduced product as described herein may be any biomass comprising one or more or all of sucrose, glucose, fructose and lactose. In an embodiment, the biomass does not comprise one or more or all of: i) mannitol, ii) dextran, iii) isomaltose and iv) isomaltotriose. In an embodiment, the biomass may also comprise one or more or all of xylose, arabinose and mannose.

In an embodiment, the biomass comprises one or more or all of: plant, fungal, animal milk, animal milk concentrate, eukaryotic and bacterial material.

In an embodiment, the biomass comprises plant material. The plant material can be from one or more sources.

In an embodiment, the plant material is selected from one or more or all of: fruit, vegetable, nut, legume and grass.

In an embodiment, the fruit is selected from one or more or all of: a simple, aggregate and multiple fruit. In an embodiment, the fruit is from one or more family/families selected from: Arecaceae, Myrtaceae, Rosaceae, Musaceae, Ericaceae, Saxifragaceae, Cucurbitaceae, Nightshade, Capparaceae, Adoxaceae, Vitaceae, Rutaceae, Actinidiaceae, Sapindaceae, Anacardiaceae, Moraceae, Oleaceae, Cactaceae, Passifloraceae, Bromeliaceae, Cactaceae, Lythraceae, Polygonaceae, Oxalidaceae and Caesalpinioideae.

In an embodiment, the family is Rosaceae, preferably an apple.

In an embodiment, the fruit is selected from one or more or all of: apple, apricot, avocado, banana, bilberry, blackberry, blackcurrant, blueberry, coconut, currant, cherry, cherimoya, clementine, cloudberry, damson, durian, elderberry, fig, feijoa, gooseberry, grape, grapefruit, orange, guava, huckleberry, jackfruit, jambul, jujube, kiwifruit, kumquat, lemon, lime, loquat, lychee, mandarin, mango, melon, cantaloupe, honeydew, watermelon, nectarine, orange, passionfruit, paw paw, peach, pear, plum, plumcot, pineapple, pomegranate, pomelo, purple mangosteen, raspberry, rambutan, redcurrant, satsuma, star fruit, strawberry, tangerine, tomato, and ugli fruit.

In an embodiment, the fruit is apple. In an embodiment, the variety of apple is selected from one or more or all of: royal gala, golden delicious, red delicious, fuji, cripps pink (pink lady), granny smith, jonathan, jonagold, jazz, sundowner, and braeburn.

In an embodiment, the fruit is grape. In an embodiment, the variety of grape is selected from one or more or all of: concord, crimson seedless, menindee seedless, niagara, red globe and thompson seedless.

In an embodiment, the fruit is orange. In an embodiment, the variety of orange is selected from one or more or all of: arnold blood, bali, belladonna, bergamont, berna, biondo comune, biondo riccio, byeonggyul, cadanera, cara cara, carvalhal, castellana, cherry orange, clanor, clementine, dom Joao, fukuhara, gardner, hamlin, homosassa, jaffa orange, joppa, khettmali, kona, lima (acidless orange), lue gim gong, macetera, malta, maltaise blonde, maltaise ovale, marrs, medan, midsweet, moro tarocco, navel, navelina, newhall, parson brown, pera, pera coroa, pera natal, pera rio, pineapple, pontianak, premier, rhode red, roble, queen, salustiana, sanguine (blood orange), sathgudi, seleta, seville (bitter orange), shamouti masry, sunstar, tomango, valencia, verna, vicieda, washington, and westin. In an embodiment, the variety of orange is selected from one or more or all of: navel, valencia, clementine, hamlin, salustiana, sanguine (blood orange), bergamont, and cara cara.

In an embodiment, the vegetable is from one or more family/families selected from: Brassicaceae, Amarylidaceae, Asparagaceae, Polygonaceae, Compositae, Amaranthaceae, Chenopodiacae, Cucurbitaceae, Leguminosae, Malvaceae, Convolvulaceae, Solanaceae and Umbelliferae.

In an embodiment, the Brassicaceae is selected from one or more or all of: wild cabbage, cabbage, bok choy, napa cabbage, rutabaga, turnip, kai-lan, collard greens, jersey cabbage, ornamental kale, kale, lacinato kale, perpetual kale, marrow cabbage, tronchuda kale, brussels sprout, kohlrabi, broccoli, broccoflower, Broccolini, bittercress, candytuft, charlock, horseradish, Kerguelen cabbage, pennycress, radish, rocket, rose of Jericho, sea kale, sea rocket, shepherd's purse, sweet alyssum, thale cress, watercress, white mustard, whitlow grass, wild radish, woad, and yellow cress.

In an embodiment, the Amarylidaceae is selected from one or more or all of: chives, garlic, leeks, onion, and shallot.

In an embodiment, the Asparagaceae is asparagus.

In an embodiment, the Polygonaceae is selected from one or more or all of: buckwheat, garden sorrel and rhubarb.

In an embodiment, the Compositae is selected from one or more or all of: artichoke, chamomile, chicory, dandelion, endive, jerusalem artichoke, lettuce, romaine, safflower salsify and sunflower.

In an embodiment, the Amaranthaceael Chenopodiacae is selected from one or more or all of: amaranth, beet, chard, lamb's-quarters, quinoa, spinach and/or sugar beet. In an embodiment, the Cucurbitaceae is selected from cucumber, pumpkin, squash and zucchini.

In an embodiment, the Leguminosae is selected from one or more or all of: alfalfa, beans, carob, chickpea, green beans, jicama, lentil, pea, peanut, and soy. In an embodiment, the Malvaceae is selected from one or more or all of: cacao, cotton and okra. In an embodiment, the Convolvulaceae is sweet potato.

In an embodiment, the Solanaceae is selected from one or more or all of: bell pepper, italian pepper, chile pepper, eggplant, potato, tomato and tomatillo.

In an embodiment, the Umbelliferae is selected from one or more or all of: caraway, carrot, celery, cilantro, cumin, dill, fennel, parsley and parsnip. In an embodiment, the Umbelliferae is carrot. In an embodiment, the variety of carrot is selected from one or more or all of: nantes (e.g. stepfano, navarre, scarlet, bolero, nelson, yaya, napa, touchon, parano, white satin, merida, purple dragon, cosmic purple), imperator (e.g. red hot, cellbunch), autumn king (majestic red) and chantenay (e.g. royal chantenay, red-cored chantenay and hercules).

In an embodiment, the biomass is a legume. In an embodiment, the legume is from the family Fabaceae. In an embodiment, the Fabaceae is selected from one or more or all of: soybean, beans, lentils, and lupin. In an embodiment, the Fabaceae is soybean.

In an embodiment, the biomass is a grass. In an embodiment, the grass is from the family Poaceae. In an embodiment, the grass is selected from one or more or all of: bamboo, lemongrass, sugarcane, corn and wheatgrass.

In an embodiment, the vegetable is selected from one or more or all of: carrot, beetroot, sugarbeet, sweetcorn, sweet potato, red peppers, butternut squash, and yam.

The plant material may be any part of a plant, including, but not limited to leaves, stems, flowers, florets, seeds and roots. In an embodiment, the plant material is juice, juice concentrate, puree, reconstituted fruit or vegetable powder, rehydrated dried fruit pieces, sugary fraction of fruit and vegetable processing, milk, milk concentrate, whey, permeate, retentate, juice, juice concentrate, puree, whole or chopped.

In an embodiment, the plant material is milk. In an embodiment, the plant material is milk concentrate. In an embodiment, the plant material is whey. In an embodiment, the whey is from tofu processing. In an embodiment, the plant material is permeate. In an embodiment, the plant material is retentate (e.g. sugar fractions such as fructose from membrane processing to reduce the sugar content of fruit or vegetable juice). In an embodiment, the retentate is from plant milk. In an embodiment, the retentate is from one or more of: soy milk, almond milk or rice milk. In an embodiment, the permeate is from one or more or all of: soy, nut, oat, sunflower seed permeate and permeate from tofu processing. In an embodiment, the plant material is juice. In an embodiment, the plant material is juice concentrate. In an embodiment, the plant material is puree. In an embodiment, the plant material is fruit piece.

In an embodiment, the biomass comprises animal milk and/or animal milk concentrate. In an embodiment, the biomass comprises a product produced from animal milk and/or animal milk concentrate, for example, whey or milk permeate.

In an embodiment, the animal milk is from a mammal selected from one or more or all of: cow, goat, camel, sheep, buffalo. In an embodiment, the biomass is milk from a mammal (e.g. cow, goat, camel, sheep, buffalo) optionally mixed with vegetable and/or fruit. In an embodiment, the biomass is a product produced from animal milk, permeate produced from mammal milk or whey.

In an embodiment, the juice concentrate or milk concentrate comprises about 15° Brix to about 60° Brix. In an embodiment, the juice or milk concentrate comprises about 20° Brix to about 50° Brix. In an embodiment, the juice or milk concentrate comprises about 25° Brix to about 45° Brix. In an embodiment, the juice or milk concentrate comprises about 30° Brix to about 40° Brix.

In an embodiment, the biomass is about 5% to about 30% juice. In an embodiment, the biomass is about 10% juice. In an embodiment, the biomass is about 15% juice. In an embodiment, the biomass is about 20% juice.

### Fermentation

In an embodiment, treating the biomass with fermentation enzymes to reduce the sugar concentration as described in step i) comprises fermentation of the biomass with one or more bacteria. The fermentation method as described herein may comprise addition to the biomass of one or more bacteria selected from lactic acid, acetic acid, propionic acid and bifido bacteria capable of producing fermentation enzymes as described herein.

As used herein “fermentation” refers to the biochemical breakdown of the biomass as described herein by one or more bacteria. In an embodiment, the one or more bacteria are selected from lactic acid, acetic acid, propionic acid and bifido bacteria. As used herein “lactic bacteria” or “lactic acid bacteria” are bacteria that produce lactic acid as the main product of carbohydrate fermentation. In an embodiment, the lactic acid bacteria also produce acetic acid. As used herein “acetic bacteria” or “acetic acid bacteria” are bacteria that produce acetic acid as an end product of carbohydrate fermentation. As used herein “propionic bacteria” or “propionic acid bacteria” are bacteria that synthesize propionic acid. As used herein “bifido”, “bifodobacteria” or “bifido bacteria” are gram negative anaerobic bacteria which often colonise the endothelium of animals.

In an embodiment, the method of preparing a sugar reduced product from a biomass comprises fermentation for about 3 hours to about 72 hours. In an embodiment, fermentation is for about 3 hours to about 48 hours. In an embodiment, fermentation is for about 3 hours to about 42 hours. In an embodiment, fermentation is for about 6 hours to about 36 hours. In an embodiment, fermentation is for about 8 hours to about 32 hours. In an embodiment, fermentation is for about 10 hours to about 24 hours. In an embodiment, fermentation is for about 15 hours to about 20 hours. In an embodiment, fermentation is for at least 3 hours. In an embodiment, fermentation is for at least 4 hours. In an embodiment, fermentation is for at least 5 hours. In an embodiment, fermentation is for at least 6 hours. In an embodiment, fermentation is for at least 7 hours. In an embodiment, fermentation is for at least 8 hours. In an embodiment, fermentation is for at least 10 hours. In an embodiment, fermentation is for at least 15 hours. In an embodiment, fermentation is for at least 20 hours. In an embodiment, fermentation is for at least 24 hours. In an embodiment, fermentation is for at least 30 hours. In an embodiment, fermentation is for at least 36 hours. In an embodiment, fermentation is for at least 42 hours. In an embodiment, fermentation is for at least 48 hours. In an embodiment, fermentation is for at least 60 hours. In an embodiment, fermentation is for at least 72 hours. In an embodiment, fermentation is at a pH of about 4 to about 7. In an embodiment, fermentation is at a pH of about 5 to about 7. In an embodiment, fermentation is at a pH of about 6. In an embodiment, the pH is regulated by the addition of base during fermentation. In an embodiment, fermentation is at a pH of about 5.3. In an embodiment, fermentation is at a pH of about 5. In an embodiment, fermentation is at a pH of about 4. In an embodiment, fermentation is at a pH of about 4 or less. In an embodiment, the material from step i) is at a pH of about 4 at the end of fermentation. In an embodiment, fermentation is at a temperature of about 24° C. to about 36° C. In an embodiment, fermentation is at a temperature of about 28° C. to about 32° C. In an embodiment, fermentation is at a temperature of about 30° C.

In an embodiment, fermentation for at least 2 hours reduces the sucrose concentration by at least 15% compared to the biomass. In an embodiment, fermentation for at least 4 hours reduces the sucrose concentration by at least 60% compared to the biomass. In an embodiment, fermentation for at least 10 hours reduces the sucrose concentration by at least 70% compared to the biomass.

In an embodiment, fermentation for at least 10 hours reduces the total sugar by at least 10% compared to the biomass. In an embodiment, fermentation for at least 15 hours reduces the total sugar by at least 20% compared to the biomass. In an embodiment, fermentation for at least 15 hours increases the concentration of mannitol to at least 4 mg/mL.

In an embodiment, the fermentation culture is about 5 L, 10 L, 15 L, 20 L, 25 L 35 L, 45 L, 55 L, 100 L, 200 L, 500 L, 750 L, 1000 L, 1500 L, 2000 L or 10,000 L.

In an embodiment, the fermentation culture is stirred. In an embodiment, stirring is intermittent. In an embodiment, stirring is continuous. In an embodiment, stirring is at about 300 rpm. In a particularly preferred embodiment, fermentation is for about 15 hours with intermittent stirring. In a particularly preferred embodiment, fermentation is for about 24 hours with intermittent stirring.

In an embodiment, the fermentation culture is not actively supplied with oxygen. In an embodiment, fermentation culture comprises no air flow or gas flow. In an embodiment, fermentation is low oxygen fermentation. In an embodiment, fermentation is under microaerophilic conditions. In an embodiment, the fermentation is anaerobic. In an embodiment, the anaerobic environment is created by the addition of nitrogen. In an embodiment, the pH of the fermentation culture is not controlled. In an embodiment, glucose oxidase is not added to the fermentation culture.

In an embodiment, fermentation increases the carotenoid concentration in the sugar reduced product compared to the biomass. In an embodiment, the carotenoid is β-carotene.

### Fermentation Enzymes

In an embodiment, the method of preparing a sugar reduced product from a biomass comprises treating the biomass with fermentation enzymes to reduce the sugar concentration. In an embodiment, treatment with fermentation enzymes comprises fermentation. In an embodiment, treatment with fermentation enzymes comprises treatment with fermentation enzymes prepared as described herein.

In an embodiment, treatment with fermentation enzymes reduces the concentration of sugar in the biomass compared to the biomass before treatment with fermentation enzymes. In an embodiment, treatment with fermentation enzymes reduces the concentration of sugar in the biomass by about 10% to about 70% compared to the biomass before treatment with fermentation enzymes. In an embodiment, treatment with fermentation enzymes reduces the concentration of sugar in the biomass by about 15% to about 60% compared to the biomass before treatment with fermentation enzymes. In an embodiment, treatment with fermentation enzymes reduces the concentration of sugar in the biomass by about 20% to about 50% compared to the biomass before treatment with fermentation enzymes. In an embodiment, treatment with fermentation enzymes reduce the concentration of sugar in the biomass by about 20% to about 40% compared to the biomass before treatment with fermentation enzymes.

In an embodiment, treatment with fermentation enzymes increase the concentration of oligosaccharides in the biomass compared to the biomass before treatment with fermentation enzymes. In an embodiment, treatment with fermentation enzymes increase the concentration of polysaccharides in the biomass compared to the biomass before treatment with fermentation enzymes. In an embodiment, treatment with fermentation enzymes converts about 10 to about 70% of total fermentable sugar to polysaccharides.

In an embodiment, the polysaccharides have a molecular weight of about 4 kDa to about 1600 kDa. In an embodiment, the polysaccharides have a molecular weight of about 4 kDa to about 1000 kDa. In an embodiment, the polysaccharides have a molecular weight of about 4 kDa to about 970 kDa. In an embodiment, the polysaccharides have a molecular weight of about 5 kDa to about 800 kDa. In an embodiment, the polysaccharides have a molecular weight of about 5 kDa to about 600 kDa. In an embodiment, the polysaccharides have a molecular weight of about 5 kDa to about 400 kDa. In an embodiment, the polysaccharides have a molecular weight of about 10 kDa to about 200 kDa. In an embodiment, the polysaccharides have a molecular weight of about 50 kDa to about 400 kDa. In an embodiment, the polysaccharides have a molecular weight of about 10 kDa. In an embodiment, the polysaccharides have a molecular weight of about 15 kDa.

In an embodiment, the fermentation enzymes are produced by one or more bacteria selected from: lactic acid, acetic acid, propionic acid and bifido bacteria as described herein.

In an embodiment, the invention provides a method of preparing fermentation enzymes for reducing the sugar concentration of a biomass comprising:

i) inoculating the biomass with one or more bacteria selected from: lactic acid, acetic acid, propionic acid and bifido bacteria which have previously been cultured in biomass,

ii) fermenting for a sufficient time for fermentation enzymes to be produced,

iii) removing the bacteria or isolating fermentation enzymes secreted by the bacteria.

Step iii) may comprise any method known to a person skilled in the art including, for example, centrifugation or filtration.

In an embodiment, when step iii) comprises removing the bacteria the fermentation enzymes are present in the ferment. In an embodiment, the ferment is added to biomass to produce the sugar reduced products as described herein. For example the method of preparing fermentation enzymes may comprise fermenting 1 L of biomass, removing the bacteria as described in step ii) and adding the ferment to a larger quantity of biomass, such as for example, 10 L, 20 L, 30 L, 50 L, 100 L or 1000 L of biomass or higher quantities depending on the size of the fermenters used.

In an embodiment, when step iii) comprises isolating fermentation enzymes the isolated enzymes are added to the biomass to produce the sugar reduced products as described herein. In an embodiment, isolating the fermentation enzymes separates the fermentation enzymes from the bacteria.

In an embodiment, fermenting in step ii) is for about 3 to about 72 hours. In an embodiment, fermenting in step ii) is for about 3 to about 30 hours. In an embodiment, fermenting in step ii) is for at least 3 hours. In an embodiment, fermenting in step ii) is for at least 4 hours. In an embodiment, fermenting in step ii) is for at least 5 hours. In an embodiment, fermenting in step ii) is for at least 8 hours. In an embodiment, fermenting in step ii) is for at least 10 hours. In an embodiment, fermenting in step ii) is for at least 15 hours. In an embodiment, fermenting in step ii) is for at least 20 hours. In an embodiment, fermenting in step ii) is for at least 24 hours.

In an embodiment, the fermentation enzymes may be secreted by one or more bacteria selected from: lactic acid, acetic acid, propionic acid and bifido bacteria as described herein. In some embodiments, the bacteria is lysed prior to isolation of the fermentation enzymes. In an embodiment, the method additionally comprises step iv) one or more additional purification steps after step ii).

In an embodiment, treating the biomass with fermentation enzymes comprises addition of the fermentation enzymes from step iii) or iv) to the biomass.

In another embodiment, the fermentation enzymes are purified or recombinant enzymes obtained from commercial sources. In an embodiment, the fermentation enzymes comprise dextransucrase (D9909-10UN; Sigma-Aldrich). In an embodiment, the fermentation enzymes comprise levansucrase (MBS1040354; MyBioSource). In an embodiment, the fermentation enzymes comprise mannitol dehydrogenase (M9532; Sigma-Aldrich).

In an embodiment, the fermentation enzymes comprise one or more or all of: i) glycosyltransferase, ii) glycosidase or aryl glycosidase, iii) pectinase, iv) esterase, v) decarboxylase, vi) tannase and vii) oxidoreductase. In an embodiment, the glycosyltransferase is selected from one or more or all of: i) dextransucrase (sucrose:1,6-α-d-glucan-6-α-d-glucosyltransferase, EC 2.4.1.5), ii) alternansucrase (sucrose: 1,6(1,3)-α-d-glucan-6(3)-α-d-glucosyltransferase, EC 2.4.1.140) iii) fructosyltransferases, and iv) β-galactosidase. In an embodiment, the fructosyltransferases is for example levansucrase (sucrose:2,6-β-d-fructan-6-β-d-fructosyltransferase, EC 2.4.1.10), and/or inulosucrase (sucrose:2,1-β-d-fructan-1-β-d-fructosyltransferase, EC 2.4.1.9). In an embodiment, the oxidoreductase is mannitol dehydrogenase. Examples of glycosyltransferase and fructosyltransferases can be found in, for example, van Hijum et al., 2006.

In an embodiment, the fermentation enzymes comprise an enzyme that catalyzes the production of mannitol. In an embodiment, the fermentation enzymes comprise an enzyme that catalyzes the production of dextran. In an embodiment, the fermentation enzymes comprise an enzyme that catalyzes the production of a pre-biotic oligosaccharide, for example but not limited to, kystose, nystose, fructosylnystose, iso-maltooligosaccharides (e.g. isomaltose and panose), glucooligosaccharides and galactooligosaccharides. In an embodiment, the fermentation enzymes comprise an enzyme that catalyzes the production of a pre-biotic polysaccharides and/or oligosaccharides, for example but not limited to inulin, dextran and levan. In an embodiment, the methods as described herein comprises only one fermentation step.

### Bacteria

In an embodiment, the method of preparing a sugar reduced product from a biomass comprises fermentation of the biomass with one or more bacteria selected from: lactic acid, acetic acid, propionic acid and bifido bacteria which produce fermentation enzymes. In an embodiment, the fermentation enzymes comprise one or more or all of: i) glycosyltransferase, ii) glycosidase or aryl glycosidase, iii) pectinase, iv) esterase, v) decarboxylase, vi) tannase, and vii) oxidoreductase. In an embodiment, the glycosyltransferase is selected from one or more or all of: i) dextransucrase, ii) levansucrase, iii) alternansucrase, iv) fructosyltransferases and v) β-galactosidase. In an embodiment, the oxidoreductase is mannitol dehydrogenase. In an embodiment, the tannase is tannin acylhydrolase.

In an embodiment, the lactic acid, acetic acid, propionic acid and/or bifido bacteria produce enzymes that catalyze the production of mannitol, oligosaccharides and/or polysaccharides. In an embodiment, the lactic acid, acetic acid, propionic acid and/or bifido bacteria produce enzymes that modify phenolics (Zhao et al., 2016). In an embodiment, the oligosaccharide is selected from one or more of: dextran, levan and inulin type fructans. In an embodiment, dextran is high molecular weight and/or low molecular weight dextran.

In an embodiment, the lactic acid bacteria is from one or more of: the Genera Lactobacillus, Leuconostoc, Pediococcus, Lactococcus, Streptococcus, Aerococcus, Carnobacterium, Enterococcus, Oenococcus, Fructobacillus, Sporolactobacillus, Tetragenococcus, Vagococcus and Weissella. In an embodiment, the lactic acid bacteria is selected from one or more of: Leuconostoc mesenteroides, Lactobacillus reuteri, Lactobacillus gasseri and Lactococus lactis. In an embodiment, the lactic acid bacteria is Fructobacillus.

In an embodiment, the lactic acid bacteria is Leuconostoc mensenteroides. Leuconostoc mensenteroides are gram positive, epiphytic bacteria (McCleskey et al., 1947). Leuconostoc mesenteroides also produce the antimicrobial proteins bacteriocins, which are used in the meat industry as natural preservatives. In an embodiment, the lactic acid bacteria is Leuconostoc mesenteroides. In an embodiment, the Leuconostoc mesenteroides is selected from ATCC 8293 (equivalent to NRRL B-1118) and NRRL B-512F investigated in Olvera et al. (2007).

In an embodiment, the Leuconostoc mesenteroides is isolated from broccoli. In an embodiment, the Leuconostoc mesenteroides is BF1 deposited under V17/021729 on 25 Sep. 2017 at the National Measurement Institute Australia. In an embodiment, the Leuconostoc mesenteroides is BF2 deposited under V17/021730 on 25 Sep. 2017 at the National Measurement Institute Australia.

In an embodiment, the Leuconostoc mesenteroides is isolated from carrot. In an embodiment, the Leuconostoc mesenteroides isolated from carrot is selected from C12, C13, C14, C15, C16, C18, C19 and C20. In an embodiment, the Leuconostoc mesenteroides is C13. In an embodiment, the Leuconostoc mesenteroides is C16.

In an embodiment, the lactic acid bacteria is a Lactobacillus gasseri.

In an embodiment, the acetic acid bacteria is from the family Acetobacteraceae. In an embodiment, the Acetobacteraceae is Gluconacetobacter.

In an embodiment, the bifido bacteria is from the family Bifidobacteriaceae. In an embodiment, the Bifidobacteriaceae is from the genus Bifidobacterium.

In an embodiment, the lactic acid, acetic acid, propionic acid and/or bifido bacteria has been isolated from a plant source, honey bee or bee hive.

In an embodiment, the plant source is Brassicaceae (e.g. broccoli), apple or carrot. In an embodiment, the lactic acid, acetic acid, propionic acid and/or bifido bacteria is pre-adapted for fermentation of the biomass as described herein.

As used herein “pre-adapted” or “pre-adaption” refers to adaption of the bacteria to culture in biomass or a similar biomass (i.e. if the plant material is apple puree the bacteria may be pre-adapted to growth on the same apple puree or apple puree from a different apple variety of apples). In an embodiment, the bacteria are pre-adapted to increase the activity of bacteria and/or production of enzymes by the bacteria. In an embodiment, the bacteria is pre-adapted for culture in biomass as described herein. In an embodiment, the bacteria is pre-adapted for culture in 13° Brix apple juice. In an embodiment, the bacteria is pre-adapted for culture in 26° Brix apple juice. In an embodiment, the bacteria is pre-adapted for culture in 39° Brix apple juice. In an embodiment, the secondary inoculum, is pre-adapted.

In an embodiment, when the method of preparing a sugar reduced product from a biomass comprises fermentation, the bacteria are removed after step i) or step ii). In an embodiment, when the method of preparing a sugar reduced product from a biomass comprises treating the biomass with fermentation enzymes, the fermentation enzymes are removed after step i) or step ii). A person skilled in the art will appreciate that the bacteria can be removed by any method known to a person skilled in the art including, for example, centrifugation or filtration.

In an embodiment, when the biomass is carrot the bacteria is Leuconostoc mesenteroides or Lactobacillus gasseri. In an embodiment, the Leuconostoc mesenteroides is BF1 deposited under V17/021729 on 25 Sep. 2017 at the National Measurement Institute Australia. In an embodiment, the Leuconostoc mesenteroides is BF2 deposited under V17/021730 on 25 Sep. 2017 at the National Measurement Institute Australia. In an embodiment, the Leuconostoc mesenteroides is isolated from carrot. In an embodiment, the Leuconostoc mesenteroides isolated from carrot is selected from C12, C13, C14, C15, C16, C18, C19 and C20. In an embodiment, the Leuconostoc mesenteroides is C13. In an embodiment, the Leuconostoc mesenteroides is C16. In an embodiment, the Lactobacillus gasseri is isolated from carrot.

### Additional Nutrients

“Additional nutrient/s” also referred to as “extra nutrient/s” can be added to the biomass before or during step i). As used herein “additional nutrient/s” may be any nutrient that increases the activity of a fermentation enzymes and include, for example but not limited to, calcium, nitrogen source, phosphate, maltose and/or isomaltose.

In an embodiment, the addition of nitrogen comprises the addition of whey protein isolates (WPI). In an embodiment, the addition of nitrogen comprises the addition of yeast extract (YE). In an embodiment, the addition of nitrogen comprises the addition of peptone. In an embodiment, the addition of nitrogen comprises the addition of milk, preferably about 1% to about 2% skimmed milk.

In an embodiment, the addition of phosphate comprises the addition of K₂HPO₄. In an embodiment, the addition of phosphate comprises the addition of about 0.6% to about 2.5% phosphate. In an embodiment, the addition of phosphate comprises the addition of about 0.67% to about 2% phosphate. In an embodiment, the addition of phosphate comprises the addition of about 0.67% phosphate. In an embodiment, the addition of phosphate comprises the addition of about 2% phosphate.

In an embodiment, the addition of calcium comprises the addition of CaCl₂. In an embodiment, the addition of calcium comprises the addition of about 0.2 to about 0.8% CaCl₂. In an embodiment, the addition of calcium comprises the addition of about 0.5% CaCl₂.

In an embodiment, the addition of maltose increases the production of oligosaccharides such as panose. In an embodiment, the addition of maltose comprises the addition of about 0.5% to about 5% maltose. In an embodiment, the addition of isomaltose comprises the addition of about 0.5% to about 5% isomaltose.

In an embodiment, the additional nutrient is skimmed milk. In an embodiment, the skimmed milk is added at a concentration of about 1% to about 4%. In an embodiment, the skimmed milk is added at a concentration of about 1% to about 2%.

In an embodiment, the additional nutrient is isolated and/or concentrated protein. In an embodiment, isolated and/or concentrated protein is selected from, but not limited to, whey protein concentrate, soy protein isolate, soy protein concentrate or pea protein isolate.

In an embodiment, glucose is not an additional nutrient. In an embodiment, fructose is not an additional nutrient. In an embodiment, sucrose is not an additional nutrient. In an embodiment, mannose is not an additional nutrient.

### Post-Treating

As used herein “post-treating”, “post-treatment”, or “post-processing” refers to one or more additional treatments of the biomass after treatment with fermentation enzymes which further reduces the sugar concentration.

In an embodiment, post-treating reduces the sugar concentration in the material treated with fermentation enzymes by about 2% to about 60% compared to the sugar in the material treated with fermentation enzymes before post-treating. In an embodiment, post-treating reduces the sugar concentration in the material treated with fermentation enzymes by about 3% to about 50% compared to the sugar in the material treated with fermentation enzymes before post-treating. In an embodiment, post-treating reduces the sugar concentration in the material treated with fermentation enzymes by about 5% to about 50% compared to the sugar in the material treated with fermentation enzymes before post-treating. In an embodiment, post-treating reduces the sugar concentration in the material treated with fermentation enzymes by about 5% to about 40% compared to the sugar in the material treated with fermentation enzymes before post-treating. In an embodiment, post-treating reduces the sugar concentration in the material treated with fermentation enzymes by about 5% to about 30% compared to the sugar in the material treated with fermentation enzymes before post-treating. In an embodiment, post-treating reduces the sugar concentration in the material treated with fermentation enzymes by about 5% to about 20% compared to the sugar in the material treated with fermentation enzymes before post-treating. In an embodiment, post-treating reduces the sugar concentration in the material treated with fermentation enzymes by about 5% to about 15% compared to the sugar in the material treated with fermentation enzymes before post-treating. In an embodiment, post-treating reduces the sugar concentration in the material treated with fermentation enzymes by about 7% to about 12% compared to the sugar in the material treated with fermentation enzymes before post-treating. In an embodiment, post-treating reduces the sugar concentration in the material treated with fermentation enzymes by about 40% compared to the sugar in the material treated with fermentation enzymes before post-treating. In an embodiment, post-treating reduces the sugar concentration in the material treated with fermentation enzymes by about 30% compared to the sugar in the material treated with fermentation enzymes before post-treating. In an embodiment, post-treating reduces the sugar concentration in the material treated with fermentation enzymes by about 20% compared to the sugar in the material treated with fermentation enzymes before post-treating. In an embodiment, post-treating reduces the sugar concentration in the material treated with fermentation enzymes by about 15% compared to the sugar in the material treated with fermentation enzymes before post-treating. In an embodiment, post-treating reduces the sugar concentration in the material treated with fermentation enzymes by about 10% compared to the sugar in the material treated with fermentation enzymes before post-treating. In an embodiment, post-treating reduces the sugar concentration in the material treated with fermentation enzymes by about 5% compared to the sugar in the material treated with fermentation enzymes before post-treating.

In an embodiment, post-treating also inactivates microbes that are pathogenic or which cause product spoilage. As used herein “microbes” refers to bacterial, viral, fungal or eukaryotic activity that can result in degradation or spoilage of the product reducing product shelf life. As used herein “inactivate” or “inactivation” of microbes refers to reducing the viable microbes by about 1 to about 12 logs. In an embodiment, the viable microbes are reduced by about 1 to 8 logs. In an embodiment, the viable microbes are reduced by about 1 to 7 logs. In an embodiment, the viable microbes are reduced by about 1 to 6 logs. In an embodiment, the viable microbes are reduced by about 2 to 6 logs. In an embodiment, the viable microbes are reduced by about 3 to 6 logs.

In an embodiment, post-treating comprises one or more of the following i) microwaving; ii) heating; iii) exposing to high frequency sound waves (ultrasound); and iv) exposing to high hydrostatic pressure. In an embodiment, post-treating increases the activity of fermentation enzymes. In an embodiment, post-treating modulates the composition of the sugar reduced product. For example, post-treating increases the concentration of oligosaccharides and/or polysaccharides in the sugar reduced product compared to a product produced by the same method lacking post-treatment.

In the methods as described herein post-treating does not include fermentation. In the methods as described herein post-treating does not include a second treatment with fermentation enzymes as described herein.

In an embodiment, post-treating increases the mannitol concentration in the sugar reduced product compared to a product produced by the same method lacking post-treatment.

In an embodiment, post-treating decreases the sorbitol concentration in the sugar reduced product compared to a product produced by the same method lacking post-treatment.

In an embodiment, post-treating does not increase the temperature of the material from step i) above 70° C. In an embodiment, post-treating does not increase the temperature of the material from step i) above 65° C.

In an embodiment, post-treating increases the temperature of the material from step i) to a temperature of about 40° C. to about 65° C. In an embodiment, post-treating increases the temperature of the material from step i) to a temperature of about 40° C. to 60° C. In an embodiment, post-treating increases the temperature of the material from step i) to a temperature of about 45° C. to 60° C. In an embodiment, post-treating increases the temperature of the material from step i) to a temperature of about 50° C. to 60° C.

In an embodiment, the post treated biomass is combined with a juice or a juice base before step ii).

### Heating

In an embodiment, post-treating comprises heating the material from step i). In an embodiment, heating does not increase the temperature of the material from step i) above 70° C. In an embodiment, heating does not increase the temperature of the material from step i) above 65° C.

In an embodiment, heating increases the temperature of the material from step i) to a temperature of about 40° C. to about 65° C. In an embodiment, heating increases the temperature of the material from step i) to a temperature of about 40° C. to about 60° C. In an embodiment, heating increases the temperature of the material from step i) to a temperature of about 45° C. to about 60° C. In an embodiment, heating increases the temperature of the material from step i) to a temperature of about 50° C. to about 60° C.

In an embodiment, the material from step i) is in a fuel based heating system, an electricity based heating system (e.g. an oven) or a steam based heating system (indirect or direct application of steam to the material from step i). In an embodiment, the material from step i) is in an oven, water bath, bioreactor, pasteurizer or heat exchanger. In an embodiment, the material from step i) is for about 30 seconds to about 5 minutes. In an embodiment, the material from step i) is for about 30 seconds. In an embodiment, the material from step i) is for about 1 minute. In an embodiment, the material from step i) is for about 2 minutes. In an embodiment, the material from step i) is for about 3 minutes. In an embodiment, the material from step i) is for about 4 minutes. In an embodiment, the material from step i) is heated for about 5 minutes. In an embodiment, the material from step i) is heated for about 1 to 8 hours. In an embodiment, the material from step i) is heated for about 2 to 6 hours.

In an embodiment, heating comprises heating at a high temperature for a short time (HTST) also referred to as “flash pasteurization” or “high temperature short time pasteurization”. HTST reduces the presence of microorganisms which cause the product to degrade. In an embodiment, HTST is at about 80° C. to about 121° C. In an embodiment, HTST is at about 90° C. to about 110° C. In an embodiment, HTST is at about 95° C. to about 105° C. In an embodiment, HTST is at about 100° C. In an embodiment, HTST is for about 2 to about 180 seconds. In an embodiment, HTST is at about 100° C. In an embodiment, HTST is for about 2 to about 120 seconds. In an embodiment, HTST is at about 100° C. In an embodiment, HTST is for about 5 to about 60 seconds. In an embodiment, HTST is for about 5 to about 50 seconds. In an embodiment, HTST is for about 5 to about 40 seconds. In an embodiment, HTST is for about 5 to about 30 seconds. In an embodiment, HTST is for about 10 to about 20 seconds. In an embodiment, HTST is for about 12 to about 18 seconds. In an embodiment, HTST is for about 15 seconds.

### High Hydrostatic Pressure

In an embodiment, post-treating comprises exposing the material from step i) to pressure. As used herein “high hydrostatic pressure”, “high pressure processing” or “HHP” is considered about 100 mega pascals (MPa) or greater. In an embodiment, the pressure treatment is conducted in a high pressure vessel (e.g. Flow Pressure System QuINTUS® Food Press Type 35 L-600 sterilisation machine, Avure Technologies, Kent, Wash., USA). In an embodiment, the material from step i) is treated with high hydrostatic pressure at about 50 Mega pascal (MPa) to about 800 MPa. In an embodiment, the material from step i) is treated with high hydrostatic pressure at about 50 Mega pascal (MPa) to about 700 MPa. In an embodiment, the material from step i) is treated with high hydrostatic pressure at about 50 Mega pascal (MPa) to about 600 MPa. In an embodiment, the material from step i) is treated with HPP at about 150 to about 500 MPa. In an embodiment, the material from step i) is treated with HPP at about 200 to about 400 MPa. In an embodiment, the material from step i) is treated with HPP at about 250 to about 350 MPa. In an embodiment, the material from step i) is treated with HPP at about 150 MPa. In an embodiment, the material from step i) is treated with HPP at about 200 MPa. In an embodiment, the material from step i) is treated with HPP at about 300 MPa. In an embodiment, the material from step i) is treated with HPP at about 400 MPa. In an embodiment, the material from step i) is treated with HPP at about 500 MPa. In an embodiment, the material from step i) is treated with HPP at about 600 MPa. Treatment with HPP does not encompass treatment with pressure of about 200 kPa (kilopascal) or less.

In an embodiment, pressure is applied at a temperature of about 20° C. to about 60° C. In an embodiment, pressure is applied at a temperature of about 30° C. to about 50° C. In an embodiment, pressure is applied at a temperature of about 35° C. to about 45° C. In an embodiment, pressure is applied at a temperature of about 40° C.

In an embodiment, the pressure hold time is for 0 (pressurization of the container then immediate de-pressurization) to about 30 minutes. In an embodiment, the pressure hold time is for about 5 to about 30 minutes. In an embodiment, the pressure hold time is for about 8 to about 25 minutes. In an embodiment, the pressure hold time is for about 10 to about 20 minutes. In an embodiment, the pressure hold time is for about 12 to about 18 minutes. In an embodiment, the pressure hold time is for about 15 minutes.

In an embodiment, the material from step i) is treated with HPP at about 600 MPa for about 3 to 5 minutes.

In an embodiment, the material from step i) is treated with HPP at about 150 MPa, at about 40° C. for about 15 minutes. In an embodiment, the material from step i) is treated with HPP at about 400 MPa, at about 40° C. for about 15 minutes. In an embodiment, the material from step i) is treated with HPP at about 600 MPa, at about 40° C. for about 15 minutes.

### Microwaves

A person skilled in the art will appreciate that “microwaves” or “microwaving” heats a substance such as biomass by passing microwave radiation through the substance. Microwaves can increase the activity of some enzymes. In an embodiment, post-treating comprises microwaving the material from step i). In an embodiment, the material from step i) is exposed to microwaves in a consumer microwave or industrial microwave. In an embodiment, the industrial microwave is a continuous microwave system, for example, but not limited to the MIP 11 Industrial Microwave Continuous Cooking Over (Ferrite Microwave Technologies). In an embodiment, the industrial microwave is a batch microwave system, for example, but not limited to the MIP4, MIP8 or MIP10 (Ferrite Microwave Technologies). In an embodiment, microwaving is at about 0.9 to about 2.45 GHz. In an embodiment, microwaving is for about 30 seconds to 4 minutes. In an embodiment, microwaving is for about 30 seconds. In an embodiment, microwaving is for about 1 minute. In an embodiment, microwaving is for about 2 minutes. In an embodiment, microwaving is for about 3 minutes. In an embodiment, microwaving is for about 4 minutes.

In an embodiment, post-treating decreases the sorbitol concentration in the sugar reduced product compared to the product before post-treatment.

### High Frequency Sound Waves (Ultrasound)

In an embodiment, post-treating comprises exposing the material from step i) with low to medium frequency ultrasound waves. In an embodiment, the ultrasound waves are generated with an industrial scale ultrasonic processor. In an embodiment, the ultrasonic processor is a continuous or batch ultrasonic processor. In an embodiment, the ultrasonic processor is for example, but not limited to, UIP500hd or UIP4000 (Hielscher, Ultrasound Technology). In an embodiment, the ultrasonic processor is a CUUR ultrasonic device developed by CSIRO (WO2015/176134). In an embodiment, the ultrasounds waves are at a frequency of about 20 kHz to about 1200 kHz and about 0.01 kW/L to about 2 kW/L. In an embodiment, the ultrasounds waves are at a frequency of about 20 kHz to about 1200 kHz and about 0.01 kW/L to about 1.8 kW/L. In an embodiment, the ultrasounds waves are at a frequency of about 20 kHz to about 1200 kHz and about 0.01 kW/L to about 1.6 kW/L. In an embodiment, the ultrasounds waves are at a frequency of about 20 kHz to about 1000 kHz and about 0.01 kW/L to about 2 kW/L. In an embodiment, the ultrasounds waves are at a frequency of about 20 kHz to about 800 kHz and about 0.01 kW/L to about 1 kW/L. In an embodiment, the ultrasounds waves are at a frequency of about 20 kHz to about 600 kHz and about 0.01 kW/L to about 1 kW/L. In an embodiment, the ultrasounds waves are at a frequency of about 20 kHz to about 400 kHz and about 0.01 kW/L to about 1 kW/L. In an embodiment, the ultrasounds waves are at a frequency of about 20 kHz and about 0.02 kW/L. In an embodiment, the ultrasounds waves are at a frequency of about 40 kHz and about 0.04 kW/L. In an embodiment, the ultrasounds waves are at a frequency of about 400 kHz and about 0.02 kW/L. In an embodiment, the material from step i) is exposed to ultrasound waves for about 30 seconds to about 3 hours. In an embodiment, the material from step i) is exposed to ultrasound waves for about 30 seconds to about 2 hours. In an embodiment, the material from step i) is exposed to ultrasound waves for about 30 seconds to about 1 hour. In an embodiment, the material from step i) is exposed to ultrasound waves for about 30 seconds. In an embodiment, the material from step i) is exposed to ultrasound waves for about 1 minute. In an embodiment, the material from step i) is exposed to ultrasound waves for about 2 minutes. In an embodiment, the material from step i) is exposed to ultrasound waves for about 3 minutes. In an embodiment, the material from step i) is exposed to ultrasound waves for about 4 minutes. In an embodiment, the material from step i) is exposed to ultrasound waves for about 5 minutes. The ultrasound treatment can be continuous or intermittent.

### Pre-Treating

As used herein “pre-treating”, “pre-treatment”, or “pre-processing” refers to one or more additional treatments of the biomass before step i) of the methods described herein wherein pre-treatment inactivates the natural microflora in the biomass, increases the release of sugars and other cell components making them more accessible for fermentation enzymes and/or increases or decreases the concentration of solids in biomass (increases or decreases the ° Brix value).

In an embodiment, pre-treating comprises one or more of the following i) microwaving; ii) heating; iii) exposing to high frequency sound waves (ultrasound); iv) exposing to high hydrostatic pressure; v) pulse electric field processing; vi) exposure to shockwaves and/or vii) concentration or dilution.

In an embodiment, pre-treating does not increase the temperature of the biomass above about 121° C. In an embodiment, pre-treating does not increase the temperature of the biomass above about 90° C. In an embodiment, pre-treating does not increase the temperature of the biomass above about 70° C.

In an embodiment, pre-treating increases the temperature of the biomass to a temperature of about 40° C. to about 121° C. In an embodiment, pre-treating increases the temperature of the biomass to a temperature of about 40° C. to 90° C. In an embodiment, pre-treating increases the temperature of the biomass to a temperature of about 40° C. to 60° C. In an embodiment, pre-treating increases the temperature of the biomass to a temperature of about 50° C. to 60° C.

### Microwaves

A person skilled in the art will appreciate that “microwaves” or “microwaving” heats a substance such as biomass by passing microwave radiation through the biomass. Microwaves can increase the activity of some enzymes. In an embodiment, pre-treating comprises microwaving the biomass before step i). In an embodiment, the biomass is exposed to microwaves in a consumer microwave or industrial microwave. In an embodiment, the industrial microwave is a continuous microwave system, for example, but not limited to the MIP 11 Industrial Microwave Continuous Cooking Oven (Ferrite Microwave Technologies). In an embodiment, the industrial microwave is a batch microwave system, for example, but not limited to the MIP4, MIP8 or MIP10 (Ferrite Microwave Technologies). In an embodiment, microwaving is at about 0.9 to about 2.45 GHz. In an embodiment, microwaving is for about 30 seconds to 4 minutes. In an embodiment, microwaving is for about 30 seconds. In an embodiment, microwaving is for about 1 minute. In an embodiment, microwaving is for about 2 minutes. In an embodiment, microwaving is for about 3 minutes. In an embodiment, microwaving is for about 4 minutes.

### Heating

In an embodiment, pre-treating comprises heating the biomass before step i). In an embodiment, heating does not increase the temperature of the biomass above about 121° C. In an embodiment, heating does not increase the temperature of the biomass above about 90° C. In an embodiment, heating does not increase the temperature of the biomass above about 70° C.

In an embodiment, the biomass is sterilized by heating.

In an embodiment, heating increases the temperature of the biomass to a temperature of about 60° C. to about 100° C. In an embodiment, heating increases the temperature of the biomass to a temperature of about 60° C. to about 690 C. In an embodiment, heating increases the temperature of the biomass to a temperature of about 60° C. to about 80° C. In an embodiment, heating increases the temperature of the biomass to a temperature of about 60° C. to about 70° C.

In an embodiment, the biomass is heated in a fuel based heating system, an electricity based heating system (i.e. an oven) or a steam based heating system (indirect or direct application of steam to the biomass. In an embodiment, the biomass is heated in an oven, water bath, bioreactor, stove, water blancher, or steam blancher. In an embodiment, the biomass is heated for about 30 seconds to about 5 minutes. In an embodiment, the biomass is heated for about 30 seconds. In an embodiment, the biomass is heated for about 1 minute. In an embodiment, the biomass is heated for about 2 minutes. In an embodiment, the biomass is heated for about 3 minutes. In an embodiment, the biomass is heated for about 4 minutes. In an embodiment, the biomass is heated for about 5 minutes. In an embodiment, heating comprises heating at a high temperature for a short time (HTST) also referred to as “flash pasteurization” or “high temperature short time pasteurization”. HTST reduces the presence of microorganisms which cause the product to degrade. In an embodiment, HTST is at about 60° C. to about 121° C. In an embodiment, HTST is at about 90° C. to about 110° C. In an embodiment, HTST is at about 95° C. to about 105° C. In an embodiment, HTST is at about 100° C. In an embodiment, HTST is for about 5 to about 60 seconds. In an embodiment, HTST is for about 5 to about 50 seconds. In an embodiment, HTST is for about 5 to about 40 seconds. In an embodiment, HTST is for about 5 to about 30 seconds. In an embodiment, HTST is for about 10 to about 20 seconds. In an embodiment, HTST is for about 12 to about 18 seconds. In an embodiment, HTST is for about 15 seconds. In an embodiment, HTST is for about 12 minutes at 60° C. In an embodiment, HTST is for about 10 minutes at 60° C. In an embodiment, HTST is for about 8 minutes at 60° C.

### High Frequency Sound Waves (Ultrasound)

In an embodiment, pre-treating comprises exposing the biomass to medium frequency ultrasound waves. In an embodiment, the ultrasound waves are generated with an industrial scale ultrasonic processor. In an embodiment, the ultrasonic processor is a continuous or batch ultrasonic processor. In an embodiment, the ultrasonic processor is for example, but not limited to, UIP500hd or UIP4000 (Hielscher, Ultrasound Technology). In an embodiment, the ultrasounds waves are at a frequency of about 20 kHz, to about 600 kHz at an energy input of 1 kW/L or higher. In an embodiment, the ultrasounds waves are at a frequency of about 20 kHz, to about 400 kHz at an energy input of 1 kW/L or higher. In an embodiment, the ultrasounds waves are at a frequency of about 20 kHz, to about 400 kHz at an energy input of 0.8 kW/L or higher. In an embodiment, the ultrasounds waves are at a frequency of about 20 kHz. In an embodiment, the ultrasounds waves are at a frequency of about 40 kHz. In an embodiment, the ultrasounds waves are at a frequency of about 400 kHz.

In an embodiment, the biomass is exposed to ultrasound waves for about 30 seconds to about 1 hour. In an embodiment, the biomass is exposed to ultrasound waves for about 5 minutes to about 45 minutes. In an embodiment, the biomass is exposed to ultrasound waves for about 10 minutes to about 35 minutes. In an embodiment, the biomass is exposed to ultrasound waves for about 15 minutes to about 30 minutes. In an embodiment, the biomass is exposed to ultrasound waves for about 30 seconds to about 5 minutes. In an embodiment, the biomass is exposed to ultrasound waves for about 30 seconds. In an embodiment, the biomass is exposed to ultrasound waves for about 1 minute. In an embodiment, the biomass is exposed to ultrasound waves for about 2 minutes. In an embodiment, the biomass is exposed to ultrasound waves for about 3 minutes. In an embodiment, the biomass is exposed to ultrasound waves for about 4 minutes. In an embodiment, the biomass is exposed to ultrasound waves for about 5 minutes. In an embodiment, the biomass is exposed to ultrasound waves for about 10 minutes at a temperature between about 40° C. to about 70° C.

### High Hydrostatic Pressure

In an embodiment, pre-treating comprises exposing the biomass to high hydrostatic pressure before step i). As used herein “high hydrostatic pressure”, “high pressure processing” or “HHP” is considered about 50 mega pascals (MPa) or greater. In an embodiment, the pressure treatment is conducted in a high pressure vessel (e.g. Flow Pressure System QuINTUSR Food Press Type 35 L-600 sterilisation machine, Avure Technologies, Kent, Wash., USA). In an embodiment, the biomass is treated with HPP at about 50 MPa to about 800 MPa. In an embodiment, the biomass is treated with HPP at about 50 MPa to about 600 MPa. In an embodiment, the biomass is treated with HPP at about 100 MPa to about 600 MPa. In an embodiment, the biomass is treated with HPP at about 200 MPa to about 600 MPa. In an embodiment, the biomass is treated with HPP at about 300 MPa to about 600 MPa. In an embodiment, the biomass is treated with HPP at about 300 MPa to about 600 MPa. In an embodiment, the biomass is treated with HPP at about 100 MPa. In an embodiment, the biomass is treated with HPP at about 200 MPa. In an embodiment, the biomass is treated with HPP at about 300 MPa. In an embodiment, the biomass is treated with HPP at about 400 MPa. In an embodiment, the biomass is treated with HPP at about 500 MPa. In an embodiment, the biomass is treated with HPP at about 600 MPa. In an embodiment, pressure is applied at a temperature of about 20° C. to about 90° C. In an embodiment, the pressure hold time is for 0 (pressurization of the container then immediate de-pressurization) to about 30 minutes. In an embodiment, the pressure hold time is for about 5 to about 30 minutes. In an embodiment, the pressure hold time is for about 8 to about 25 minutes. In an embodiment, the pressure hold time is for about 10 to about 20 minutes. In an embodiment, the pressure hold time is for about 12 to about 18 minutes. In an embodiment, the pressure hold time is for about 15 minutes.

### Pulsed Electric Field

In an embodiment, pre-treating comprises exposing the biomass to pulse electric field processing. Pulse electric field processing is a non-thermal processing technique comprising the application of short, high voltage pulses. The pulses induce electroporation of the cells which can result in the release of sugar for the cells. In an embodiment, pulse electric field processing heats the biomass to a temperature of about 40° C. to about 70° C. In an embodiment, pulse electric field processing heats the biomass to a temperature of about 50° C. to about 90° C. In an embodiment, pulse electric field processing heats the biomass to a temperature of about 60° C. to about 90° C. In an embodiment, pulse electric field processing comprises treating the biomass with voltage pulses of about 20 to about 80 kV.

### Shockwaves

In an embodiment, pre-treating comprises exposing the biomass to underwater shockwaves. As referred to herein “shockwave” or “shockwaves” are electrical discharges under water. In an embodiment, the shockwaves hit the biomass with acoustic properties to the water and mechanical stress occurs disrupting the structure of the biomass resulting in the release of sugar from the biomass. In an embodiment, the shockwaves generate about 10 to about 80 MPa. In an embodiment, the shockwaves generate about 20 to about 70 MPa. In an embodiment, the shockwaves generate about 30 to about 60 MPa. In an embodiment, the shockwaves generate about 35 to about 55 MPa. In an embodiment, the shockwaves generate about 40 MPa. In an embodiment, shockwaves are generated as described in Yasuda et al., 2017.

### Concentration

In an embodiment, pre-treatment comprises concentrating the biomass to increase the ° Brix value of the biomass. The biomass can be concentrated by any method known to a person skilled in the art including, for example, evaporation, evaporation under vacuum, and/or membrane concentration (ultrafiltration, forward osmosis, reverse osmosis, membrane distillation, osmotic distillation). In an embodiment, the fruit and/or vegetable juice or the animal or plant milk can be concentrated to 20° Brix, 30° Brix, 40° Brix or 50° Brix.

### Sugar Reduced Products

In an embodiment, the sugar reduced product as described herein is selected from: juice, juice concentrate, milk, milk concentrate, puree, fruit and/or vegetable pieces, and a powder. In an embodiment, the juice or juice concentrate has a Brix value of about 3° Brix to about 50° Brix. In an embodiment, the juice or juice concentrate has a Brix value of about 5° Brix to about 50° Brix. In an embodiment, the juice or juice concentrate is about 34° Brix juice. In an embodiment, the juice or juice concentrate is about 26° Brix juice. In an embodiment, the juice or juice concentrate is about 23° Brix juice. In an embodiment, the juice or juice concentrate is about 20° Brix juice. In an embodiment, the juice or juice concentrate is about 18° Brix juice. In an embodiment, the juice or juice concentrate is about 13° Brix juice. In an embodiment, the juice or juice concentrate is about 10° Brix juice. In an embodiment, the juice is apple juice.

In an embodiment, the milk or milk concentrate has a Brix value of about 3° Brix to about 50° Brix. In an embodiment, the milk or milk concentrate has a Brix value of about 5° Brix to about 50° Brix. In an embodiment, the milk or milk concentrate is about 26° Brix juice. In an embodiment, the milk or milk concentrate is about 18° Brix juice.

In an embodiment, the total sugar in the product is reduced by about 20% to about 90% compared to the biomass. In an embodiment, the total sugar in the product is reduced by about 30% to about 70% compared to the biomass. In an embodiment, the total sugar in the product is reduced by about 40% to about 70% compared to the biomass. In an embodiment, the total sugar in the product is reduced by about 40% to about 60% compared to the biomass. In an embodiment, the total sugar in the product is reduced by about 40% compared to the biomass. In an embodiment, the total sugar in the product is reduced by about 50% compared to the biomass. In an embodiment, the total sugar in the product is reduced by about 60% compared to the biomass. In an embodiment, the total sugar in the product is reduced by about 70% compared to the biomass.

In an embodiment, the sucrose in the product is reduced by about 30% to about 90% compared to the biomass. In an embodiment, the glucose in the product is reduced by about 30% to about 60% compared to the biomass. In an embodiment, the fructose in the product is reduced by about 40% to about 60% compared to the biomass. In an embodiment, the fructose in the product is reduced by about 50% to about 60% compared to the biomass.

In an embodiment, the xylose, arabinose and/or mannose is reduced by about 30% to about 90% compared to the biomass. In an embodiment, the xylose, arabinose and/or mannose is reduced by about 30% to about 60% compared to the biomass.

In an embodiment, the sorbitol in the product is reduced by about 30% to about 90% compared to the biomass. In an embodiment, the sorbitol in the product is reduced by about 30% to about 60% compared to the biomass.

In an embodiment, the product comprises about 40 to about 80 g/L of total sugar. In an embodiment, the product comprises about 45 to about 75 g/L of total sugar. In an embodiment, the product comprises about 50 to about 70 g/L of total sugar. In an embodiment, the product comprises about 55 to about 65 g/L of total sugar.

In an embodiment, the concentration of an oligosaccharide is increased in the product compared to the biomass. In an embodiment, the oligosaccharide is selected from one or more or all of: i) a gluco-oligosaccharide, ii) a fructo-oligosaccharide, iii) a isomalto-oligosaccharide, and iv) galactoooligosaccahride. In an embodiment, the isomalto-oligosaccharide is panose.

In an embodiment, the concentration of a polysaccharide is increased in the product compared to the biomass. In an embodiment, the polysaccharide is dextran. In an embodiment, the polysaccharide is a fructan. In an embodiment, the fructan is levan. In an embodiment, the fructan is inulin.

In an embodiment, the product comprises pre-biotic oligosaccharides and/or polysaccharides.

In an embodiment, the concentration of one or more of: mannitol, isomaltose, and isomaltriose is increased in the material obtained by step ii) compared to the biomass. In an embodiment, the product comprises mannitol. In an embodiment, the product comprises isomaltose.

In an embodiment, the concentration of carotenoid is increased in the material obtained by step i) and ii) compared to the biomass. In an embodiment, the carotenoid is β-carotene.

In an embodiment, the product is a pre-biotic. In an embodiment, the product is a pro-biotic.

In an embodiment, the product is a sweetener.

In an embodiment, the product has a low glycaemic index.

In an embodiment, the product is a low calorie sweetener.

In some embodiments, the product comprises nutrients that are lost during other production processes such as chromatography. In an embodiment, the nutrients present in the biomass are not significantly reduced in the sugar reduced product. As used herein “significantly reduced” means that the nutrients are not reduced by more than 5%, or by more than 10%, or by more than 15%, or by more than 20%, or by more than 30% in the product compared to the biomass.

In an embodiment, the sugar reduced product is suitable for use in other products (e.g. tea, coffee and other beverages, baked goods, deserts e.g. ice cream). In an embodiment, the sugar reduced product is suitable for use in dairy products. In an embodiment, the sugar reduced product is suitable for use as a pre-biotic. In an embodiment, the sugar reduced product is suitable for use as a supplement.

In an embodiment, the sugar reduced product is suitable for use with a beverage base for example, a soy milk, nut milk or low sugar milk.

In an embodiment, the sugar reduced product comprises one or more bacteriocins produced during fermentation. As used herein “bacteriocins” are proteins or peptide toxins produced by bacteria that inhibit the growth of other bacteria.

In an embodiment, the sugar reduced product comprises polyphenols and/or polyphenolic derivatives. In an embodiment, the polyphenolic derivative is phenolic acid or phenolic aglycone.

In an embodiment, the sugar reduced product comprises a reduced amount of malic acid compared to the biomass.

In an embodiment, the product is a puree.

In an embodiment, the product is a powder. In an embodiment, the powder is carrot powder. In an embodiment, the carrot powder is high in carotenoids.

In an embodiment, the sugar reduced product comprises lactic acid bacteria.

### Example 1—Materials and Methods

### Chemical Reagents

All chemical and biochemical reagents used in the examples were of analytical grade or better.

### Bacteria

Leuconostoc mesenteroides NRRL B-512F was obtained from ARS culture collection (NRRL culture collection, USDA, Illinois, USA) and Leuconostoc mesenteroides ATCC 8293 was obtained via a local supplier. Initial screening experiments were conducted using both strains and based on the results, the ATCC 8239 strain was selected for subsequent experiments. Organic apple juice (Melrose, 70.3° Brix, pH=3.9) was used as a substrate (pH=3.9, ° Brix=70.3) in all fermentation experiments.

### Preparation of Bacterial Inoculum

For Examples 1 to 13 Leuconostoc mesentroides bacteria were incubated in primary culture and secondary culture. The bacteria were then added to 200 ml apple juice biomass and allowed to ferment for 24 hours. The primary medium was sterilised MRS broth. The secondary culture medium was a mixture of diluted apple juice (˜13° Brix), water and yeast extract as nitrogen source for bacteria pre-adaptation to the polyphenolic compounds in the apple juice. Leuconostoc mesentroides ATCC 8239 was used for all the experiments in examples 1 to 13 except in example 8 where the efficacy of ATCC 8923 was compared with Leuconostoc mesenteroides NRRL B-512F.

For Examples 14 and 15 MRS broth was used for the cultivation of the Leuconostoc mesentroides cells. 2 L of the broth were set up and split in 200 mL into Schott bottles. This bottles were autoclaved for 15 minutes at 121° C. to provide a sterile environment for the cultivation of the starter culture. Leuconostoc mesentroides ATCC 8239 was used for all the experiments in examples 14 and 15.

### Primary Culture

Leuconostoc mesenteroides ATCC 8239 and/or NRRL B-512F from −80° C. cells were inoculated into sterile MRS broth and incubated at 25° C. water bath for 24 hours.

### Secondary Culture

The secondary culture medium for Examples 1 to 13 consisted of 7 ml of concentrated apple juice, 5 ml 20% sterilised yeast extract and 38 ml of sterilised mili-Q water, which yields a final composition of 13° Brix apple juice and 4% yeast extract. Concentrated apple juice is a rich source of sucrose, fructose and glucose, which provide a carbon source for bacterial growth while the yeast extract was used as a nitrogen source. At the end of the 24 hours incubation, cells from the primary culture were harvested by centrifugation (5500 rpm, 15 min, 16° C.), washed twice with phosphate buffer (PBS) and were resuspended in 1 ml sterilised Mili-Q water. The optical density (OD) of the suspension was measured using a UV-Visible spectrophotometer (from Shimadzu) at 600 nm to estimate the biomass. Cells (˜1.5*10\hat{ }9) were added to the secondary culture medium for the pre-adaptation of the cells prior to inoculation into apple juice. After overnight incubation for 18 hours, the cells from 50 ml secondary culture were collected by centrifugation (5500 rpm, 15 min, 16° C.). The concentrated cells were washed with PBS, and were resuspended in 18 ml medium (with the exact same composition as the secondary culture medium). Six ml of the cell suspension was used as inoculum in subsequent apple juice fermentation experiments.

For Examples 14 and 15 the following secondary culture protocol was used. After the 17 hours of cultivation, 5 mL of the primary culture were inoculated into 200 mL sterile MRS broth and cultivated overnight (17 hours) at 25° C. in the incubator. After 17 hours the cells were harvested by centrifugation (5500 rpm [3615 g], T=16° C., t=15 min) and washed twice under the same centrifugation conditions with PBS. Afterwards the cells were resuspended in in a 1:1 mixture of 10% sucrose solution and a 30% glycerol solution at the required dose and stored at −80° C. until use.

### Substrate Preparation

Fermentation Examples 1 to 13 were conducted at various concentrations of apple juice, protein supplement, and buffering, with the objective of determining the factors that influence the conversion of sugars in the apple juice to functional food ingredients such as oligosaccharides, soluble exopolysaccharides and mannitol. In all cases, apple juice concentrate (° Brix=70.3) was used as a starting material.

All the additional components (K₂HPO₄, yeast extract, whey protein isolates (WPI)) were dissolved at the required amount in Mili Q water which was used for diluting the concentrated apple juice to the experimental concentration, and the solution was autoclaved prior to adding into the concentrated apple juice. Sterilised high concentration NaOH solution (6M) was used for pH adjustment in experiments where K₂HPO₄ was not used as a buffering agent. With regard to K₂HPO₄, 1.34 and 4 g K₂HPO₄ were used respectively for adjusting the initial pH of apple juice to 6.0 and 7.1 respectively. These amounts were determined based on preliminary experiments.

### Fermentation Experiments

For Examples 1 to 13 fermentation was conducted at 30° C. The initial pH of the juice was adjusted to between 5.3 and 7.1 so as to be within the pH range for the optimal growth of the organism. All experiments were conducted in triplicates in a shaking water bath maintained at 30° C. and 90 to 110 rpm depending on the concentration of apple juice. The fermentation experiments were conducted using sterile Schott bottles (250 ml) as bioreactors. The pH was not adjusted during the experiments and in most cases dropped to ˜4.0 at the end of fermentation. The detailed experimental conditions are presented in Table 1.

The fermentation experiment was conducted as follows:
The substrate solution was prepared as described above on the evening before the experiment, and kept at 4° C.
Leuconostoc mesenteroides cells were prepared and incubated in the primary MRS culture and secondary inoculum as described above.
The bacterial inoculum prepared as described above was used to inoculate 200 ml apple juice samples in Schott bottles. The three replicate samples were incubated at 30° C. in a shaking water bath, maintained at the experimental temperature for 24 hours. The shaking speed for the 13, 18.7, 23 and 34° Brix apple juice were respectively 90, 100, 110 and 120 rpm.
Time 0 samples were taken immediately after adding the inoculum and mixing.
Subsequently, samples were taken out periodically (every 2 hours), and pH, ° Brix and microbial biomass (OD) were measured immediately after collecting the samples. Samples for analysis of sugars, titratable acidity and volatile analysis were immediately frozen and kept at −20° C. until analysis. Samples at the end of fermentation were used for extraction and assay of the activity of glycosyltransferases.

For Examples 14 and 15 the following fermentation process was used with the initial liquid volume of 1.6 L in a bioreactor (Sartorius). In all cases, the pH was controlled at a set point using K₂HPO₄ solution. Response surface methodology with face centred central composite experimental design was used to evaluate the simultaneous effects of pH, temperature and juice concentration on the rate of microbial growth, total sugar reduction, and the expression of levansucrase and dextransucrase. Three levels of the experimental variables and their 15 combinations were investigated as shown in Table 2. A quadratic equation (Eqn 1) and its subsets were evaluated for the description of the response parameters.

$$Y = {b}_{o} + {\sum }_{i = 1}^{n} {b}_{i} {X}_{i} + {\sum }_{i = j = 1}^{n} {b}_{ij} {X}_{i} {X}_{j} \qquad ( 1 )$$

Where Y represents a response variable, n is the number of independent variables, bₒ, bᵢ, and bᵢⱼ are coefficients and Xᵢ and Xⱼ represent the independent variables. In order to determine the significance of adding terms of increasing complexity to the model, the sum of squares was determined sequentially. Analysis of

TABLE 1
Experimental design results of sugar profile analysis.

| | | | | | | | fructose + | | | |
|---|---|---|---|---|---|---|---|---|---|---|
| | | nutrient | | | | | glucose + | mannitol | isomaltose | panose |
| | Apple juice | source | secondary | cell | initial | sucrose | sucrose | formation | formation | formation |
| Run | concentration | addition | inoculum | strain | pH | reduction % | reduction % | (mg/ml) | (mg/ml) | (mg/ml) |
| 1 | 13° Brix | None | No preadaptation | ATCC | 5.8 | 61.05 ± | 7.72 ± | 0.00 ± | 1.51 ± | 0.00 ± |
| | | | | | | 0.83 | 3.57 | 0.00 | 0.28 | 0.00 |
| 2 | 13° Brix | None | No preadaptation | ATCC | 5.5 | 95.40 ± | 25.01 ± | 16.25 ± | 1.58 ± | 0.00 ± |
| | | | | | | 1.16 | 1.06 | 0.72 | 0.10 | 0.00 |
| 3 | 13° Brix | None | 13° Brix AP + YEP | ATCC | 6.1 | 94.81 ± | 14.52 ± | 7.52 ± | 1.66 ± | 0.00 ± |
| | | | | | | 0.89 | 1.46 | 1.26 | 0.16 | 0.00 |
| 4 | 13° Brix | None | 13° Brix AP + YEP | ATCC | 5.3 | 93.94 ± | 30.40 ± | 16.15 ± | 1.79 ± | 0.00 ± |
| | | | | | | 0.52 | 1.79 | 0.26 | 0.25 | 0.00 |
| 5 | 13° Brix | None | 13° Brix AP + YEP | ATCC | 6.1 | 94.87 ± | 31.30 ± | 21.36 ± | 1.95 ± | 0.00 ± |
| | | | | | | 0.27 | 3.34 | 1.00 | 0.23 | 0.00 |
| 6 | 13° Brix | None | 13° Brix AP + YEP | ATCC | 5.5 | 48.82 ± | 6.97 ± | 13.85 ± | 6.94 ± | 0.00 ± |
| | | | | | | 3.30 | 4.75 | 1.81 | 0.19 | 0.00 |
| 7 | 13° Brix | WPI | 13° Brix AP + YEP | ATCC | 5.8 | 94.36 ± | 32.56 ± | 24.00 ± | 1.66 ± | 0.00 ± |
| | | | | | | 0.27 | 2.53 | 0.58 | 0.07 | 0.00 |
| 8 | 13° Brix | YE | 13° Brix AP + YEP | ATCC | 5.9 | 91.05 ± | 34.42 ± | 29.50 ± | 1.44 ± | 0.00 ± |
| | | | | | | 0.27 | 4.18 | 1.34 | 0.02 | 0.00 |
| 9 | 13° Brix | 2% phosphate | 13° Brix % AP + YEP | ATCC | 7.1 | 95.01 ± | 22.25 ± | 23.95 ± | 1.25 ± | 0.00 ± |
| | | | | | | 0.15 | 5.66 | 0.50 | 0.13 | 0.00 |
| 10 | 34° Brix | None | 30% AP + YEP | ATCC | 5.7 | ±15.53 − | ±0.61 − | 0.00 ± | 3.02 ± | 0.00 ± |
| | | | | | | 1.67 | 2.11 | 0.00 | 2.36 | 0.00 |
| 11 | 23° Brix | None | 13° Brix AP + YEP | ATCC | 5.7 | 94.63 ± | 22.82 ± | 22.96 ± | 3.85 ± | 0.00 ± |
| | | | | | | 0.85 | 1.46 | 0.29 | 0.40 | 0.00 |
| 12 | 18° Brix | None | 13° Brix AP + YEP | ATCC | 5.9 | 95.25 ± | 26.33 ± | 21.05 ± | 2.58 ± | 0.00 ± |
| | | | | | | 0.73 | 0.69 | 0.30 | 0.14 | 0.00 |
| 13 | 13° Brix | 0.5% phosphate | 13° Brix AP + YEP | ATCC | 6.1 | 95.37 ± | 24.99 ± | 17.13 ± | 1.38 ± | 0.00 ± |
| | | | | | | 0.67 | 2.01 | 0.37 | 0.16 | 0.00 |
| 14 | 13° Brix | 0.5% | 13° Brix AP + YEP | ATCC | 6.1 | 94.60 ± | 26.76 ± | 17.17 ± | 1.44 ± | 0.00 ± |
| | | phosphate | | | | 0.89 | 0.55 | 0.09 | 0.27 | 0.00 |
| 15 | 13° Brix | None | 13° Brix AP + YEP | NRRL | 5.8 | 79.50 ± | 26.11 ± | 1.17 ± | 1.05 ± | 0.00 ± |
| | | | | | | 0.70 | 2.34 | 0.12 | 0.12 | 0.00 |
| 16 | 13° Brix | 0.5% CaCl2 | 13° Brix AP + YEP | ATCC | 5.7 | 84.86 ± | 29.18 ± | 19.84 ± | 0.82 ± | 0.00 ± |
| | | | | | | 1.04 | 1.78 | 1.00 | 0.07 | 0.00 |
| 17 | 13° Brix | 0.5% CaCl2 + | 13° Brix AP + YEP | ATCC | 5.4 | 94.27 ± | 29.14 ± | 18.18 ± | 0.00 ± | 12.36 ± |
| | | 5% maltose | | | | 0.73 | 1.18 | 0.53 | 0.00 | 0.23 |

TABLE 2
Response surface experimental design and data from the fermentation
experiments in a bioreactor under strict anaerobic condition.

| | | | | Microbial | | |
|---|---|---|---|---|---|---|
| | | Apple juice | | growth | Levansucrase | Dextransucrase |
| Temperature | | concentration | Total sugar | rate | activity | activity |
| (° C.) | pH | (° Brix) | reduction (%) | (ΔOD/hr) | (U/L) | (U/L) |
| 30 | 6 | 26 | 8 | 0.05 | 285.3 | 569.6 |
| 40 | 5 | 39 | 3 | 0.02 | 118.4 | 198.9 |
| 30 | 6 | 26 | 8 | 0.09 | 187.1 | 1000.0 |
| 30 | 6 | 39 | 25 | 0.02 | 147.6 | 383.6 |
| 20 | 7 | 39 | 24.4 | 0.07 | 1954.1 | 97.4 |
| 30 | 6 | 26 | 6 | 0.11 | 182.2 | 496.5 |
| 40 | 7 | 39 | 8 | 0.11 | 69.6 | 240.9 |
| 40 | 5 | 13 | −7 | 0.07 | 135.8 | 337.3 |
| 30 | 6 | 26 | 1 | 0.09 | 144.4 | 480.8 |
| 30 | 6 | 26 | 12 | 0.07 | 153.3 | 370.2 |
| 20 | 5 | 39 | 4 | 0.08 | 273.6 | 730.1 |
| 30 | 7 | 26 | 18 | 0.03 | 250.3 | 613.1 |
| 30 | 6 | 26 | 0 | 0.07 | 171.2 | 535.6 |
| 30 | 5 | 26 | 8 | 0.06 | 188.4 | 565.1 |
| 40 | 6 | 26 | 21 | 0.01 | 81.2 | 291.2 |
| 40 | 7 | 13 | 11 | 0.04 | 182.5 | 409.0 |
| 20 | 5 | 13 | −3 | 0.09 | 179.4 | 408.2 |
| 20 | 7 | 13 | 4 | 0.02 | 143.3 | 5887.6 |
| 30 | 6 | 13 | 12 | 0.11 | 363.7 | 1073.7 |
| 20 | 6 | 26 | 1 | 0.163 | 228.9 | 599.2 |

variance (ANOVA) was conducted to determine the significance of the model and individual model terms. Only significant model terms (Prob>F less than 0.05) and terms that are required to maintain model hierarchy were included in the final response surface equations. Only significant model terms (Prob>F less than 0.05) were included in the final response surface equations. In order to determine the adequacy of the selected models, the coefficient of determination and the adjusted coefficient of determination were determined. In addition several statistical diagnostic tests including the plots of studentized residuals versus run and factor were performed. The linearity of the normal plot was also evaluated to test if the normality assumption was satisfied. The experimental design and the data analysis were performed using Design Expert 7.1.3 (Stat-Ease Inc., Minneapolis, Minn., USA).

The K₂HPO₄ solution (in water sufficient for diluting the concentrated apple juice to the required concentration) was autoclaved prior to use in the experiments. Under sterile conditions the concentrated apple juice required to get the experimental apple juice concentration was mixed with sterile K₂HPO₄ solution in the bioreactor. The inoculum cells were defrosted and centrifuged at 10,000 rpm at 16° C. for 10 min.

The cells were then washed twice with PBS, which involved suspending the cells in PBS followed by centrifugation at 10,000 rpm at 16° C. for 10 min. Then the washed cells were suspended in diluted apple juice solution from the bioreactors and inoculated into the respective reactors. During the 24 hours of fermentation, the data logging system recorded the temperature, the stirrer speed, the pH value, the dissolved oxygen content, the air flow and the added K₂HPO₄ solution to maintain the pH at the set value. Samples were taken every hour from the bioreactor for further analysis and to determine the optical density (OD) as a measure of microbial growth. After 24 hours, two 25 mL samples were taken for post processing treatments and enzyme assay. The samples were centrifuged for 5 minutes at a speed of 13400 rpm before freezing and frozen storage at −80° C. to remove the microbial cells. In all cases, N₂ gas was used to maintain anaerobic condition in the bioreactor.

### Post-Processing

Two different post-process treatments were used after the fermentation process and compared. Based on the results of the fermentation experiments four samples were chosen and further processed by microwave or in a water bath maintained at 50° C.

Microwave Treatment:

Samples (5 mL) which were prepared in duplicate were treated with microwaves. The power setting on the microwave oven was adjusted to maintain a temperature between 40° C.-60° C. in the sample at the end of the treatment. The temperature range was selected as such since a lower temperature may not sufficiently enhance the enzymatic reaction and a higher temperature can inactivate the enzymes. To stop the reaction the samples were immediately cooled in ice water after the treatment. The power consumption during the treatment was calculated using the following equation (eqn 2):

$$P = \frac{{C}_{p} m Δ T}{t} \qquad ( 2 )$$

Where Cp=4.182 KJ/KgK is the heat capacity of water, m the mass of the sample, ΔT the temperature change in Kelvin and t the treatment time in seconds.

Heating:

Samples (5 mL) which were prepared in duplicate were treated with heat for 3 hours in a water bath maintained at 50° C. After the 3 hours incubation, the samples were cooled in ice water to stop the reaction. The sugar profile for each sample after the treatment was determined using the procedure described in the sugar profile analysis section.

### Assessment of Microbial Biomass

The microbial biomass was determined by measuring the optical density of the samples spectrophotometerically at 600 nm.

### Assessment of Sugar Profile

To assess the changes in the sugar profile of the apple juice during the fermentation process, samples were analysed in accordance with the following procedure.
1. The sample was centrifuged for 10 minutes at a speed of 13400 rpm.
2. Depending on the initial juice concentration in the sample the solution was diluted to a final juice concentration of 10%.
3. This solution was mixed with three volumes of ethanol (97% v/v).
4. This mixture was centrifuged for 10 minutes at a speed of 13400 rpm to remove high molecular weight soluble polymers in the sample.
5. The liquid supernatant was diluted with milli-q water in a ratio of 1:9.
6. This final solution was filtered through 0.2 μm syringes into HPLC vials.
7. The sugar profile of the samples was analysed using HPLC as described below.

### HPLC Analyses of Sugars, Mannitol, and Oligosaccharides

The analyses of sugars, mannitol and oligosaccharides in untreated and fermented apple juice samples were conducted using HPLC. Shodex Asahipak NH2P-50 4E (4.6×250 mm) (Showa Denko K.K., Japan) and Shodex Asahipak NH2P-50G (4.6×50 mm) (Showa 23 Denko K.K, Japan), were used for the HPLC analysis. The HPLC equipment comprised a 2690 Alliance Separations Module (Waters Inc.) and 410 RI Detector (Waters Inc.). Samples, after the removal of particulate material by alcohol precipitation, centrifugation and filtration were used for HPLC analysis. The Mobile phase was 68% acetonitrile in MilliQ water.

The HPLC operating conditions were as follows: Autosampler temperature 50° C., column temperature 30° C., detector internal temperature 35° C., mobile phase flow rate 1 ml/min and run time 60 minutes.

The standards were fructose 103674Y (Analar), glucose 346351 (Sigma), sucrose S-7903 (Sigma), isomaltose 17253 (Sigma), maltotriose M8378 (Sigma), maltotetraose 4-7877 (Supelco), maltopentaose 4-7876 (Supelco), maltohexaose 4-7873 (Supelco), maltoheptanose 4-7872 (Supelco), 1-kestose 72555 (Sigma) and nystose 56218 (Sigma).

The standard mixture was prepared using MilliQ water. The concentration of each covered the concentration range in the samples. A calibration curve was developed by injecting different volumes of the standard mixture. The area under the peak was plotted against the quantity of each standard injected (concentration of the standard solution (mg/mL)×injection volume (μl)×purity %). The slope and intercept were calculated by linear regression. The concentration of the respective saccharides in samples was calculated using the linear regression model of the calibration curves.

### Titratable Acidity

The titratable acidity was measured using an automatic titrator with 0.1 N NaOH as a titrant to an end point of pH 8.1. according to OECD method for analysis of fruit acids (OECD, 2005).

The total acidity was expressed as gram per litre of lactic acid calculated in accordance with the following equation (eqn 3):

$$Titratable acidity ( g \text{/} L ) = \frac{Titre \times acid factor \times 1000}{sample volume ( 10 ml )}$$

Where the titre is the volume of 0.1N NaOH required for titration to the end point and the acid factor was 0.009 for lactic acid. The titratable acidity was expressed as the relative change in acidity after fermentation i.e. as the ratio of the titratable acidity of the fermented samples to that of the unfermented apple juice.

### Enzyme Extraction and Assay

Enzyme Extraction and Partial Purification:

The crude enzyme extraction and partial purification was as follows:
1. Polyvinyl polypyrolidone (PVPP) (4%) was added to the 30 ml fermented apple juice, mixed and then centrifuged (4° C., 10000 rpm for 15 min) to remove polyphenols in the apple juice, which interfere with the extraction and assay of the enzymes.
2. This was followed by ammonium sulphate precipitation (70%) in order to partially purify the enzyme and remove the background sugar, which interferes with the assay.
3. The partially purified protein precipitate was dissolved in 5 ml of acetate buffer (pH=5.0) as a source of crude enzyme.

Dextransucrase Assay:

The activity of dextransucrase was assayed in accordance with the method of Da Silva et al. (2014) as follows:
1. Acetate buffer (pH=5.2) was used as the solvent for a 10% (w/v) sucrose solution containing 0.05 mg/mL CaCl₂) (Solution: S).
2. Enzyme extract (200 μL) was mixed with 800 μL of the sucrose solution.
3. For the blank, 200 μL acetate buffer was mixed with 800 μL the substrate solution.
4. The samples and the blank were incubated for 10 minutes at 30° C.
5. To inactivate the enzyme and stop the reaction the samples were heated for 5 minutes at 100° C. (boiling water).
6. Samples were cooled in ice water.
7. In order to remove the high molecular weight soluble polymers by precipitation, three volumes of ethanol (97% V/V) was added to the 0.5 ml samples.
8. The samples were then centrifuged at 13400 rpm for 10 minutes.
9. The supernatant was diluted 1:9 with milli-Q water and filtered through 0.2 μm syringes filter into HPLC vials.
10. The sugar content of the samples were analysed using HPLC.
11. One unit of the enzyme activity was expressed as the amount of enzyme that releases 1 μmol of fructose per min under the assay condition.

Levansucrase Assay:

The activity of levansucrase was assayed in a similar was as dextransucrase using raffinose, a specific substrate for levansucrase, as follows:
1. Acetate buffer (pH=5.2) was used as the solvent for a 10% (w/v) raffinose solution containing 0.05 mg/mL CaCl₂).
2. 200 μL of the enzyme extract was mixed with 800 μL of the raffinose solution.
3. The blank was 200 μL acetate buffer mixed with 800 μL solution R.
4. Subsequent steps were similar to the dextransucrase assay.
5. One unit of levansucrase activity was defined as the amount of enzyme that releases one micromole of glucose per min under the assay condition.

Total Soluble Polysaccharides Analysis:

The total soluble polysaccharide content of the samples was estimated using the total carbohydrate assay of Dubois et al. (1956) in accordance with Honorato el al. (2007). Accordingly,
1. Three volumes of ethanol (97% V/V) were added to 0.5 ml fermented apple juice samples.
2. The mixture was centrifuged at 4° C., 16400 rpm for 15 min. Then the precipitate was used for dextran analysis, whereas the supernatant was kept for sugar analysis by HPLC.
3. The precipitate was resuspended in 1 ml Mili Q water and centrifuged two times at 4° C., 16,400 rpm for 15 min to remove the microbial biomass in the samples.
4. After centrifugation, the supernatant was diluted with Mili Q water for analysis.
5. 5% phenol and concentrated sulphuric acid (proportion 1:5) were added to the diluted solution, while keeping the test tubes in ice water.
6. The test tubes were shaken and mixed, and incubated in a water bath maintained at 80° C. for 30 min.
7. After incubation, the text tubes were put in ice water to cool them down to room temperature.
8. The absorbance of the samples were measured at 470 nm and expressed as dextran equivalent using a standard curve developed with dextran solutions with a range of concentration.
9. The amount of soluble polysaccharides were reported as the difference between the total soluble polysaccharide content in the sample after fermentation and prior to fermentation.

### Example 2—Effect of Apple Juice Concentration on Sugar Conversion

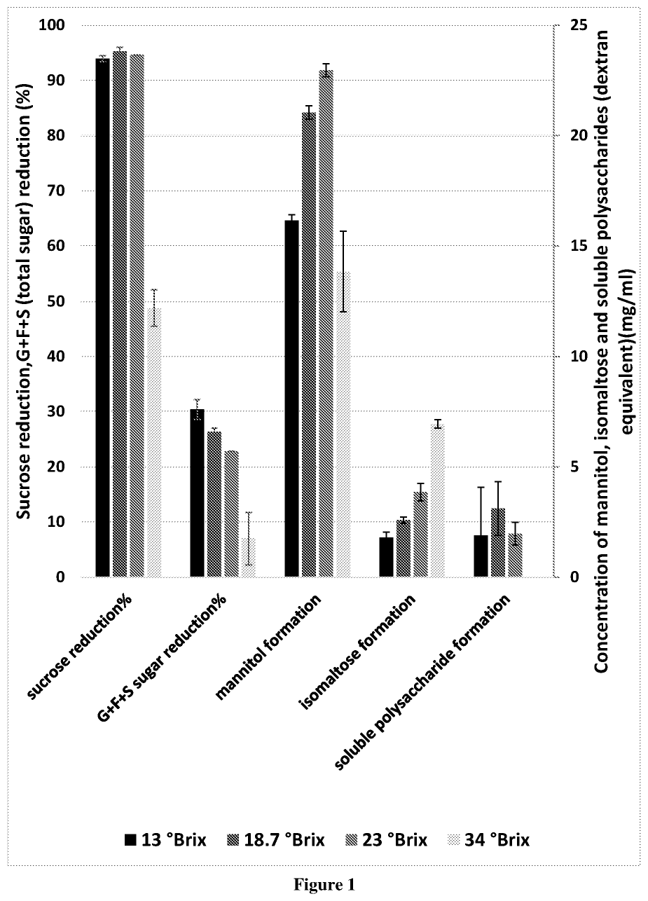

To assess the effect of apple juice concentration on the fermentation rate and sugar conversion during fermentation, concentrated apple juice was diluted with sterilised MiliQ water to 13, 18.7, 23 and 34° Brix separately without extra nutrient sources. Leuconostoc mesentroides ATCC 8293 from MRS primary culture was washed, concentrated, and then pre-adapted in 50 ml 13° Brix apple juice with 2% yeast extract secondary inoculum, before adding to the 200 ml fermentative apple juice as described in Example 1. The objective of the pre-adaptation in the secondary culture was to provide a similar fermentative condition for the cells as in the apple juice. The initial pH was adjusted to pH 5.5±0.2 for all the fermentative apple juice culture. Samples before and after 24-hour fermentation were collected, and the concentrations of reducing sugar, mannitol, isomaltose, and soluble polysaccharides were evaluated as described above in Example 1. The results are presented in FIG. 1.

After 24 hour fermentation, there was a significant reduction (from 44.8% to 95.3%) in sucrose concentration in the apple juice. The concentrations of all the high calorie, high GI sugars, including fructose, glucose, sucrose, showed a clear decrease. The mannitol, isomaltose and other sugar polymers were not present in the samples before fermentation. However, they were formed during the fermentation process.

With regard to the sucrose reduction, 13 (equivalent to a single strength apple juice), 18.7 and 23° Brix apple juice all showed very similar and dramatic reduction (from 93.9% to 95.2%). However, there was only 48.2% decrease in sucrose concentration before and after fermentation of the 34° Brix apple juice, which was much lower than the other concentrations. With regard to the reduction in total reducing sugars and sucrose, the lowest decrease (only 7%) was observed in the 34° Brix juice. The 13° Brix apple juice gave the best performance with 30.4% decrease in total sugars, which implies that 13° Brix apple juice had the lowest calories after fermentation. As for the mannitol formation, there was a slight increase from 13° Brix apple juice to 23° Brix apple juice, with the lowest formation level in 34° Brix apple juice. There was no substantial amount of isomaltose and soluble polysaccharide formation (below 10 mg/ml) in all the samples of different concentrations. No significant production of water soluble polysaccharides occurred during the fermentation process of the 30% apple juice. It has to be noted that the assay that was used for polysaccharides analysis is non-specific total carbohydrate assay and was able to measure only the water soluble portion of the carbohydrates that precipitated following treatment by ethanol.

### Example 3—Effect of Initial Fermentation pH on Sugar Conversion During Apple Juice Fermentation

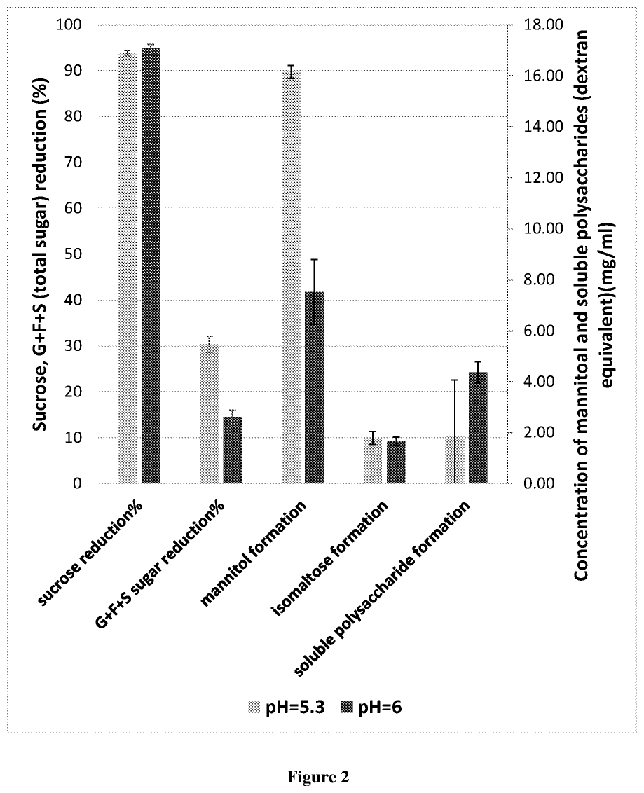

Since the highest sugar reduction and hence calorie reduction were observed with the 13° Brix apple juice, further experiments to investigate the effect of initial fermentative pH on sugar conversion during fermentation were conducted with 13° Brix apple juice as substrate. In these experiments, Leuconostoc mesenteroides (ATCC 8293) was used in the fermentation experiments after pre-adaptation following the protocol described in Example 1 without added extra nutrient sources. FIG. 2 shows the extent of sugar conversion after 24 hours of fermentation at different initial pH of the fermentation media.

According to literature the optimal pH for the growth of Leuconostoc mesentroides ATCC 8293, is pH 6.0. Similarly, dextransucrase from Leuconostoc spp. have optimal activity at pH 5-6. Therefore, two levels of pH between 5 to 6, pH=5.3 and pH=6 were chosen to study the effect of initial fermentative pH on sugar conversion during apple juice fermentation.

From the results, it is clear to see that sucrose reduction reached to over 90% (93.9% and 94.8% separately) under both initial pH conditions. In terms of total sugar reduction, pH 5.3 gave a much better performance than pH 6. The concentrations of glucose, fructose and sucrose in total reduced by 30.4% under pH 5.3 conditions, which was 2 times more than at the initial pH of 6. As for mannitol formation, samples under pH 5.3 fermentative conditions displayed nearly twice more mannitol formation than pH 6. However, more dextran were formed in the ferment at initial pH of 6 (1.26 mg/ml) than under pH 5.3 condition (with only 0.26 mg/ml formation). At both pH conditions, limited amount of soluble polysaccharides were formed. Relative increase in cell biomass under both pH conditions showed a very similar trend with Nt/No of 4.3 and 4.2 for pH 6 and pH 5.3 respectively at the end of 24 hour fermentation.

Considering the high calorie sugar reduction and low calorie functional ingredient formation after fermentation into consideration, pH 5.3 was more preferable initial pH than pH 6 in the apple juice fermentation process.

### Example 4—Effect of Nitrogen Source on Sugar Conversion During Apple Juice Fermentation

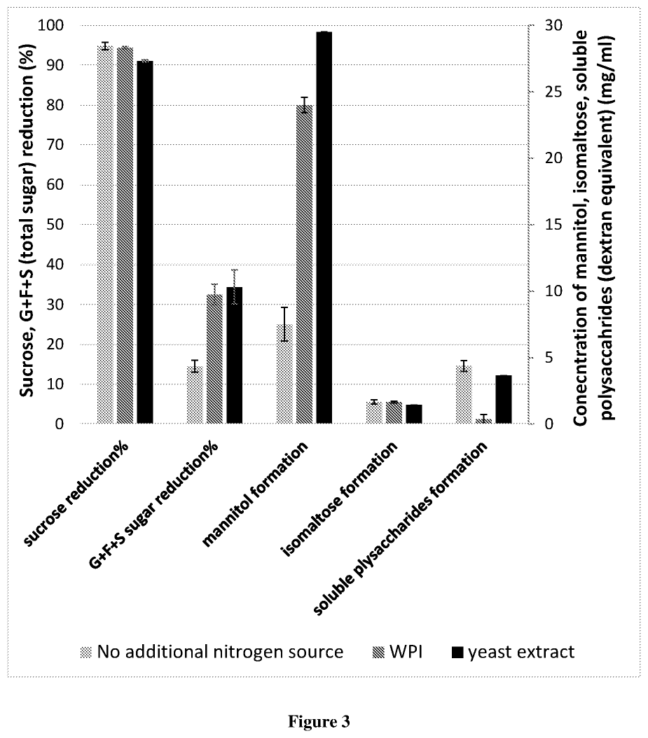

The effect of added nitrogen on sugar conversion was investigated using 13° Brix apple juice as substrate and the Leuconostoc mesenteroides ATCC 8093 as inoculum after pre-adaptation as described in Example 1. The initial pH was 5.9±0.1 in all cases. In these experiments, the effect of two types of nitrogen source, whey protein isolates (WPI) and yeast extract (YE) on sugar conversion, were compared with control apple juice without additional nitrogen source. The results are shown in FIG. 3.

The sucrose reduction with and without nitrogen source addition were very similar in all cases with more than 90% sucrose decrease in the apple juice after fermentation. With respect to total sugar reduction and mannitol formation, addition of extra nitrogen source had a significant positive effect under the condition of investigation (initial pH ˜6.0). Samples with added WPI and yeast extract had 32.2% and 34.4% total sugar reduction, compared to samples without nitrogen source with only 14.5% total sugar reduction. With regard to mannitol formation, in the fermented apple juice, adding extra nitrogen source, resulted in four times more mannitol production compared to apple juice without nitrogen adjustment. Using yeast extract as a nitrogen source resulted in slightly higher mannitol formation than whey protein isolates. As for isomaltose formation, there was no significant difference in all the three apple juice samples. No significant production of soluble polysaccharides was observed in the apple juice with added WPI whereas similar amounts of soluble polysaccharides were produced in the control juice and the juice with added yeast extract following fermentation. No significant difference was observed in the production of isomaltose.

Nitrogen source addition promotes additional high calorie sugar reduction and healthy functional food ingredients formation in apple juice fermentation processes.

### Example 5—Effect of Phosphate on Sugar Conversion During Apple Juice Fermentation

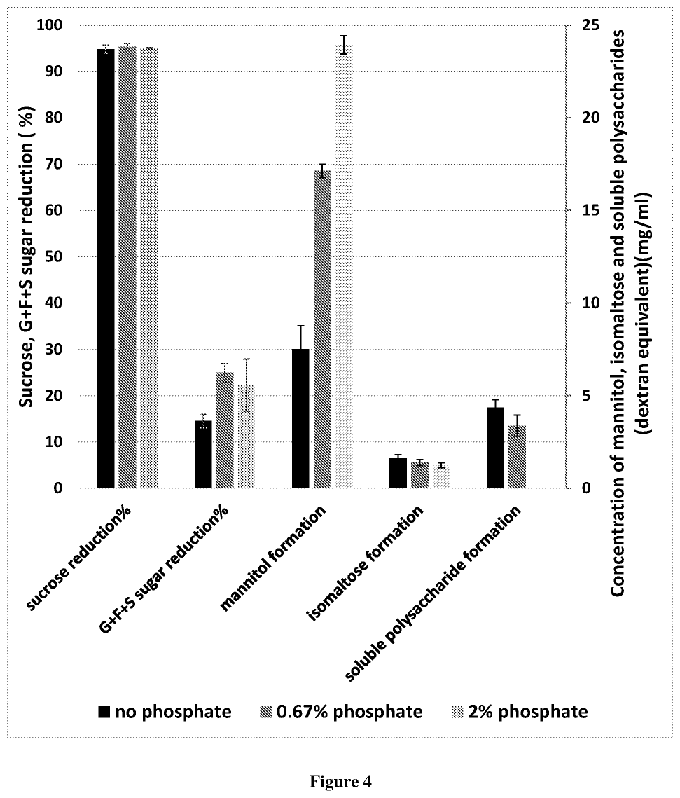

The effect of phosphate addition on sugar conversion during fermentation was also assessed using 13° Brix apple juice as substrate with pre-adapted Leuconostoc mesenteroides ATCC 8293 cells. Two different levels of phosphate (2% and 0.67%) were added to the apple juice which raised the pH of the juice to pH 7.1 and pH 6.1, respectively. The results are shown in FIG. 4.

As can be seen in FIG. 4, it is clear that all samples with and without phosphate addition demonstrated a very similar and high levels of sucrose reduction (˜95%). With phosphate addition, there were higher level of total sugar reduction, and more mannitol formation. With regard to the other sugar polymers (like dextran), no significant production was observed in the apple juice with 2% phosphate. Overall, apple juice with 0.67% phosphate gave the best performance among all the three samples investigated. The difference between samples with 0.67% and 2% added phosphate could be probably due to the pH. With 0.67% phosphate addition, the pH of apple juice culture was adjusted to 6, which was within the optimal pH range for the growth of Leuconostoc mesentroides condition, could be more favourable for the production of active enzymes involved in sugar conversion and/or their activity. On the other hand, under a similar initial pH (pH 6), the use of phosphate led to a significantly higher total sugar reduction and mannitol formation. In addition, phosphate also played a role on the cell growth rate, which slightly increased the cell growth rate compared to the samples without phosphate addition (more details can be seen in Example 10). However, if there was too much phosphate addition, the cells experienced a longer lag phase. For instance, if phosphate was added at 2% and the pH adjusted to 7.1, cells rarely grow or didn't grow in the first 6 hours of fermentation.

### Example 6—Effect of CaCl₂ and Maltose on the Sugar Conversion During Apple Juice Fermentation

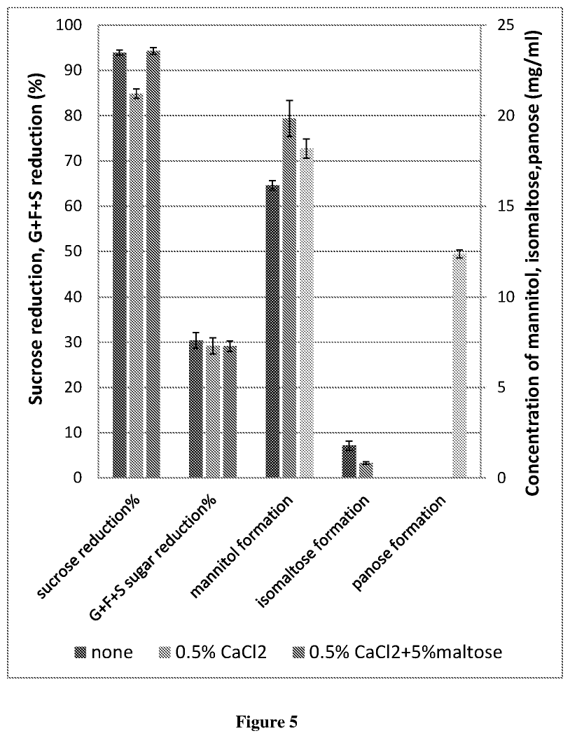

Apple juice samples (13° Brix) with pre-adapted Leuconostoc mesentroides ATCC 8923 cells and with the initial pH adjusted to 5.5±0.2 were used with added CaCl₂ and maltose so as to determine the effects of these compounds on sugar conversion during fermentation. The data are presented in FIG. 5.

The sucrose reduction in apple juice culture with 0.5% CaCl₂ and maltose was slightly higher than apple juice with no added extra nutrients, while apple juice with only 0.5% CaCl₂ showed the lowest level of sucrose reduction. However, no significant difference was observed in total sugar reduction among these three samples, with about 30% reduction in all cases.

However, slightly higher production of mannitol was observed in apple juice with 0.5% CaCl₂, and 0.5% CaCl₂ and maltose compared to the control apple juice. Interestingly, no isomaltose formation was observed in the apple juice with added maltose. Rather, significant amount of panose was formed in the sample. Unlike the other experimental conditions, addition of maltose resulted in a significant amount of oligosaccharide production, which indicates that maltose is a stronger and more efficient acceptor than fructose and glucose which are naturally present in the juice. In addition, CaCl₂ and maltose addition lead to 4 times higher fermentation rates (Nt/N0=12.5) compared to control apple juice (Nt/N0=4.3), which could be due to the extra mineral nutrient provided by CaCl₂.

In summary, maltose is a better acceptor than fructose and glucose in acceptor reaction for low-molecular oligosaccharides production and enables the production of panose. CaCl₂ could supply additional mineral source to meet the requirement for better cell growth and production of enzymes in the apple juice fermentative culture, resulting in a slightly higher production of low-calorie mannitol in the culture. However, CaCl₂ did not have any effect on total sugar reduction during fermentation of apple juice.

### Example 7—Effect of Apple Juice Concentration in Secondary Inoculum on Sugar Conversion During Fermentation

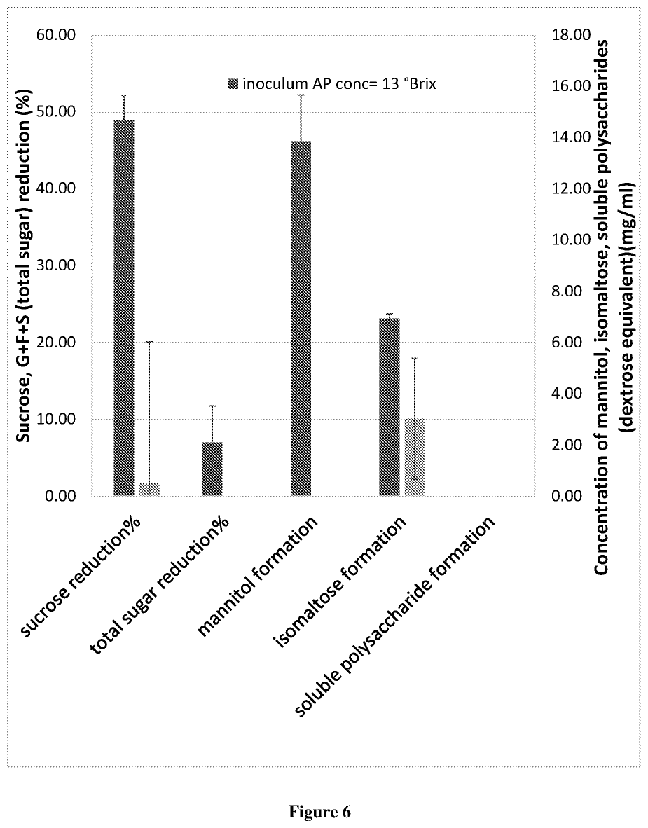

In the case of the fermentation experiment on 34° Brix apple juice, different apple juice concentrations were used in the secondary inoculum to choose the best pre-adaptation condition. No additional nutrient source was added to the 200 ml apple juice fermentative culture in this case, and the culture was adjusted to pH 5.5±0.2. The 13° Brix apple juice secondary inoculum turned out to be more suitable for pre-adaptation than 34° Brix apple juice, as shown in FIG. 6.

Dramatic differences in sucrose reduction and total sugar reduction were observed between the two pre-adaptation conditions. Cells pre-adapted in 34° Brix apple juice caused only a very small reduction in sucrose (1.7%) compared to cells pre-adapted in 13° Brix apple juice inoculum (48.8%). There was minimal hydrolysis of sucrose into fructose and glucose with no further conversion of these sugars into other compounds (mannitol, soluble polysaccharides) and limited conversion into isomaltose, resulting in a net increase in total sugar content of about 8% in samples fermented by cells pre-adapted in 34° Brix juice. Isomaltose formation in juice fermented using cells pre-adapted in 34° Brix apple juice was half the amount that was produced in apple juice fermented by cells pre-adapted in 13° Brix apple juice. As for dextran formation, no measurable dextran production was observed in either of these two samples. In general, the 34° Brix apple juice concentration was not the most suitable condition for total sugar reduction regardless of the pre-adaptation condition. However, compared to the 34° Brix apple juice pre-adapted inoculum, the 13° Brix apple juice pre-adapted inoculum resulted in a much better performance in the 34° Brix apple juice culture with significantly higher total sugar reduction and mannitol formation.

### Example 8—Comparison on the Effect of Different Strains of Leuconostoc Mesentroides (ATCC 8293 and Commercial Strain NRRL B512F) on Sugar Conversion During Fermentation

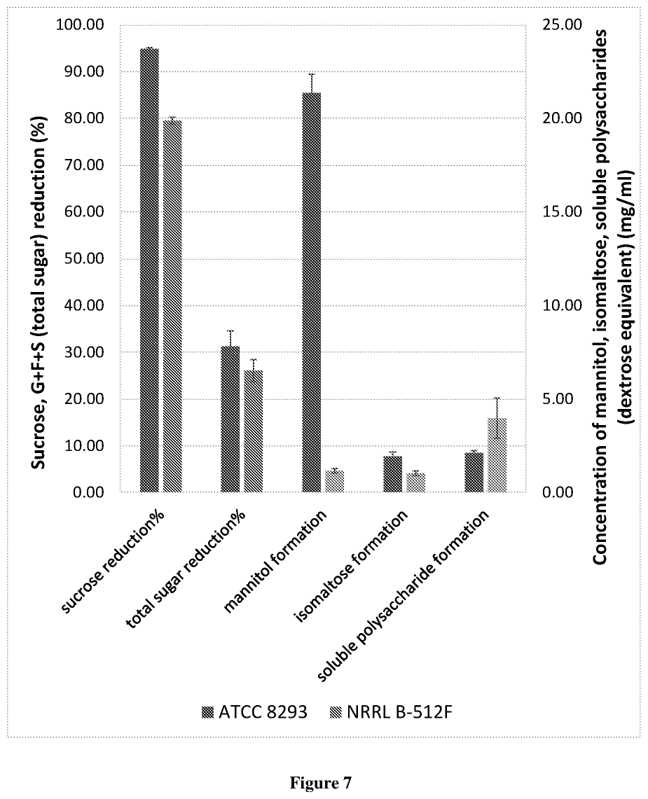

In this study, the efficiency of Leuconostoc mesentroides ATCC 8293 in sugar conversion during apple juice fermentation processes was compared with the commercial strain NRRL B-512F. The same amount of inoculum from these two strains after pre-adaptation was added to 13° Brix apple juice with no added extra nutrients. The fermentation process was conducted under the same condition, at an initial pH 5.8±0.2 for 24 hours. The results are presented in FIG. 7.

FIG. 7 shows that there were higher sucrose and total sugar reduction as well as mannitol and isomaltose formation with ATCC 8293 strain than the commercial B-512F strain. On the other hand, the NRRL B-512F strain was slightly more efficient in soluble polysaccharide formation.

Taking total sugar and sucrose reduction and functional compounds formation (isomaltose and mannitol) into consideration, Leuconostoc mesentroides ATCC 8293 was more suitable than NRRL B-512F under the studied condition for the fermentation of apple juice and conversion of sugars into low calorie and healthy ingredients.

### Example 9—Overall Comparison of the Influence of Different Types of Additional Nutrient and Phosphate Addition

The effects of different types of extra nutrient sources and/or phosphate addition were compared on sugar conversion and healthy functional ingredients formation in apple juice during 24 hours fermentation. 13° Brix apple juice was chosen to be the natural fermentative culture, and pH was pre-adjusted to 5.8±0.2. Leuconostoc mesenteroides 8293 cells pre-adapted in 13° Brix apple juice with yeast extract were used as inoculum in the fermentation experiments.

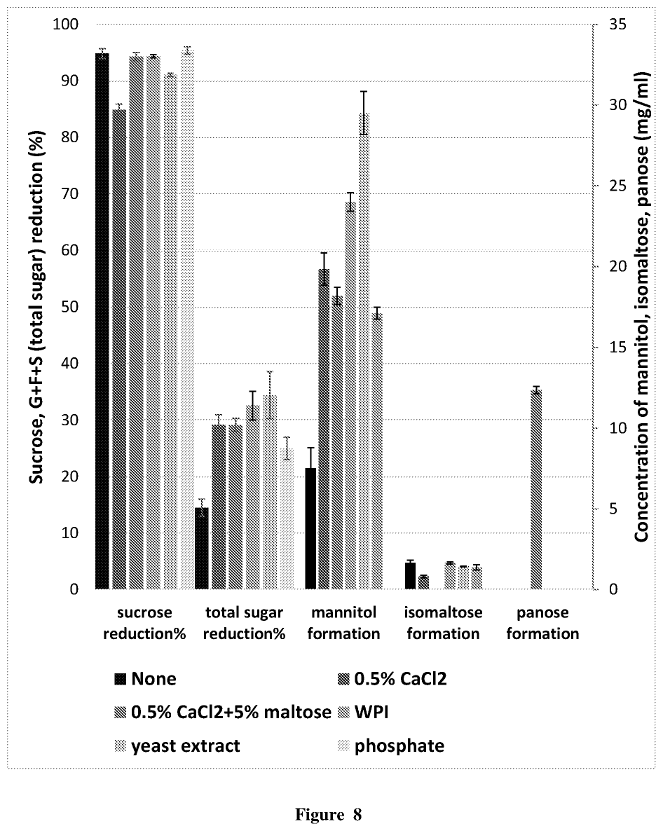

From FIG. 8, it is clearly seen that all the experiments gave a similar level of sucrose reduction (over 90% sucrose reduction), except samples with 0.5% CaCl₂ which resulted in a slightly lower sucrose reduction (84%). This is unexpected considering that CaCl₂ enhances the hydrolytic activity of dextransucrases which seem to be one of the enzymes responsible for the reduction of sucrose during fermentation. With regard to total sugar reduction and mannitol formation, addition of extra nutrient source and phosphate resulted in much better performance compared to the apple juice only control. Adding 0.5% CaCl₂ and 0.5% CaCl₂+5% maltose decreased the total high calorie sugar to almost the same level as the other nutrient, and comparable amount of mannitol production. Adding extra nitrogen source for a well-balanced environment for cells growth and enzyme production, resulted in the highest total sugar reduction and mannitol formation. Yeast extract and whey protein isolate (WPI) showed similar effect in terms of total sugar reduction whereas mannitol formation was slightly higher with yeast extract, probably due to a higher bioavailability. As for isomaltose formation, similar low level of formation (approximately 1.5 mg/ml) was observed in all the samples except in samples with added CaCl₂ where even lower amount (0.8 mg/ml) of isomaltose was formed in the apple juice after 24 hour of fermentation. In samples with added maltose in addition to CaCl₂, no isomaltose was formed in the end product. In this case, a significant amount of panose, a trisaccharide, was formed, although no production of higher DP oligosaccharides were observed under the investigated conditions. The addition of phosphate in the media also improved total sugar reduction and production of mannitol over and above that was observed for apple juice alone, which could be due to its buffering capacity, which keeps the pH of fermentation culture in the optimal pH for enzyme production and activity for a relatively longer period during fermentation.

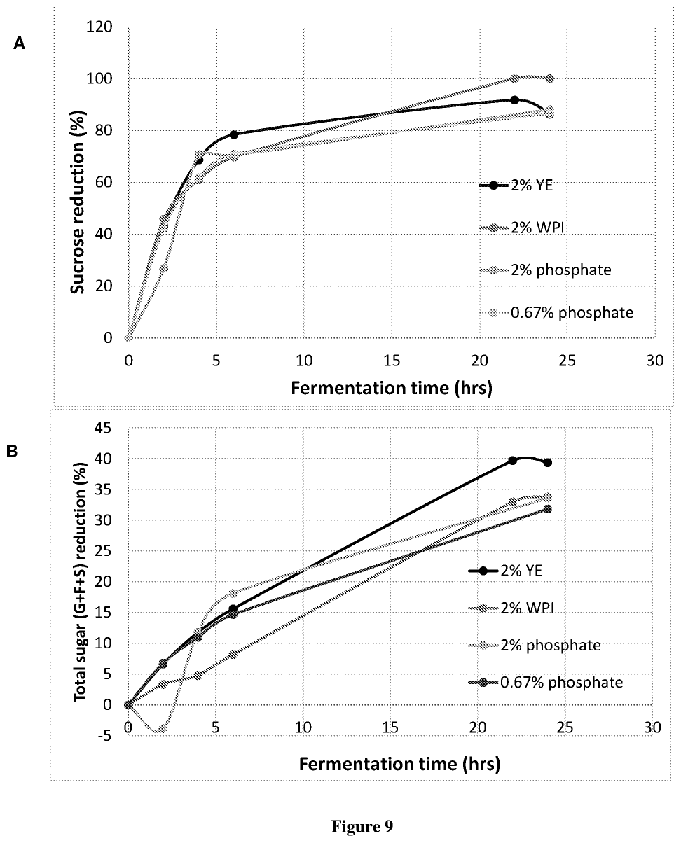

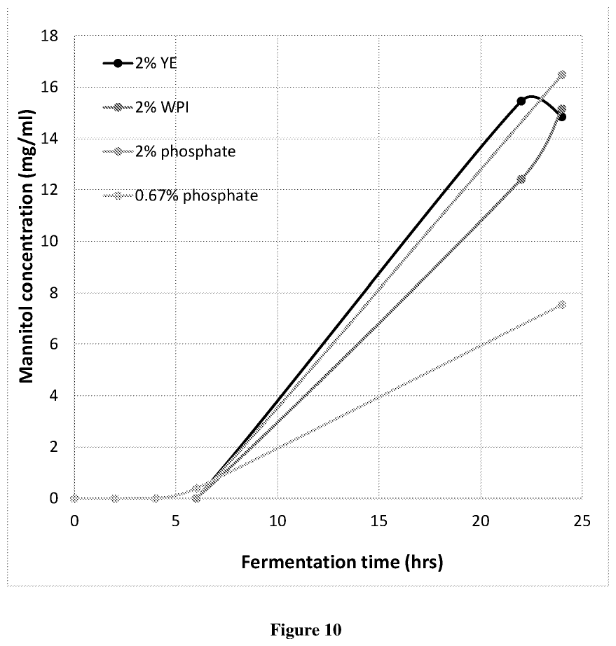

The effect of fermentation time on sugar profile, total sugar reduction and mannitol production were also evaluated. Data for selected conditions are presented in FIGS. 8 and 9. It can be seen that almost all the sucrose was hydrolysed during the first 6 hours of fermentation, which indicates that sufficient activity of glycosyltransferases was expressed in the samples during this period (FIG. 9a). However, only 25 to 55% of the total sugar reduction occurred during the first 6 hours (FIG. 9b). The rest of the sugar reduction took place between the 6 and the 22^{nd} hr. Mannitol production started after 6 hrs of fermentation except in the juice supplemented with 0.5% phosphate where a small amount of mannitol was measured after 6 hrs of fermentation (FIG. 10). The result indicates that sufficient amount of glycosyltransferases could be synthesised during 6 hours of fermentation and that time is sufficient for enzyme production in a two-step enzymatic conversion process.

### Example 10—Effect of Different Fermentation Factors on Cell Growth Rate (Nt/NO)

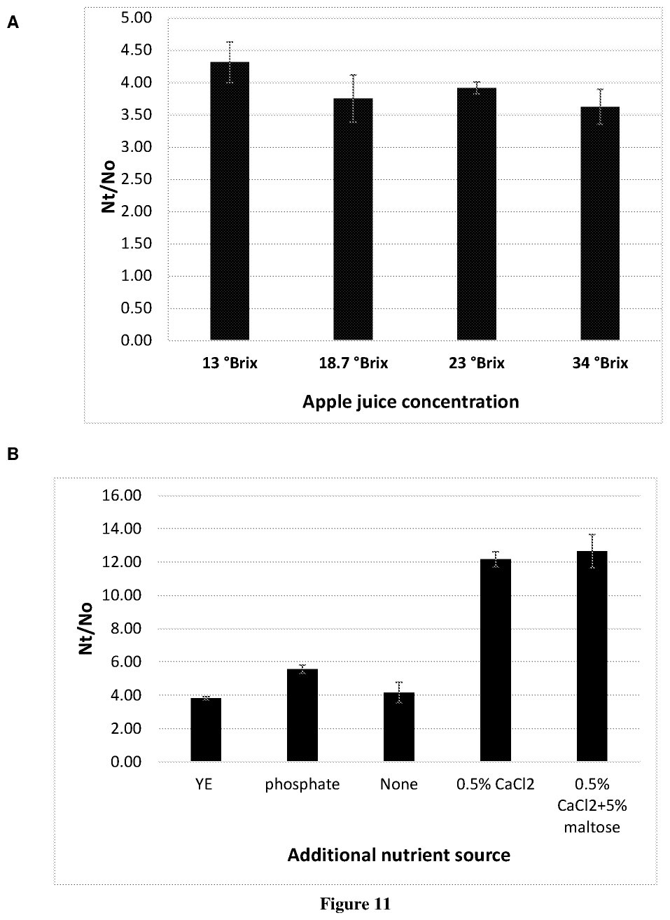

Different fermentation conditions led to different cell growth rate (Nt/NO). Apple juice concentration did not have a significant influence on ATCC cell growth during fermentation process, which is shown in FIG. 11a. It can be seen that cell growth rate in 13, 18.7, 23 and 34° Brix apple juice did not have a significant difference.

However, different types of nutrient source and phosphate addition did affect the cell growth. From FIG. 11b, it can be seen that mineral source (CaCl₂ addition) resulted in the highest cell growth rate (before and after fermentation). Maltose caused a slight increase on the cell growth rate. Cell growth rate in the apple juice fermentation culture with phosphate addition was three times more than that without phosphate addition. The cell growth rate with added nitrogen source (yeast extract) was 1.4 times more than those without yeast extract addition in the fermentation culture. In conclusion, extra nitrogen source, phosphate, mineral and maltose addition could all increase cell growth rate. Mineral addition had the most significant effect on cell growth rate.

### Example 11—Effect of Apple Juice Culture Concentration on Lactic Acid Formation

Titratable acidity is a very important quality attribute, which determines the sensory quality and acceptability of beverages. Leuconostoc mesenteroides are heterofermentative lactic acid bacteria which produce lactic acid, acetic acid, CO₂ and ethanol during fermentation. As such, fermentation of apple juice by Leuconostoc mesenteroides leads to changes in the titratable acidity of the product. Therefore, the changes in the titratable acidity of apple juice after fermentation at different concentrations (13, 18.7, 23, and 34° Brix apple juice samples) under the same fermentative conditions with pH adjustment to 5.8±0.1, where no extra nutrient sources or phosphate addition was examined. The change in acidity was expressed as the relative change i.e. acidity after 24 hour fermentation/acidity before fermentation in gram equivalent lactic acid per litre. The reference samples were unfermented 13, 18.7, 23, and 34° Brix apple juice with no added components.

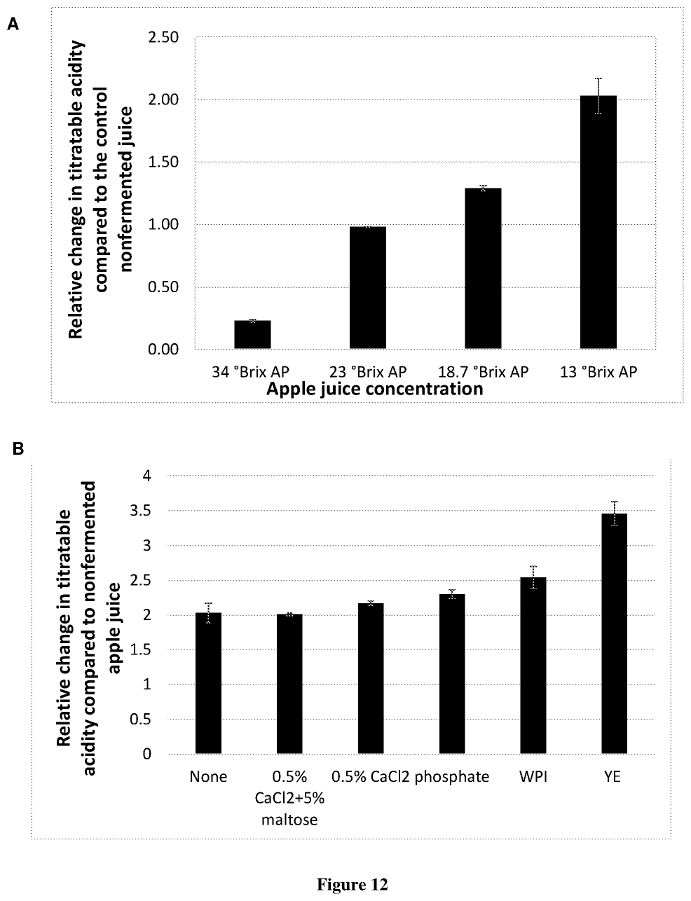

FIG. 12a shows that relative change in the titratable acidity of the juices after 24 hour fermentation increased with decrease in apple juice concentration. The highest increase in titratable acidity was observed in the 13° Brix apple juice where 2.0 times increase in acidity was observed compared to the reference 13° Brix unfermented apple juice. On the other hand, a significant decrease in acidity was observed in the 34° Brix apple juice with the acidity of the fermented juice being only 0.23 times that of the unfermented juice. There was no change in the titratable acidity of the 23° Brix apple juice whereas some increase was observed in the 18.7° Brix apple juice. Titratable acidity measures the overall acidity of the product including the acidity from malic acid and other acids that are naturally present in apple juice. While fermentation by lactic acid bacteria such as Leuconostoc mesenteroides leads to the production of lactic and acetic acid, the organisms also metabolise malic acid into lactic acid. Lactic acid is a monocarboxylic acid while malic acid is a di-carboxylic acid contributing twice to titratable acidity compared to lactic acid. In the 34° Brix apple juice where the fermentation is relatively inefficient, relatively low lactic acid may have been formed whereas malic acid, the major acid in apple juice, was degraded. This may have led to the overall decrease in titratable acidity. Indeed, a complementary untargeted metabolomic analysis of the samples (data not presented) showed that there was a significant decrease in malic acid (2.5 times) whereas there was no statistically significant increase in lactic acid. The same applies to the overall change in titratable acidity in the other samples.

### Example 12—Effect of Additional Nutrient Sources and Phosphate on Titratable Acidity of the Fermented Juice

It can be clearly seen from FIG. 12b that extra nitrogen sources enhanced changes in titratable acidity of the product perhaps due to more efficient fermentation and higher rate of lactic acid formation. The highest increase of titratable acidity of about 3.5 times was observed in juice samples with added yeast extract followed by samples with added WPI. This was also confirmed by the complementary untargeted metabolomics analysis. In samples with added yeast extract, there was substantial production of lactic acid, whereas there was also an increase in malic acid. On the other hand, in samples supplemented with WPI, there was a significant increase in lactic acid whereas substantial decrease in malic acid was observed during fermentation. This explains the relative difference in changes in titratable acidity of the samples. Phosphate and mineral source provision also enhanced changes in titratable acidity, although to a lesser extent. On the other hand, addition of maltose did not increase the change in titratable acidity over and above the control samples.

### Example 13—the Activities of Levansucrase and Dextransucrase Following Apple Juice Fermentation at Different Conditions

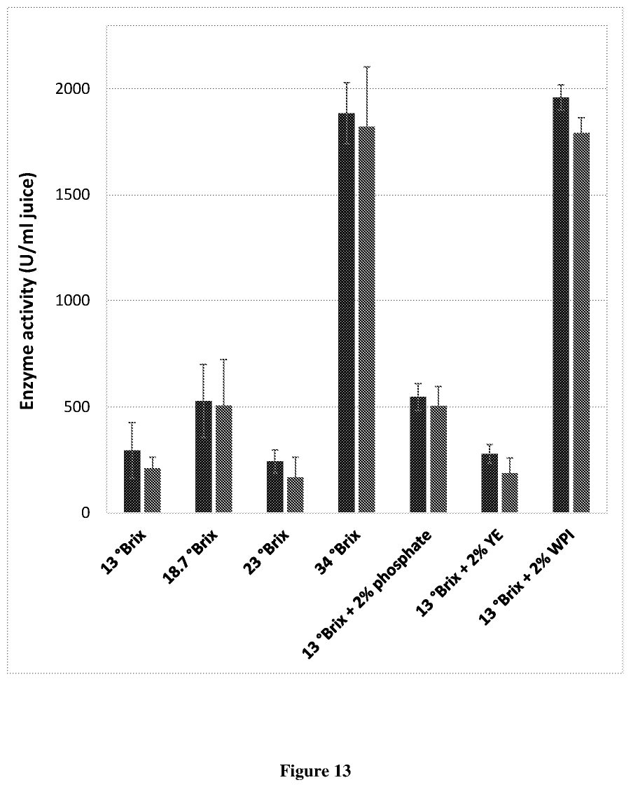

The activities of levansucrase and dextransucrase were assayed in apple juice samples with different concentration and added nutrients fermented as described in Example 1. Data are presented in FIG. 13. As can be seen the highest synthesis of dextransucrase and levansucrase was observed in the 34° Brix apple juice and in the 13° Brix apple juice supplemented with 2% whey protein isolate (WPI). Nevertheless, this was not reflected either in the total sucrose or sugar reduction data or the formation of oligo and soluble polysaccharides. It seems that the level of enzyme activity expressed in the 13° Brix apple juice is sufficient to catalyse the almost complete hydrolysis of sucrose. The higher concentration of isomaltose in the 34° Brix apple juice does not seem to be due to the higher expression of these enzymes in the sample. Rather, it is due to the higher sugar concentration that favours conversion to oligosaccharides instead of polysaccharides. However, 34° Brix apple juice or apple juice supplemented by WPI could be used for the production of enzymes in a two-step process for the enzymatic conversion of simple sugars in fruits and sugar rich vegetables into oligosaccharides and polysaccharides, thereby resulting in products enriched with prebiotic oligosaccharides and soluble fibre and reduced sugar. It has to be noted that the assays were conducted on crude enzyme extracts containing various activities including levansucrase, dextransucrase and mannitol dehydrogenase which catalyse complex reactions other than hydrolysis of sucrose and raffinose to fructose and glucose. As such the activities assayed based on the amount of fructose and glucose in the assay mixture give only an indication of the activities of the respective enzymes.

### Example 14—Total Sugar Reduction, Levansucrase and Dextransucrase Activity During Fermentation Under Constant pH and Strict Anaerobic Condition in a Bioreactor

The data from the response surface experiment on the effects of fermentation variables on total sugar reduction, microbial growth rate, levansucrase and dextransucrase activities are summarised in Table 2. The total sugar reduction after 24 hours of fermentation varied from −7% for 13° Brix juice during fermentation at 40° C. and pH 5 implying an increase in the concentration of simple sugars to a maximum of 25% during fermentation of the 39° Brix juice at 30° C. pH 6.0. The total sugar reduction was significantly (p>0.05) affected by juice concentration and pH. Overall, the total sugar reduction exhibited an increasing trend with increase in pH and juice concentration. Nevertheless, the response surface model did not describe the data well (R²=0.40105). The microbial growth rate ranged from 0.01 to a maximum of 0.16 OD/hr in the 26° Brix juice at pH 6 and 20° C. As the total sugar reduction, no clear trend was observed with respect to microbial growth rate and none of the experimental variables had a statistically significant effect (p>0.05).

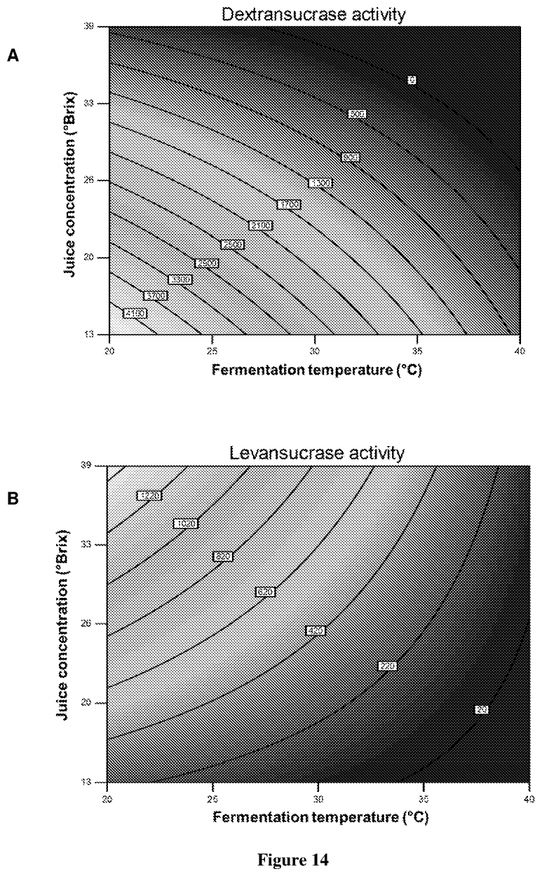

The activity of levansucrase in the juice varied from 69.6 U/L to 1954.1 U/L. The highest activity was observed in 39° Brix samples fermented at pH 7 and 20° C. The synthesis of levansucrase in apple juice was significantly affected by temperature, and temperature-concentration, temperature-pH and concentration-pH interactions. The resulting response surface model described the effects of these variables on levansucrase activity reasonably well (R²=0.716). A contour plot based on the response surface model showing the effects of temperature and concentration on levansucrase activity is presented in FIG. 14a. At pH 6 and 7, the expression of levansucarse increased with a decrease in temperature and increase in concentration. At pH 5, some increase in levansucrase activity is also observed with increase in temperature at low apple juice concentration. Based on the response surface model, the optimum levansucrase activity was predicted to be 1480.3 U/L at pH 7, 20° C. and apple juice concentration of 39° Brix, which is close to the experimental value at the same condition.

The activity of dextransucrase in the fermented apple juice varied from 97.4 to 5887 U/L. The highest dextransucrase activity was observed in 13° Brix sample fermented at pH 7 and 20° C. Interestingly, close to the minimum levansucrase activity and total sugar reduction was observed under that condition. Fermentation temperature and juice concentration as well as pH-concentration, temperature-concentration and temperature-pH interaction had significant effects on dextransucrase activity in the juice (Table 3). The response surface model described the dependence of dextransucrase activity on these experimental variables reasonably well (R²=0.7460). The contour plot showing the simultaneous effects of temperature and concentration on dextransucrase activity at pH 7 is presented in FIG. 14b. Dextransucrase production increased with decrease in temperature and concentration at pH 6 and 7. In contrast to levansucrase, the highest activity of dextransucrase was observed at the lowest apple juice concentration. At pH 5, some increase in dextransucrase activity was also observed with increase in temperature at high juice concentration. Based on the response surface model, the maximum dextransucrase activity was estimated to be 4540.78 U/L at 20° C., pH 7 and 13° Brix juice concentration.

TABLE 3
Analysis of variance and coefficients of the response surface models describing the
effect of temperature, pH and apple juice concentration on total sugar reduction,
fermentation rate, levansucrase and dextransucrase activity after eliminating non-
significant terms and keeping terms required for maintaining model hierarchy.

| | Dextransucrase | | Levansucrase | | Totals sugar | |
|---|---|---|---|---|---|---|
| | activity | | activity | | reduction (%) | |
| | Estimated | | Estimated | | Estimated | |
| Source | coefficient | p-value | coefficient | p-value | coefficient | p-value |
| Model | | 0.0026 | | 0.0051 | | 0.0112 |
| Intercept | −15064 | | −3204.3 | | −37.5 | |
| T- | 163.5 | 0.0205 | 152.4 | 0.0191 | | |
| temperature | 3811 | 0.0544 | 382.6 | 0.0578 | 6.04 | 0.0150 |
| P-pH | 155.7 | 0.0172 | −22.8 | 0.0795 | 0.36 | 0.0486 |
| C- | −59.2 | 0.0437 | −20.6 | 0.0426 | | |
| concentration | −59.05 | 0.0124 | −20.6 | 0.0455 | | |
| PxT | 4.96 | 0.0300 | −1.96 | 0.0157 | | |
| PxC | | | | | | |
| TxC | | | | | | |
| R² | 0.7460 | | 0.7160 | | | 0.4105 |
| R²adj | 0.6288 | | 0.5849 | | | 0.3412 |

No correlation was observed between the activities of the glycosyltransferases and the total sugar reduction. Overall, the total sugar reduction was less than what was observed during experiments in Schott bottles described in Examples 2 to 13. On the other hand, the activities of the glycosyltransferases were relatively higher during fermentation in the bioreactor, although no additional nutrients were added into the juice samples. The effects of strict anaerobic condition with aerobic condition in the bioreactor for the 13° Brix juice at pH 6 and 30° C. was compared. A much higher sugar reduction of 31% was observed under aerobic condition while the sugar reduction under equivalent anaerobic condition was only 1%, indicating that aerobic condition favours sugar reduction. The activity of dextransucrase was higher under aerobic condition than anaerobic condition, 1073 U/L and 784 U/L respectively whereas the activity of levansucrase was within the same range (364 and 342 U/L respectively).

### Example 15—Effects of Post-Fermentation Processing on Sugar Reduction

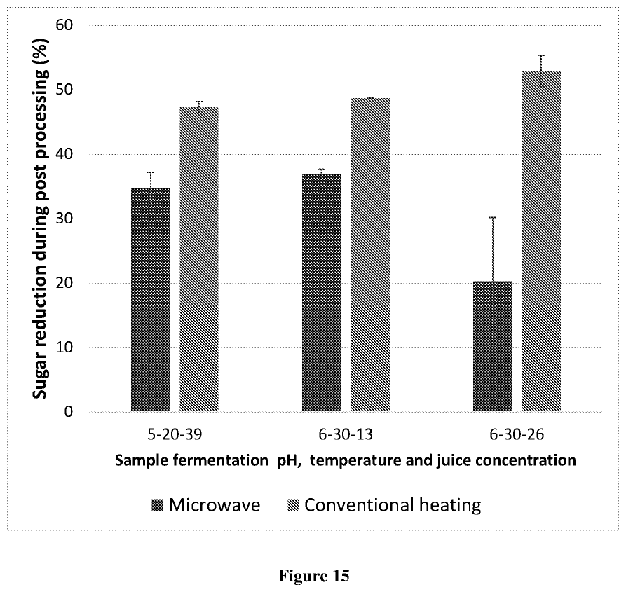

In order to improve the level of sugar reduction by the glycosyltransferase enzymes, four samples were selected for further processing by microwave or conventional heating in a water bath maintained at 50° C. FIG. 15 compares the effects of the two treatments on the level of total sugar reduction in the four samples. Post fermentation microwave processing for 1 min at a specific power input of ˜2 W/gm resulted in further sugar conversion and additional reduction in total sugar between 20% and 37%. The lowest sugar reduction was observed in the 26° Brix juice fermented at pH 6 and 30° C. There was no clear correlation between the level of sugar reduction and the activity of glycosyltransferases. Conventional heating at 50° C. for three hours in a thermostated water bath resulted in a higher level of sugar reduction compared to microwave ranging from 47% to 52%. Nevertheless, the microwave treatment was very efficient as it resulted in comparable sugar reduction within a very short time.

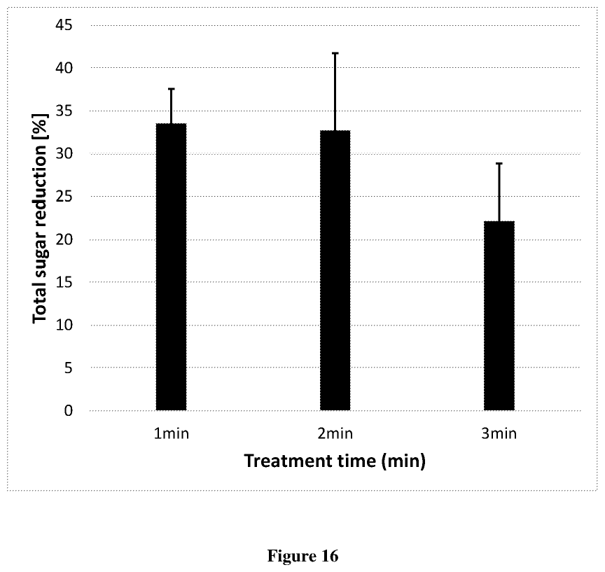

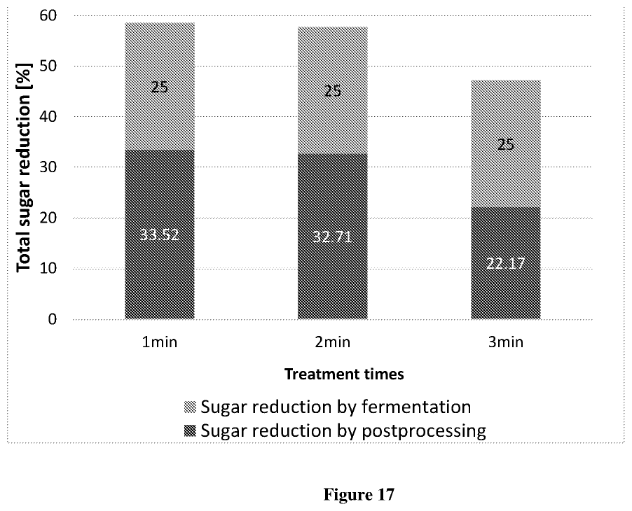

Further microwave post fermentation experiments were conducted on the sample which had the highest level of sugar reduction i.e. the 39° Brix juice sample fermented at pH 6 and 30° C. The microwave treatment was conducted for 1, 2 and 3 min. FIG. 16 shows the effects of treatment time on sugar reduction. As can be seen, at the selected power input condition, treatment for 1 to 2 min results in similar and high level of sugar reduction, whereas longer treatment led to lower sugar reduction perhaps due to microwave induced degradation of the reaction products back to simple sugars. FIG. 17 shows the total sugar reduction including the contribution from fermentation and microwave processing split into two parts. Post-fermentation processing can substantially increase the level of sugar reduction to 60% or higher depending on the level of initial sugar reduction by fermentation.

### Example 16—Effects of Fermentation by Leu. Mesenteroides sp. Isolated from Carrot on the Sugar Profile of Carrot Puree

Carrot was purchased from a local super market. Carrot puree was prepared by blending unpeeled shredded carrot with water at 2 to 1 carrot to water proportion. The puree was sterilised by autoclaving at 121° C. for 5 min to inactivate the endogenous microflora. The sterile puree was fermented using Leu. mesenteroides isolated from Australian grown carrot (C12, C13, C14, C15, C16, C18, C19, C20). The puree was inoculated at 10⁷ CFU/gm and fermented for 12.5 to 39 hrs up to the target pH of 4.4. After the completion of the fermentation process, samples were taken for sugar analysis. In order to extract the simple sugars in the sample, 1 g of the puree was suspended in 1 ml of 80% ethanol solution and the suspension was incubated for 30 min at 80° C. After centrifugation (Eppendorf, Minispin Centrifuge, F-45-12-11) for 15 min (˜9600 g), the supernatant was used for sugar profile analysis using the high performance liquid chromatography (HPLC) method described in Example 1.

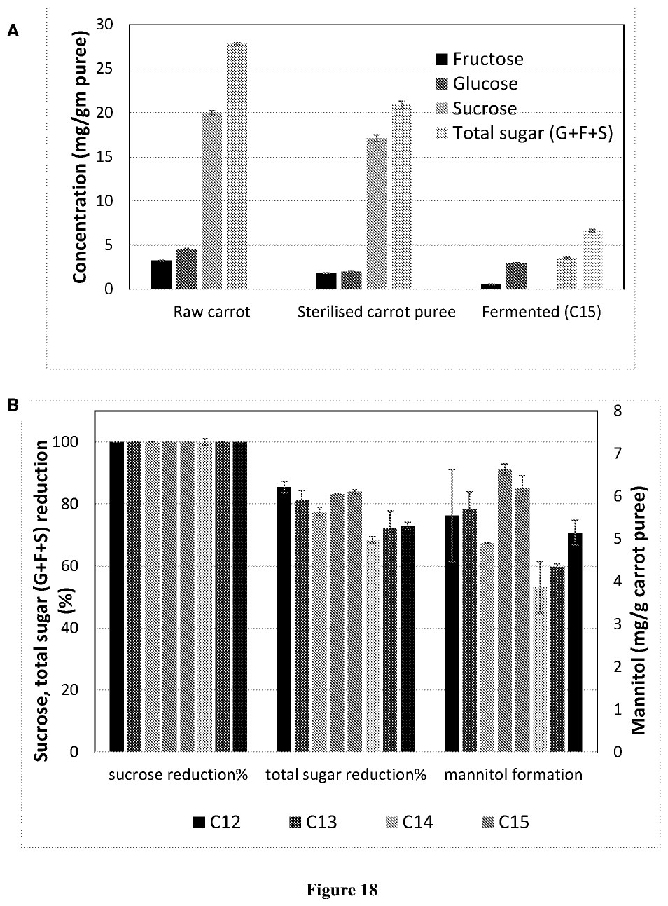

FIG. 18a shows a representative sugar profile of a carrot puree sample prior to sterilisation, after sterilisation and after fermentation. There was significant reduction in the concentration of the reducing sugars (fructose and glucose) during sterilisation most probably due to Maillard reaction. There was also a slight decrease in sucrose content during sterilisation which can be attributed to thermal degradation. Fermentation by all the Leu. mesenteroides isolates resulted in 100% sucrose degradation, the predominant sugar in carrot, and substantial total sugar reduction varying from 68% to 85%. The concentration of fructose decreased in most samples after fermentation except in samples fermented by C18, C19 and C20 where some increase was observed. With respect to glucose concentration, some increase after fermentation was observed in all samples except samples fermented by C12 where a decrease was observed. The highest level of total sugar reduction of ˜83-85% was achieved with C12, C13, C15 and C16 where the highest mannitol production was also observed. The mannitol content varied from 3.8 to 6.6 mg/g carrot puree, which is equivalent to 3.8 to 6.6% on dry basis.

### Example 17—Effect of Fermentation and Post-Processing on Sugar Profile of Cloudy Apple Juice and Juice Concentrate

### Methods

### Juice and Juice Concentrate Processing

Whole apples (cv. Smitten freshly picked from Montague Fresh (Aust) Pty Ltd, Narrawarren) were washed with water, cut into quarters, dipped in 1% ascorbic acid and were steam blanched to a core temperature of 70° C. using a steam oven (Rational Combi-Dampfer CCC, Germany) set to 100° C. A temperature probe was inserted into the core of an apple to monitor the temperature. The objective of the steam blanching was to inactivate the endogenous enzymes pectin methylesterase and polyphenol oxidase responsible for cloud loss and browning respectively. Samples were then cooled in ice-water, blot dried and juiced using Freshpress Cold Press Juicer (Model FP100, Australia). The juices was then strained through filter bags with 1 μm pore size (Sefar, Australia) to remove any insoluble materials, concentrated by Forward Osmosis (FO) membrane processing to 21° Brix using Porifera's FO system (Porifera, Inc., USA) and pasteurised at 100° C. for 15 seconds using Armfield HTST/UHT system and stored at 4° C. until further processing.

### Fermentation

The fermentation experiments were conducted using Leuconostoc mesenteroides ATCC 8923 as starter. The inoculum was prepared as described in Example 1 and the dosage was ˜10⁷ CFU/mL. All fermentation experiments were conducted for 24 hrs using sterile 5 L fermenter (Biostat A, Sartorius, Germany) maintained at 30° C. at 300 rpm stirring rate and an initial pH of 4.0 (the natural pH of the juice) and 6.0. The pH of the samples were adjusted using 6M sodium hydroxide. The temperature, pH and agitation rate were continually monitored. Yeast extract (0.3%) and maltose (2%) were added to the samples during some of the experiments. Samples were periodically taken during fermentation and at the end of the fermentation process for analysis of sugars, the activity of glycosyltransferase enzymes and titratable acidity.

### Post-Processing by High Hydrostatic Pressure (HPP)

A 35 L high pressure vessel (Flow Pressure System QuINTUS® Food Press Type 35 L-600 sterilisation machine, Avure Technologies, Kent, Wash., USA) was used in the HPP processing experiments. Fermented samples in 250 mL flexible water resistant bottles were subjected to high pressure processing at 150, 400 and 600 MPa for 15 min at 40° C. Samples were pre-heated to 35, 28 and 22° C. to achieve the target temperature of 40° C. after compression to 150, 400 and 600 MPa respectively. The sugar profile and the activity of glycosyltransferase enzymes were analysed immediately after processing.

### Post-Processing by Microwave

Five mL fermented samples were placed in glass vials and microwaved in a microwave oven (Sharp, Australia) for 1 min until the desired temperature 50° C.-55° C. at a specific power input of ˜2 W/g. The sugar profile of the samples was analysed after processing.

### Post-Processing by Ultrasound

Ten mL fermented juice samples in glass vials were subjected to ultrasonic processing at 40 kHz at specific power densities of 0.02 and 0.037 kW/L (Blackstone Ney ultrasonics, USA) and 400 kHz at a specific power density of 0.02 kW/L (Sonosys Ultraschall systeme, Germany) for 2 hrs with samples directly placed on the ultrasonic transducers immersed in a temperature controlled re-circulating water bath maintained at ˜40° C. The sugar profile of the samples were analysed following processing.

### Sugar Profile and Enzyme Activity Analysis

The sugar profile analysis and the extraction and assay of levansucrase and dextransucrase were conducted as described in example 1.

### Results

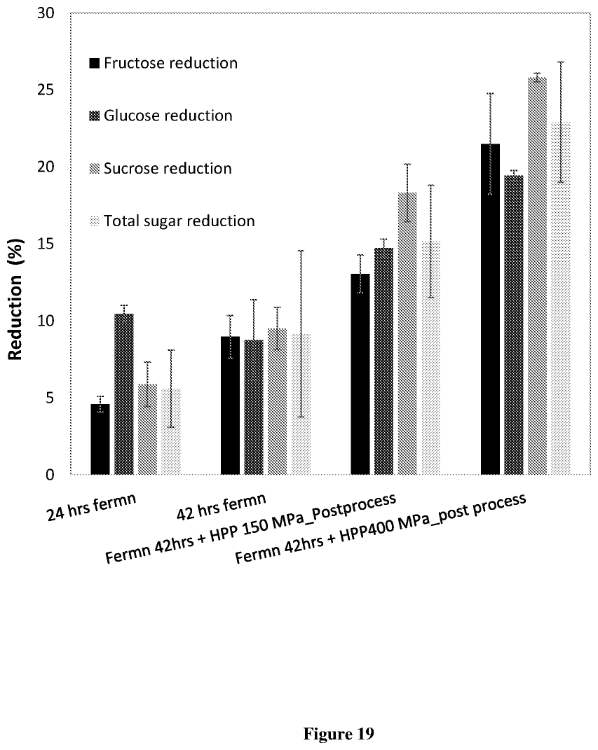

The effect of fermentation (at initial pH ˜4.0, natural pH of the juice) followed by high pressure processing (HPP) for 15 minutes on sugar content of cloudy apple juice concentrate (21° Brix) was assessed and is shown in FIG. 19. Post processing by HPP improved the level of sugar reduction in the apple juice.

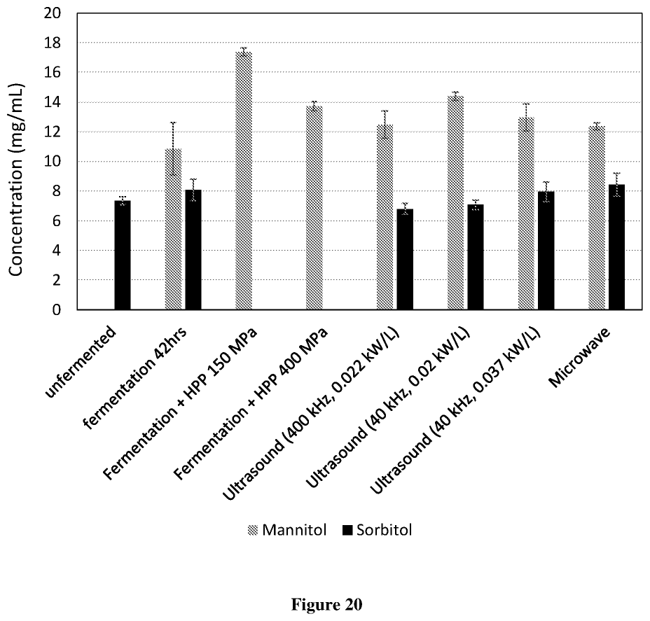

The effect of fermentation (at initial pH 4.0) and post-processing by high pressure processing (HPP), ultrasound processing and microwave processing on the concentration of sugar alcohols in cloudy apple juice concentrate (21° Brix) was assessed and is shown in FIG. 20. Post-processing by HPP, ultrasound and microwave significantly increased mannitol formation. HPP resulted in complete degradation of sorbitol, a high glycaemic index sugar alcohol naturally present in apple juice.

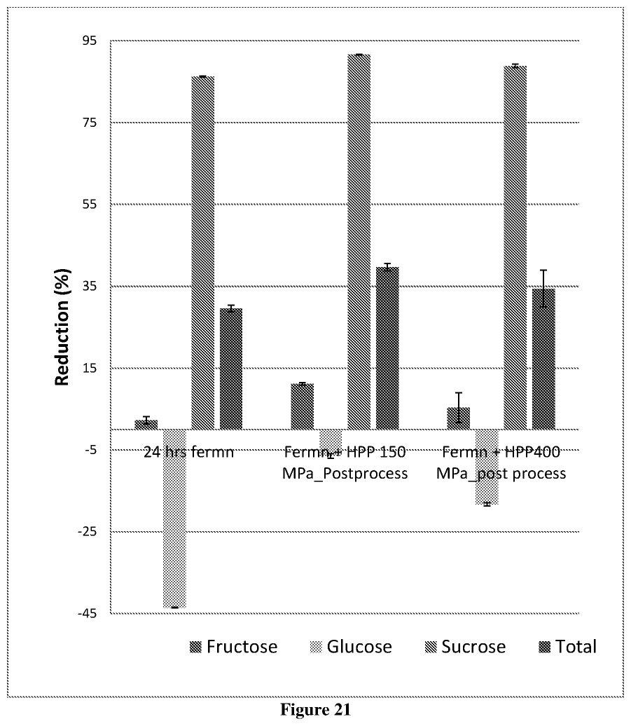

The effect of fermentation (initial pH adjusted to ˜6.0) followed by high pressure processing (HPP) on sugar content of cloudy apple juice concentrate (21° Brix) was assessed and is shown in FIG. 21. Post-processing by HPP enhanced the degree of sugar reduction with 150 MPa increasing the level of sugar reduction to 39.6% compared to 29.6% after fermentation treatment only.

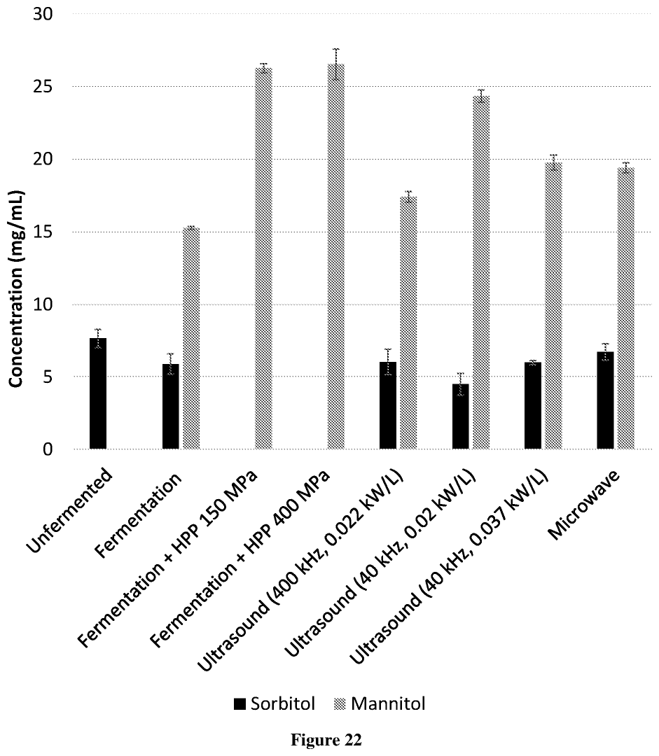

The effect of fermentation (initial pH adjusted to 6.0) and post-processing by high pressure processing (HPP), ultrasound processing and microwave processing on the concentration of sugar alcohols in cloudy apple juice concentrate (21° Brix) was assessed and is shown in FIG. 22. Post-processing by HPP, ultrasound and microwave significantly increased mannitol formation. HPP resulted in complete degradation of sorbitol, a high glycaemic index sugar alcohol naturally present in apple juice. A small amount of isomaltotriose was observed in microwaved and sonicated samples.

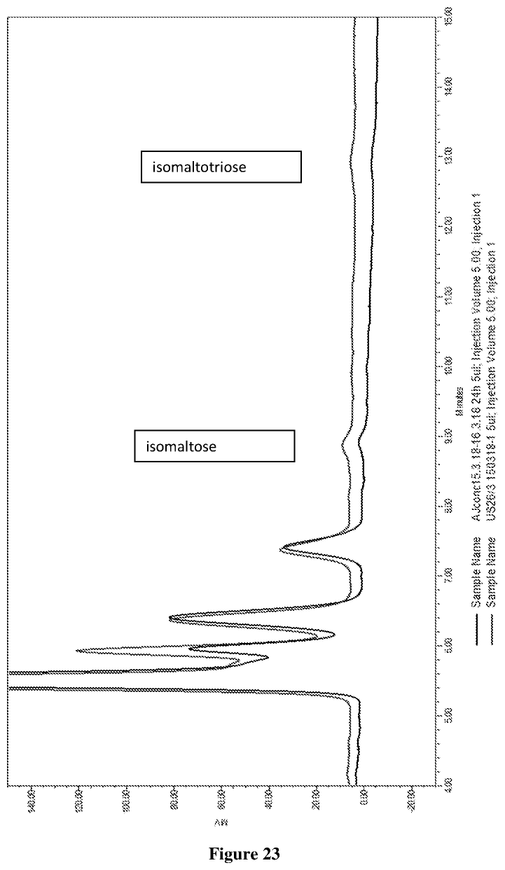

The HPLC profile of cloudy apple juice concentrate fermented at initial pH adjusted to ˜6.0 and post-processed by ultrasound (40 kHz, 0.02 kW/L) was assessed and is shown in FIG. 23. The bottom line shows a fermented sample. The top line shows a fermented sample post-processed by ultrasound. A higher amount of isomaltose and isomaltotriose was present in the ultrasonicated samples.

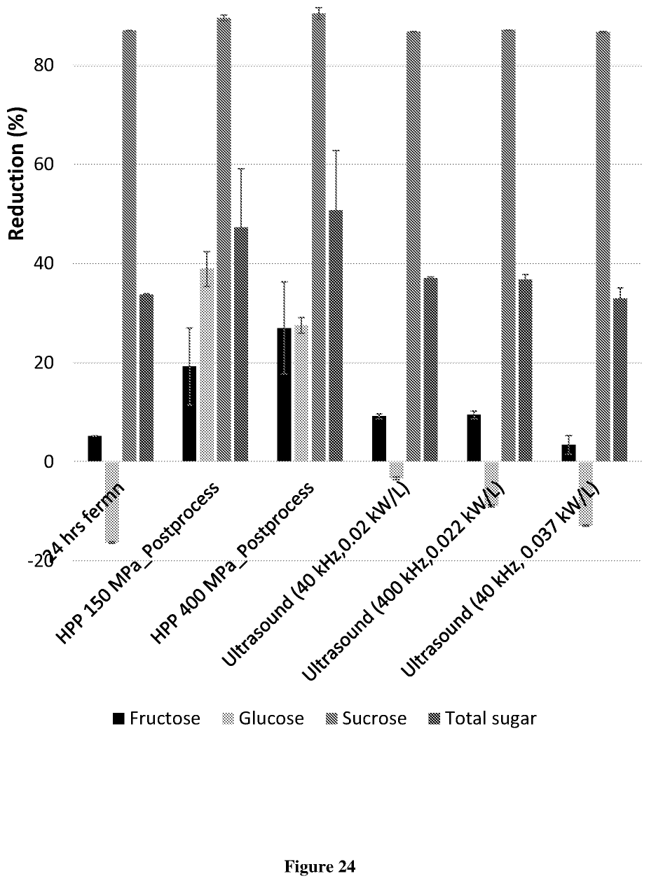

The effect of fermentation (initial pH adjusted to ˜6.0) followed by high pressure processing (HPP) on the sugar content of cloudy apple juice concentrate (21° Brix) with 0.3% yeast extract was assessed and is shown in FIG. 24. Post-processing by HPP increased the level of sugar reduction from ˜34% to 50%. Ultrasound treatment for 2 hours at 40 kHz, 0.02 kW/L and 400 kHz, 0.022 kW/L also slightly increased sugar reduction.

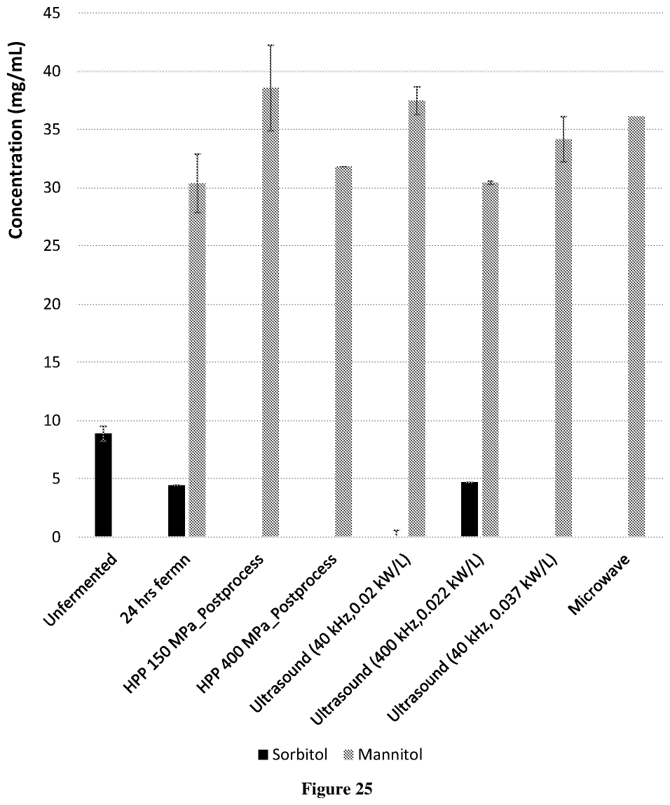

The effect of fermentation (initial pH adjusted to 6.0) and post-processing by high pressure processing (HPP), ultrasound processing and microwave processing on the concentration of sugar alcohols in cloudy apple juice concentrate (21° Brix) with 0.3% yeast extract was assessed and is shown in FIG. 25. HPP 150 MPa, ultrasound (40 kHz, 0.02 kW/L), ultrasound (40 kHz, 0.037 kW/L) and microwave improved mannitol production. Significant degradation of sorbitol was observed during fermentation and post processing. Polysaccharides and a small amount of isomaltose were observed in all samples except HPP post treated samples. A small amount of isomaltotriose was observed in ultrasound and microwave treated samples.

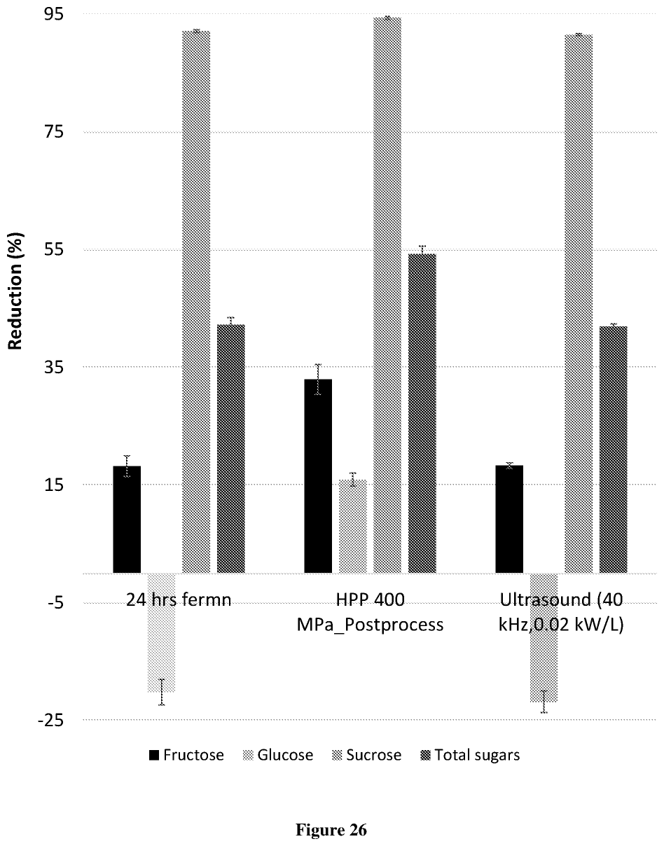

The effect of fermentation (initial pH adjusted to ˜6.0) followed by high pressure processing (HPP) on the sugar content of cloudy apple juice (10° Brix) with 0.3% yeast extract was assessed and is shown in FIG. 26. HPP at 400 MPa significantly improved total sugar reduction from 42% to 54%. It also improved the reduction of glucose and fructose.

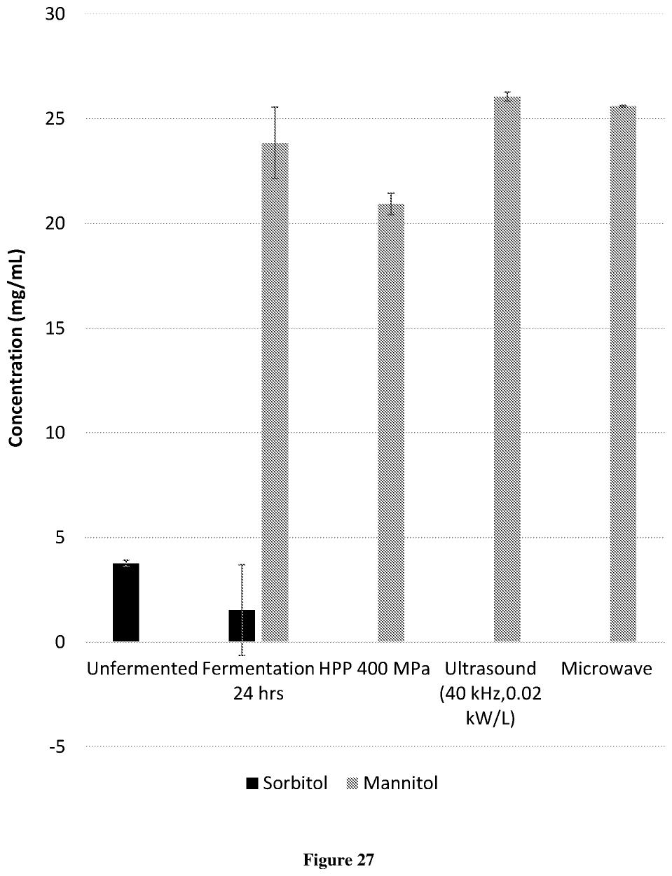

The effect of fermentation (initial pH adjusted to ˜6.0) and post-processing by HPP, ultrasound and microwave on the concentration of sugar alcohols in cloudy apple juice (10° Brix) with 0.3% yeast extract was assessed and is shown in FIG. 27. Post-processing by ultrasound slightly improved mannitol production while other processing techniques did not.

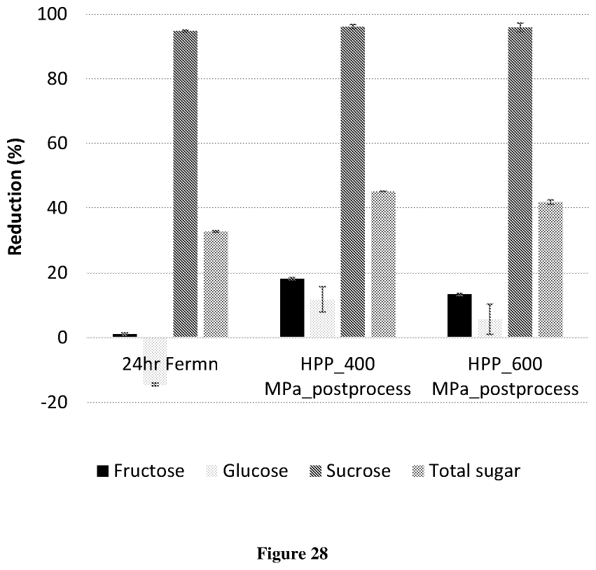

The effect of fermentation (initial pH adjusted to ˜6.0) followed by high pressure processing (HPP) on sugar content of cloudy apple juice concentrate (21° Brix) with 0.3% yeast extract and 2% maltose was assessed and is shown in FIG. 28. Post processing by HPP at 400 MPa increased sugar reduction from 32.8% to 45.2%.

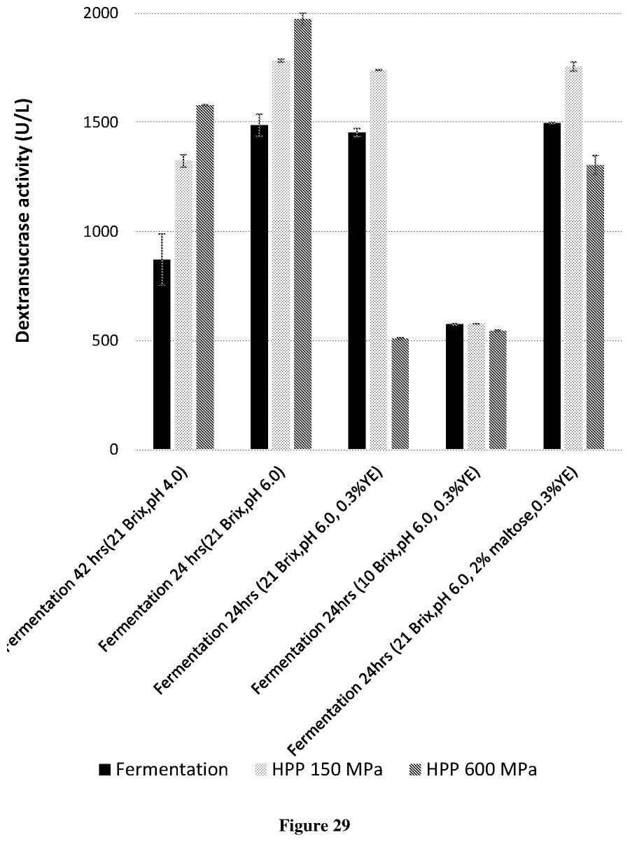

The effects of high pressure processing on the activity of dextransucrase in fermented apple juice samples was assessed and is shown in FIG. 29. The application of HPP at 150 MPa significantly increased the activity dextransucrase in all samples except the straight apple juice (10 Brix). Significant increase in the activity of the enzyme was also observed after HPP treatment at 600 MPa in samples fermented at the natural pH and without the addition of yeast extract at pH 6.0).

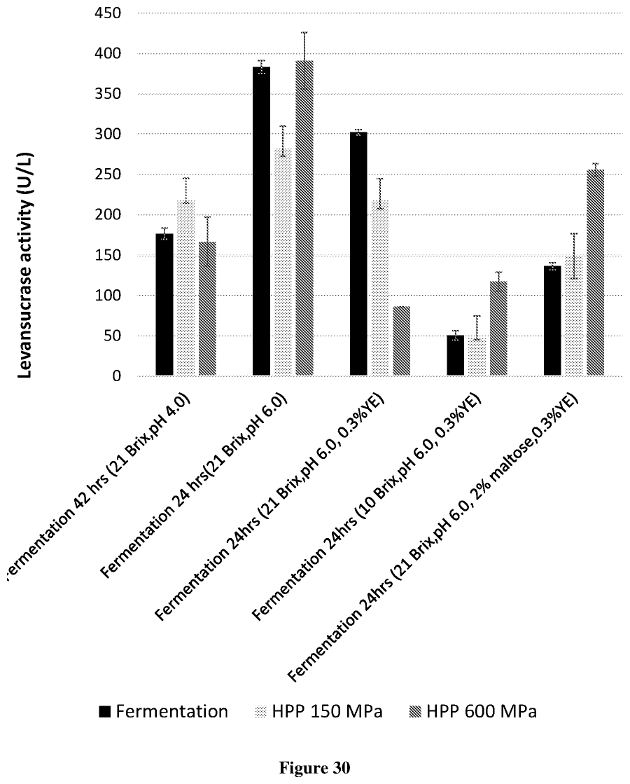

The effect of high pressure processing on the activity of levansucrase in fermented apple juice samples was assessed and is shown in FIG. 30. HPP at 150 MPa resulted in decreased activity of levansucrase in all samples except sample fermented at pH 4.0. HPP at 600 MPa on the other hand resulted in substantially increased activity in the 10 Brix juice and the juice fermented with added maltose.

### Example 18—Fermentation for Conversion of Sugars into Prebiotic Polysaccharides in Carrot Juice

### Methods

### Materials

Fresh carrots were purchased from local suppliers. All the chemical and biochemical reagents were purchased from Merck (Kilsyth, VIC, Australia) or Sigma-Aldrich (Castle Hill, NSW, Australia) and were of analytical or HPLC grade. Lactobacillus gasseri DSM 20604 and Lactobacillus gasseri DSM 20077 were obtained from DSMZ (Germany). The Schott bottles and 5 L bioreactor (BIOSTAT® A, Sartorius, Australia) used for the experiments were autoclaved and cooled to room temperature prior to use.

L. gasseri Cultures Preparation

Lactobacillus gasseri DSM 20604 and Lactobacillus gasseri DSM 20077 pellet were inoculated into 10 mL MRS broth and serially diluted to 10⁵ times, and incubated for 48 h at 37° C. under anaerobic condition. 10 μL of diluted culture were taken out and then inoculated in 30 mL De Man, Rogosa and Sharpe (MRS) broths. The broths were grown for 18 h at 37° C. under anaerobic condition.

The cultures were centrifuged at 5000 g for 10 minutes at 17° C. using centrifuge (Sigma 6-16K, Australia), and were resuspended in 3 mL of MRS to yield a concentration of ˜10⁹ CFU/mL. All of the culture tubes were combined to make one stock solution and 15% glycerol was added to the total volume. The combined cultures were dispensed into 1 mL aliquots and kept frozen at −70° C.

A total count was performed on the concentrated culture containing glycerol. Dilutions were performed using Maximum Recovery Diluent (MRD) as a medium and were plated onto MRS agar, incubated at 37° C. for 48 h, with an Anaerogen sachet to generate microaerophilic conditions.

On the day of fermentation, the 1 mL culture tubes were removed from the freezer and defrosted in water maintained at 35° C. for 5 minutes and the cultures were washed prior to use as follows. The tubes were centrifuged for 5 mins at 13400 rpm.

The supernatant was discarded, 1 mL of sterile phosphate buffered saline (PBS) buffer was added to the Eppendorf tube and the cell pellet was resuspended in the buffer. The culture was then centrifuged as above. The supernatant was discarded and the culture was washed for a second time with PBS buffer. The PBS buffer was discarded after centrifuging, leaving the cell pellet. Then 1 mL of sterile deionised water was added to the cell pellet to maintain a concentration of approximately 10⁹ CFU/mL. Then they were ready for use. Each 1 mL culture tube was used for fermenting 200 mL of juice.

### Carrot Juice and Juice Concentrate Production

Fresh carrots were washed, and the two ends of carrot were chopped. Then carrots were steamed at 100° C. using a steam oven (Rational Combi-Dampfer CCC, Germany) until the internal temperature was 80° C. The heat treated carrots were cooled down in ice water and blot dried and juiced. The juicing process included shredding the carrots using a Ø 1 cm shredder and compression using cold press juicer (Fresh Press, Model FP100, Australia). The juice was filtered with 1 mm pore size filter bag to remove insoluble materials. The carrot juice was concentrated by Forward Osmosis membrane processing until the soluble solid content was around 15° Brix, a concentration factor of ˜2. The juice was then pasteurization at 100° C. for 15 seconds before using a heat exchanger. The concentrated juice was used in all the experiments as is or after 1:1 dilution with sterilised Milli-Q water to obtain the concentration of straight juice.

### Juice Fermentation

The initial pH of the juice was adjusted to 5.5, the optimal pH for the growth of the two L. gasseri strains. The experiments were conducted using different inoculum concentrations in 200 mL of juice samples in sterile Schott bottles (250 mL). The fermentation was conducted for 24 hours in a shaking water bath maintained at 100 rpm and 37° C.

### Small Batch Carrot Juice Fermentation Experiments

L. gasseri DSM 20077 and DSM 20604 cultures prepared as described above were inoculated into 200 ml straight or concentrated carrot juice in sterile Schott bottles (250 ml). The initial pH of the juice wasn't adjusted as the natural pH of carrot juice (˜6.0) was found to be suitable for the growth of the two strains. The concentration of Lactobacillus gasseri cultures was 10⁷ CFU/mL. The fermentation was carried out for 24 h in a shaking water bath maintained at 100 rpm and different temperatures. The detailed experimental conditions are presented in Table 4. All experiments were conducted in triplicate.

TABLE 4
Experimental conditions for the carrot juice
fermentation experiments in Schott bottles.

| | | Fermentative |
|---|---|---|
| Type of juice | Type of strains | temperature (° C.) |
| Straight carrot | L. gasseri DSM 20604 | 30 |
| juice | | 37 |
| | | 45 |
| Straight carrot | L. gasseri DSM 20077 | 30 |
| juice | | 37 |
| | | 45 |
| Concentrate carrot | L. gasseri DSM 20604 | 30 |
| juice | | 37 |
| | | 45 |
| | L. gasseri DSM 20077 | 30 |
| | | 37 |
| | | 45 |

### Larger Scale Carrot Juice Fermentation Experiments in Bioreactor

Fermentation of straight and concentrated carrot juice samples (1.2 L) were conducted using Lactobacillus gasseri DSM 20604 or Lactobacillus gasseri DSM 20077 as starters at ˜10⁷ CFU/mL. The initial pH of carrot juice was not adjusted. Based on the results of the small batch experiments, the fermentation temperature was selected to be 30° C. and the stirring rate was 300 rpm. The experiments were conducted under transient aerobic (with no active supply of air) and anaerobic (using nitrogen to remove the headspace oxygen) conditions (Table 5) in Biostat A 5 L fermenter (Sartorius, Germany).

TABLE 5
Experimental conditions for the carrot
juice fermentation in bioreactor.

| Type of juice | Type of strains | Presence of oxygen |
|---|---|---|
| Straight carrot | L. gasseri DSM 20604 | Bioreactor |
| juice | L. gasseri DSM 20077 | Anaerobic (in Bioreactor) |
| | L. gasseri DSM 20604 | Bioreactor |
| | L. gasseri DSM 20077 | Anaerobic (in Bioreactor) |

### Post-Processing of Fermented Juice Using Microwave

5 mL fermented samples were processed in a microwave (Carousel model, Sharp) for 30 seconds and 60 seconds. The temperature before and after treatment were measured. Immediately after the treatment, samples were cooled down in ice water. All experiments were conducted in duplicate. The power input was determined based on the temperature change and in accordance with the following equation.

$$P = \frac{{c}_{w} \times {m}_{x} \times Δ T}{t}$$

With CW is the specific heat of water, mx as the mass of the treated sample, ΔT as the temperature difference in Kelvin and t as the treatment period in seconds. The specific power input was ˜1 to 2 W/g during treatment by microwave for 30 s and 60 s respectively.

### Lactic Acid Bacteria Count

All fermented samples were diluted using MRD and plated on MRS agar, then incubated at 37° C. for 48 h, using an Anaerogen sachet to generate microaerophilic conditions.

### Titratable Acidity

Was assessed as described in Example 1.

### Crude Enzyme Extraction

20 mL of the fermented sample was centrifuged at 5500 rpm for 15 min at 16° C. to remove the cells. Then 9.44 g ammonium sulphate was added to the fermented sample till 70% saturation and stirred for one hour at 4° C. Then it was centrifuged at 11000 g for 15 minutes at 4° C. The residue was re-dissolved in 1 mL of 20 mM sodium acetate buffers and was used as crude enzyme extract for assaying total hydrolytic activity using sucrose and raffinose (a substrate specific to fructansucrases) as substrates.

Assay of Hydrolytic Activities with Sucrose

The hydrolytic activity with sucrose as substrate was assayed as described in example 1 for the assay of dextransucrase. One unit of activity was defined as μmol glucose released per min under the assay condition.

Hydrolytic Activity Assay with Raffinose as Substrate

The hydrolytic activity assay with raffinose as substrate was conducted as described for levansucrase activity in Example 1. One unit of activity was defined as μmol glucose released per min under the assay condition.

### Sugar Analysis by High-Performance Liquid Chromatography

Prior to analysis of simple sugars and oligosaccharides in the juices by high-performance liquid chromatography (HPLC), polysaccharides were precipitated by adding three volumes of 80% (v/v) ethanol. After mixing, samples were centrifuged at 15000 g for 10 mins at 22° C. The supernatant was filtered through 0.2 μm membrane before injection to HPLC for sugar analysis. A Shodex Asahipak NH2P-50 4E (4.6×250 mm) (Showa Denko K.K., Japan) column was used for the HPLC analysis as described in example 1.

For polysaccharide analysis by HPLC, the precipitates from above were dissolved in water and deproteinization of the samples was performed by adding 3 drops of 20% (w/v) sulfosalicylic acid in to 5 mL of the samples. After mixing, samples were centrifuged at 5000 g for 10 mins and filtered through a 0.45 μm filter to remove the proteins. The supernatant was analysed by HPLC using Shodex SUGAR Series KS-804 (300×8 mm, Showa Denko K.K., Japan).

### Sample Preparation for Fourier-Transform Infrared Spectroscopy (FTIR) and Confocal Raman Spectroscopy Analysis

The fermented and unfermented Juice samples were de-proteinized by the CaCl₂ method Huang et al (2011). The solution was adjusted to pH 8-9 with 2% NaOH solution, and heated to 85° C. The CaCl² solid was added up to a concentration of 5% (w/v), mixed and boiled for 30 min. After that, the mixture was cooled to room temperature and centrifuged at 5000 rpm for 15 minutes at 22° C.

The polysaccharides in the samples were precipitated with absolute ethanol. The volume of ethanol was four times that of the de-proteinized juice. After that, the sample was centrifuged at a speed of 4500 rpm at 4° C. for 10 mins to obtain the precipitated polysaccharide. The precipitate was washed for a second time with absolute ethanol and then dried with SpeedVac concentrator (Savant™ SC250EXP, Thermo Fisher) at room temperature under 0.5 torr vacuum pressure.

### Raman Spectroscopy Measurements

A Renishaw InVia Raman spectrometer, equipped with a Leica microscope plus a deep depletion charge-coupled device detector, 1200 lines per mm grating, a holographic notch filter with slit size of 65 μm was used in the Raman spectroscopy analysis. The incident laser power was adjusted to ˜25 mW (10%) of 785 nm radiation from diode laser with an estimated spatial resolution in the order of 0.8 μm was used for acquiring the spectra from each sample. The system was calibrated and monitored using a silicon reference (520.5 cm⁻¹) before the measurements. For each measurement, the sample was brought into focus using a 20× microscope objective (NA=0.4 in air). The accumulation time for each acquisition was 10 s and single accumulation was collected for a single measurement over the confocal region containing the selected area. All total 54 Raman spectra (3 individual measurement areas×18 different fermented carrot juice samples including reference strains and standards) were collected.

Maltodextrin, dextran, inulin and pectin powder, and 10 mg/mL levan solution were used as polysaccharide references. Commercially available software (Matlab and OriginLab) were used for all data pre-processing including background subtraction and second-order derivative calculation (Savitzky−Golay filter with points=7, polynomial degree=2).

### FTIR Spectroscopy Measurements

FTIR spectra were collected with the use of FTIR spectrometer with the Smart ITR ATR sampling accessory. Each sample was applied on ATR as powder. The spectra were collected over the range 4000-500 cm⁻¹. For each material, three samples under the same conditions were examined, for each sample, 80 scans were averaged with a spectral resolution of 4 cm⁻¹. Then a final average spectrum was calculated.

### Raman and FTIR Data Acquisition and Processing

Commercially available software (R language, Matlab and OriginPro) were used for all data processing. Spectra were collected in the 4000 to 500 cm-1 range that covers the fingerprint region of most biological materials. The WiRE 4.1 Raman software integrated in the Renishaw inVia Raman spectroscopy system was applied for cosmic ray removal using the ‘width of feature’ method and fluorescence background removal. The Savitzky-Golay filter (span=7, polynomial degree=2, curve fitting toolbox in MATLAB) was used to reduce the noise of the spectra.

In order to perform multivariate analysis, the intensities of the spectra were normalised using total intensity normalisation of the spectra to account for sample-to-sample variations. The background-subtracted and normalized Raman spectra were then mean-centred to reposition the centroid of the data at the origin. To analyse the Raman spectra obtained from different fermented samples, the multivariate statistical methods of principal component analysis (PCA) were applied. The mean-centred data were analysed by calculating the principal components (PCs), creating scores plots for the first and second PCs and the corresponding loading plots that relate the scores to specific regions in the original Raman data.

For specific peak intensity analysis, the normalised intensity values of the specific peaks selected from the loading plot of PCA were averaged by adding the maximum intensity and the intensity values of the two neighbouring wavenumbers. Statistical mean comparison of the mean FTIR intensity for each peak assignment between sample groups were performed using Tukey one-way analysis of variance (ANOVA).

The difference between mean comparisons of groups was considered to be significant when p-value was less than 0.05.

### Results

Effect of Nitrogen Source on the Growth Rate of L. gasseri

The effect of added nitrogen sources on the extent of growth rate of L. gasseri was investigated using straight carrot juice as substrate, yeast extract as nitrogen source and L. gasseri DSM 20604 and L. gasseri DSM 20077 as starters. Experiments were conducted in the small batch experiments in Schott bottles.

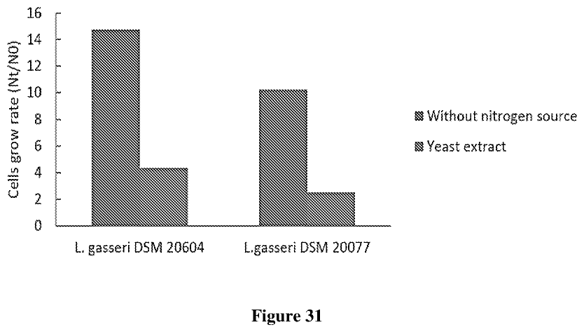

Nitrogen source is a very important factor for the growth of bacteria. In this case, without nitrogen source, the cells grew 14.7 and 10 times for L. gasseri DSM 20604 and L. gasseri DSM 20077 compared to 4 and 2 times respectively with added yeast extract (FIG. 31). It seems that some components of the yeast extract that was used as additional nitrogen source inhibit the growth of the two L. gasseri strains. Further carrot experiments were conducted without additional nitrogen source.

### Effect of Initial Fermentation Temperature on the Extent of Sugar Conversion During Carrot Juice Fermentation

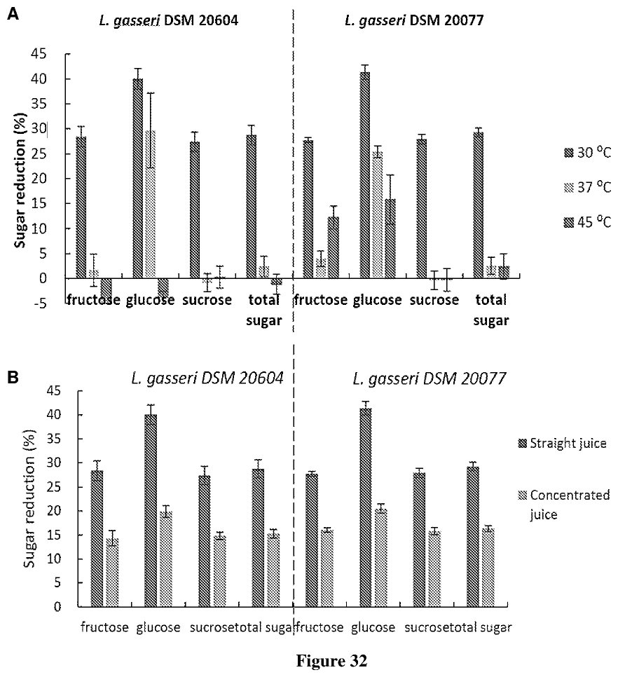

In order to understand the effect of fermentation temperature on the extent of sugar conversion in carrot juice, straight carrot juice was fermented by Lactobacillus gasseri DSM 20604 and Lactobacillus gasseri DSM 20077 at different temperatures. Samples before and after 24-hours incubation were collected, and the sugar concentrations were analysed. The results are presented in FIG. 32A.

For both strains, the highest reduction in total sugars (around 29%) was observed in the fermentation trial at 30° C., and almost no sugar reductions was observed at 37° C. and 45° C. Further, even though there was limited total sugar reduction at 37° C. and no sucrose reduction, the glucose reductions was more than 25%, indicating that L. gasseri still grew in carrot juice and converted glucose to lactic acid during fermentation at 37° C. However, the glycosyltransferase activities maybe very low at these temperatures, resulting in no sucrose reduction and very low total sugar reduction. There was no significant difference between the two strains at 30° C. and 37° C. in sugar reduction, when incubating at 45° C., L. gasseri DSM 20077 performed slightly better.

### Effect of Carrot Juice Concentration on the Extent of Sugar Conversion

To study the effect of carrot juice concentration on the extent of sugar conversion during fermentation, the fermentation of straight carrot juice (8.5% Brix) and concentrated carrot juice (15% Brix) were compared with Lactobacillus gasseri DSM 20604 and Lactobacillus gasseri DSM 20077 as starters. The fermentation temperature was 30° C. Samples before and after 24-hour fermentations were collected, and the concentrations of reducing sugar and oligosaccharides were evaluated. The results are presented in FIG. 32B.

In all cases, after 24-hour fermentation, there was a significant sugar reduction in the carrot juice. The concentrations of the entire high calorie, high GI sugars, including fructose, glucose, sucrose, showed a clear decrease. Straight carrot juices showed better total sugar reduction (27%) compared to 15% in the concentrated carrot juice. There were no significant differences between the two cultures in sugar reduction. Maltose and other oligosaccharides were present in the carrot juice before fermentation. After fermentation, the intensity of the oligosaccharide peaks slightly increased but it was difficult to quantify. On the other hand, significant amount of polysaccharides were formed after fermentation, indicating that small sugars were converted to oligosaccharides and polysaccharides. From health and calorie reduction perspective, straight carrot juice was better as a fermentation substrate and was used for larger scale fermentation experiments.

### Effect of Carrot Juice Concentration on the Activity of Fructosyl Transferase Enzymes

During carrot fermentation by L. gasseri strains, fructosyltransferase enzymes were synthesised. The activities of these enzymes were measured as μmole of glucose release per minute as hydrolytic activities with sucrose and raffinose as substrates. Data are presented in Table 6.

TABLE 6
Hydrolytic activities of fructosyltransferase in carrot samples
fermented for 24 hours at 30° C. in the small batch experiments.

| | Sucrose hydrolytic | Raffinose hydrolytic |
|---|---|---|
| Fermentation condition | activities (U/L) | activity (U/L) |
| Fermented straight juice | 35 ± 12.5 | 20 ± 2.5 |
| by 20604 | | |
| Fermented straight juice | 32.5 ± 5 | 12.5 ± 10 |
| by 20077 | | |
| Fermented concentrated juice | 17.5 ± 15 | 35 ± 25 |
| by 20604 | | |
| Fermented concentrated juice | 0.09 ± 0.02 | 0.09 |
| by 20077 | | |

In all cases, significant hydrolytic activities were observed with sucrose and raffinose as substrates, which is an evidence of fructosyltransferase activity. There were also formation of polysaccharides under the assay condition further confirming the production of fructosyltransferases during fermentation of carrot juice by these strains. Due to the high sample to sample variation, there was no significant difference in the hydrolytic activity with raffinose as substrate for the different samples. However, the sucrose hydrolytic activities were slightly higher in straight carrot juice.

### Effect of Anaerobic Condition on the Extent of Sugar Conversion During Carrot Juice Fermentation

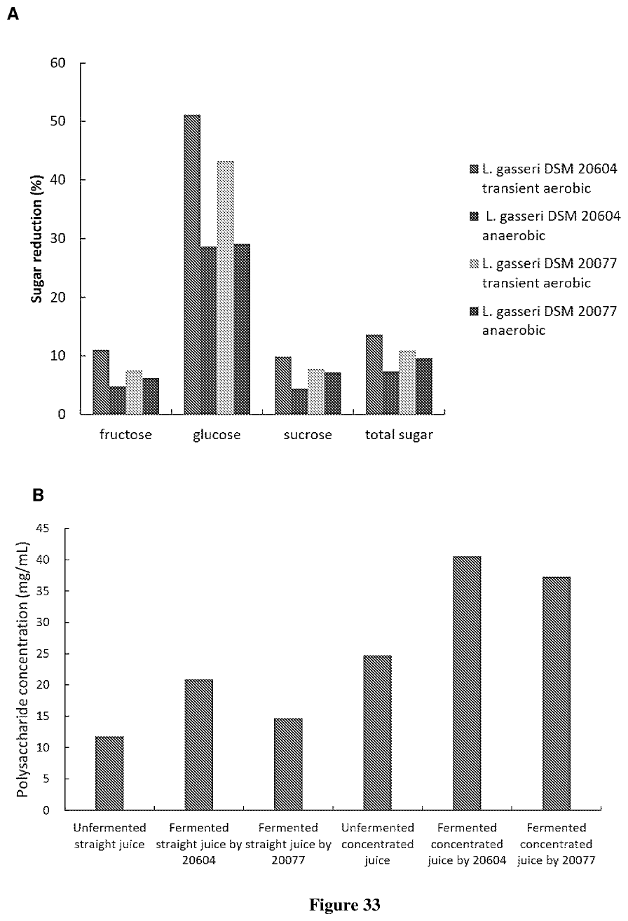

The effect of the anaerobic condition on the extent of sugar conversion during fermentation of straight carrot juice was investigated in a 5 L bioreactor. The pH of carrot juice was not adjusted and the fermentation temperature was 30° C. Samples before and after 24-hour fermentations were collected, and the sugar reduction was evaluated. The results are presented in FIG. 33A.

The reduction of all simple sugars after fermentation were higher under transient aerobic condition for both strains. Interestingly, the increase in microbial biomass for the two strains were higher under anaerobic condition. For instance, in the case of DSM 20604 cells, growth was 13 times under aerobic condition compared to 28 times under anaerobic condition. As such, a higher activity of enzymes would be expected at anaerobic condition, with more sugar reduction. However, in this case higher cells growth was accompanied by lower sugar reduction. The final pH under transient aerobic condition was around 5.4 while the final pH under anaerobic condition was around 4.9, which may have affected the activity of the enzymes. There was no significant difference between the two strains on total sugar reduction. Overall, total sugar reduction was much lower than what was observed in the small batch experiments in Schott bottles (compare FIG. 32A with FIG. 32B). The reason could be less cells were added to the carrot juice in bioreactor fermentation. The initial cell number in bioreactor fermentation were around 8×10⁶ CFU/mL, while in small batch experiments the initial cell number was around 2×10⁷ CFU/mL.

### Identification of Polysaccharide Composition in Fermented Carrot Juice Samples

The polysaccharides formed during fermentation of straight and concentrated carrot juice by L. gasseri DSM 20604 and L. gasseri DSM 20077 at 30° C. for 24 hours were extracted, dried and weighted. The results are presented in FIG. 33B.

After fermentation, there was a significant polysaccharide formation at all conditions. The polysaccharides extracted from 20604 fermented juices and 20077 fermented juices were around 1.7 times and 1.4 times more than unfermented juice, respectively. Both strains can produce levansucrase, which hydrolyse sucrose to fructose and glucose and polymerise fructose to levan. More polysaccharide were formed after fermentation by L. gasseri DSM 20604. The reason could be L. gasseri DSM 20604 can produce inulosucrase in addition to levansucrase, which synthesize inulin polymer.

The result indicates that the reduction in simple sugars after fermentation is at least partially due to polymerization into prebiotic polysaccharides. Before fermentation, there were 89 mg/mL total sugars and 11.8 mg/mL polysaccharides in straight carrot juice, and 136 mg/mL total sugars and 24.7 mg/mL polysaccharides in concentrated juice. After straight juice fermentation by L. gasseri DSM 20604 and DSM 20077, the total sugars reduction was 26.2 and 25.5 mg/mL, and polysaccharide formation was 9.1 and 2.9 mg/mL, which means that 34.9% of reduced sugar was converted to polysaccharides by L. gasseri DSM 20604 fermentation and 11.5% of reduced sugar were converted to polysaccharides by L. gasseri DSM 20077 fermentation. After concentrated juice fermentation, 73.7% of reduced sugar was converted to polysaccharides during fermentation by L. gasseri DSM 20604 and 57.4% of reduced sugar was converted to polysaccharides during fermentation by L. gasseri DSM 20077.

The molecular weight distribution and the structure of polysaccharide were further investigated by Raman spectroscopy, FTIR spectroscopy and size exclusion chromatography (HPLC-SEC).

### SEC-HPLC Analysis for all Sugars

Fermented juices after deproteinization by sulfosalicylic acid were analysed by size exclusion chromatography (SEC) analysis.

With the SEC column employed, higher molecular weight polysaccharides elute first and small ones elutes after a longer retention time. Based on the sugar standard, the two prominent peaks around retention times of 11.5 mins and 11 mins were monosaccharide and disaccharide. Oligosaccharide elutes from retention time 11 mins to 9 mins. The first ones to elute were the polysaccharides. In all conditions, after fermentation, the intensity of polysaccharide peaks increased, which indicates more polysaccharide formation.

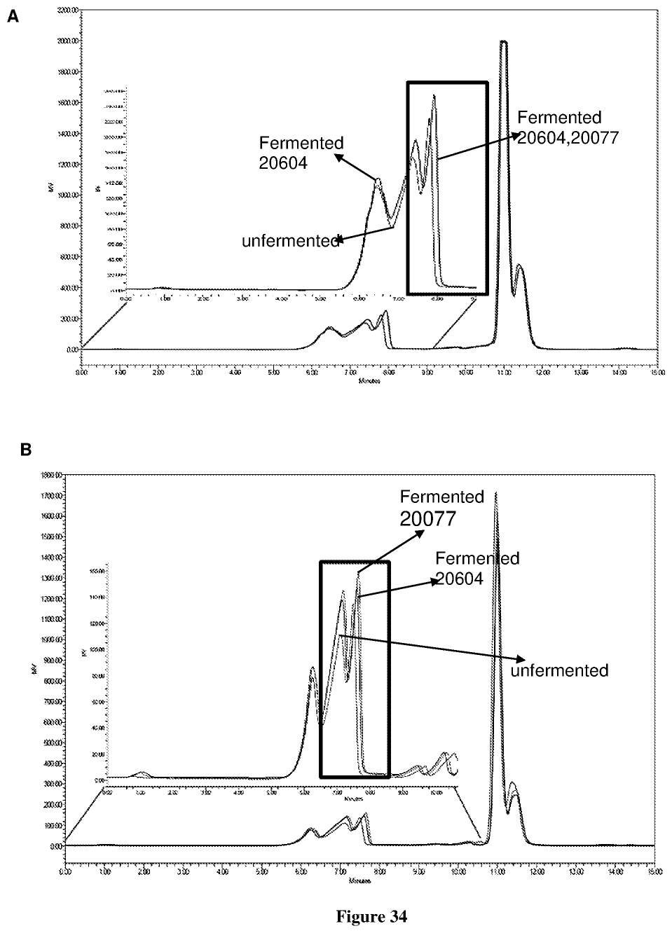

After fermentation, the polysaccharide peak became broader and slightly shifted to longer retention time (seerectangle section in FIGS. 34A and 34B), which suggests an increase in small size polysaccharide formation. There was no very large size polysaccharide, which eluted at 1 mins in unfermented straight juice but after fermentation such polysaccharide were formed. This polysaccharide formation was not observed in concentrated carrot juice. In all fermented juices, the intensity of oligosaccharide peaks did not change significantly, however the peaks shifted to the left, indicating the formation of higher molecular weight oligosaccharides after fermentation. The intensity of mono and di-saccharides decreased, also indicating that small sugars were polymerized after fermentation.

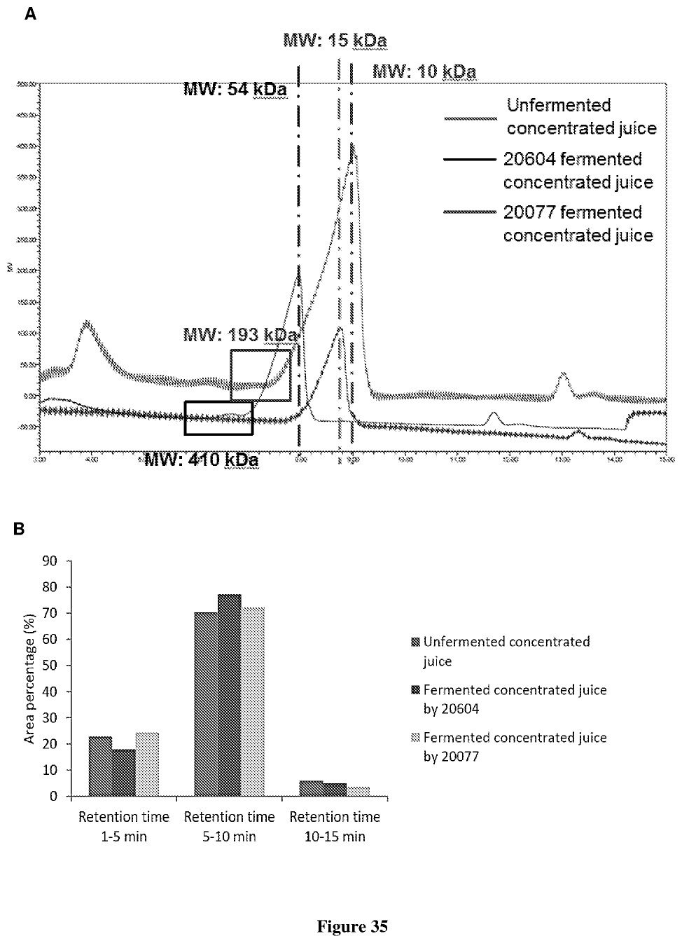

However, due to the high intensity of small sugars, the polysaccharide profile was not clearly observed. Therefore, the analysis was repeated after the small sugars were extracted by ethanol. Results are presented in FIGS. 35A and 35B.

### SEC Analysis for Polysaccharides

After fermentation, fewer molecules eluted at retention times between 10 to 15 mins which means that the oligosaccharide amounts decreased and the proportion of higher molecular weight polysaccharides increased. Over 70% of the saccharides were in the molecular weight range of 6 kDa to 1600 KDa.

The molecular weight of polysaccharides in unfermented concentrated juice ranged from 6 kDa to 113 kDa, and the most prominent peak was the one with molecular weight of ˜15 kDa. The molecular weights of polysaccharides in fermented concentrated juice by 20604 were from 19 kDa to 970 kDa and the most abundant molecules had molecular weights around 54 kDa and 410 kDa. After fermentation of concentrated juice by L. gasseri 20077, the molecular weight of the polysaccharides ranged from 4 kDa to 381 kDa, and the most abundant molecules had molecular weight around 10 kDa.

### Confocal Raman Spectroscopy Analysis

Raman Spectra of Polysaccharide Standards

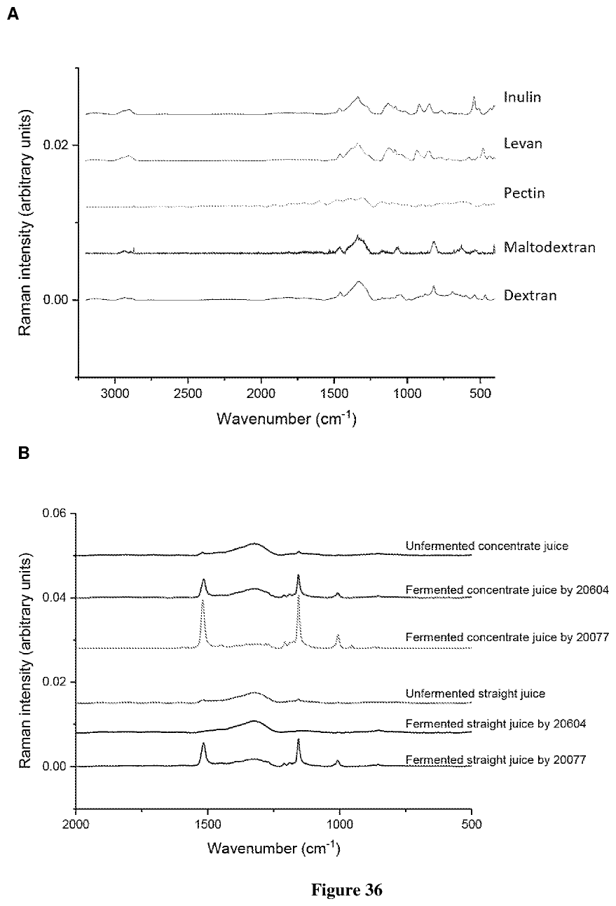

The characteristic peak assignments of the reference samples are shown in FIG. 36A. The reference Raman spectra are for the main polysaccharides that may exist in (fermented) carrot juice. These Raman spectra are further used for identification and localization of the main polysaccharides found in Raman spectra of carrot juices. The Raman spectra of inulin and levan are very similar due to their similar chemical and structural composition. The characteristic bands for inulin and levan are the bands centred around 819 and 1068 cm₋₁. The characteristic bands for dextran and maltodextrin are the bands around 1130, 1080, 918 and 840 cm⁻¹. Besides them, dextran has a band around 540 cm⁻¹ and maltodextrin has a band around 479 cm⁻¹. In brief, the prominent peaks assignments typically associated with polysaccharides (dextran and maltodextrin) included glucose-saccharide peaks at wave numbers 530-540 cm⁻¹ and peaks that are associated with the glycosidic ring deformation at 1090-1125 cm⁻¹. The symmetric stretch bands of the carboxyl ion (COO—) appearing at 1460 cm⁻¹ could also be seen in the Raman spectra of dextran and maltodextrin.

Raman Spectra of (Fermented) Carrot Juice

The Raman spectrum and the peak assignments of all these samples are presented in FIG. 36B and Table 7.

TABLE 7
Selected Raman frequencies and their peak assignments
for the spectra (Movasaghi et al., 2007).

| Wavenumber (cm^{-a}) | Assignment |
|---|---|
| 1615 | νC═C of Tyr, Trp |
| 1602 | def C═C of Phe |
| 1550 (1580-1480) | def N—H and strC—N of amide II |
| 1520 (1538-1520) | Carotene, —C═C— carotenoid |
| 1452 | def CH₂ |
| 1447 | def CH₂ |
| 1460-1440 | def CH, def CH₂ and def CH₃ |
| 1360 | Trp |
| 1337 | def CH |
| 1209 | Tryptophan& phenylalanine ν(C—C₆H₅) mode |
| 1157 | In-plane vibrations of the conjugated ═C—C═, β-carotene |
| | accumulation (C═C stretch mode) |
| 1155 | νC—C, strC—N |
| 1125-1025 | νC—C, strC—N, νCOC symmetric glucosidic link |
| 1060-1095 | C—O, C—C stretching in carbohydrates |
| 1008 | ν(CO), ν(CC), δ(OCH), ring (polysaccharides, pectin) |
| 1001 | Phe (ring breathing, sym) |
| 950 | stretching modes of amino acids and polysaccharides |
| 870 | stretching modes of amino acids and polysaccharides |
| 840-60 | Polysaccharide structure |
| 759-755 | Symmetric breathing of Trp |
| 484-490 | Glycogen |

FIG. 36B shows the spectra of the samples in the range of 2000-500 cm⁻¹. The spectra of fermented concentrated juices by 20604 and 20077 have very similar bands. However, some bands are sharper and more intense in fermented concentrated juice by 20077. The spectrum of fermented straight juice was similar to the unfermented straight juice. The most dominant bands are characteristic of mainly carotenoids or polysaccharides, which are shown in Table 6. The glucose-saccharide peak (wavenumber around 840 cm⁻¹) existed in all fermented and unfermented samples, while after fermentation the intensity of this peak became higher. This peak may not be dextran in this case, because dextran may not be present in unfermented carrot juice. Further, the wavenumber from 840 to 860 cm⁻¹ are all representative of polysaccharide structure. The bands characteristic for each polysaccharide are located closely to each other, and in the case of a polysaccharides' mixture, this would cause problems with detection due to absorbance overlapping. The two prominent peaks around 1157 and 1520 cm⁻¹ were associated with the peaks for carotene and carotenoid. After fermentation in concentrated juice by these two cells and in straight juice by 20077, increase in the intensity of the carotene peak (wavenumber 1520 cm⁻¹) was observed.

### Principal Component Analysis (PCA)

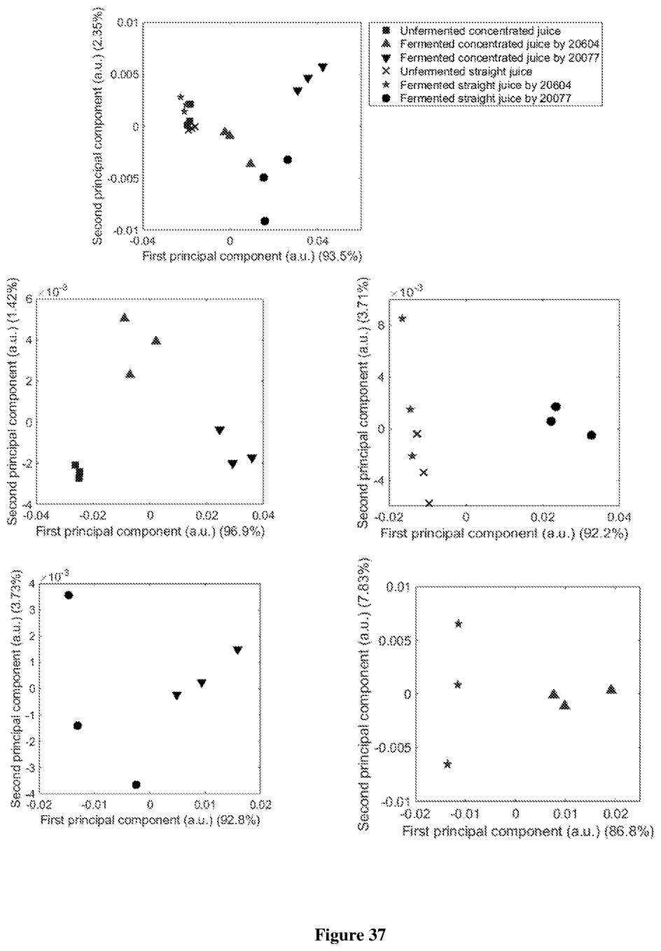

PCA was performed to extract the relevant chemical information related with the spectral alterations observed from changes in fermented carrot juice. The scores plot from PCA (FIG. 37) shows a distinct clustering of each group while there are some overlapping between unfermented juice samples and fermented straight juice by 20604 strain. The first principal components (PC1) was sufficient to differentiate the fermented concentrated juice by both strains and fermented straight juice by 20077 strain from the unfermented samples which accounted for over 93% of the variance in the data. It is clearly observed from the scores plot that (1) a clear separation between controlled unfermented (straight or concentrated) juice and fermented juice by 20077 (2) a clear separation between controlled unfermented concentrated juice and fermented juice by 20604, while there was no big difference between unfermented straight juice and fermented juice by 20604 (3) the juice concentration affects the polysaccharides produced during fermentation. The dominant spectral variation observed in the PC1 loading plot (FIG. 37) confirm that the main difference between these samples were associated with carotene, carotenoids, and v(CO), v(CC), δ(OCH), ring (representing polysaccharides including pectin).

### FTIR Analysis

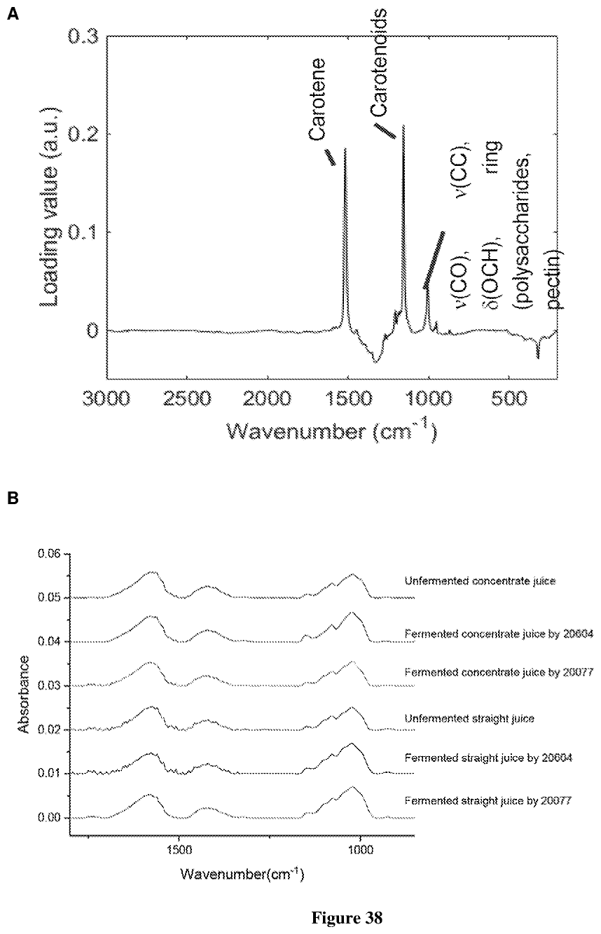

FIG. 38B shows the FTIR spectra of fermented and unfermented samples in the range of 1,800-850 cm⁻¹. It has been reported that the most preferable region of FTIR spectra for carbohydrates' analysis is 1800-850 cm⁻¹ (Szymanska-Chargot et al, 2013). The wavenumbers in the narrow region of 1800-1500 cm⁻¹ are related to the carbonyl esters' and carboxylates' vibration, which reflect the pectic substances' content. The region at 1200-850 cm⁻¹ is dominated by stretching vibrations of C—O, C—C, ring structures and deformation of CH2 groups' vibration characteristic for polysaccharides. However, the bands characteristic for each polysaccharide are located close to each other and in the case of a polysaccharides' mixture, this would cause problems with detection due to absorbance overlapping. In this case, the FTIR spectra of the all the samples seem to be very similar. This may because the water bands in all the samples were not normalized.

TABLE 8
FTIR spectral interpretations.

| Wavenumber (cm⁻¹) | Assignment |
|---|---|
| 1637 | C═C uracyl, C═O |
| 1577 | Ring C—C stretch of phenyl |
| 1419 | νₛ(COO⁻) (polysaccharides, pectin) |
| 1400 | CH³ symmetric deformation |
| 1145 | Phosphate & oligosaccharides |
| 1078 | C—OH stretching band of oligosaccharide residue |
| 1022 | Glycogen |
| 900-1350 | Phosphodiester stretching bands region |
| 835-40 | Left-handed helix DNA (Z form) |
| 600-900 | CH out-of plane bending vibrations |

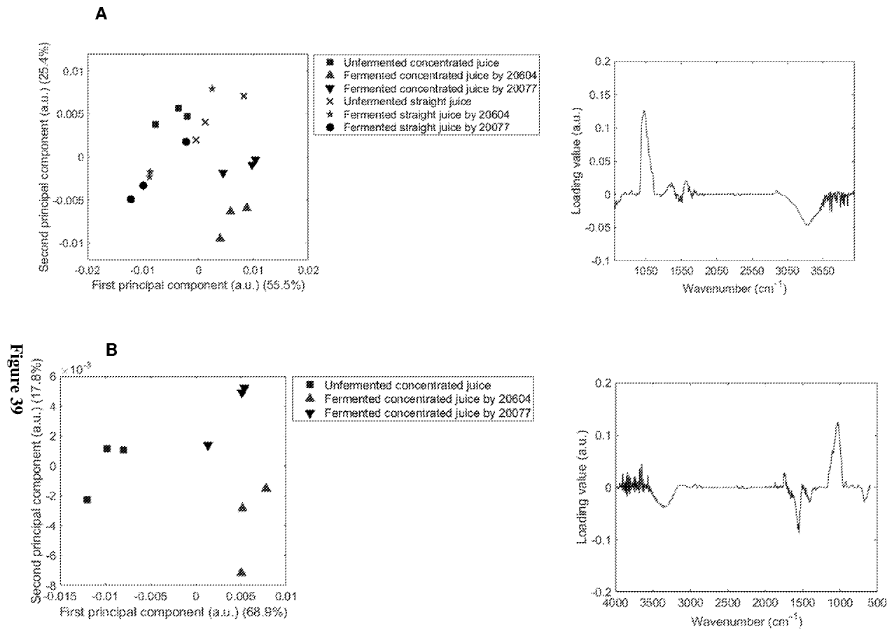

It is clearly observed from the scores plot that there is (1) a clear separation between controlled unfermented (concentrated or straight) juice and fermented juice by 20077 and (2) a clear separation between controlled unfermented concentrated juice and fermented juice by 20604, while there is no big difference between unfermented straight juice and fermented juice by 20604 (3) (FIG. 39). The juice concentration affects the polysaccharides produced during fermentation. The dominant spectral variation observed in the PC1 loading plot confirms that the main differences between these samples were C—OH bands of oligosaccharides, polysaccharide and pectin and COO— symmetric stretching (pectin ester group).

After fermentation, there was a significantly higher concentration of polysaccharides at all conditions. After fermentation by 20604, the abundant polysaccharides had molecular weight of 10 kDa and 200 kDa. The dominant polysaccharides after fermentation by 20077 had molecular weight of 54 kDa and 410 kDa. After fermentation of concentrated carrot juice by the two strains, their polysaccharides' structures differed substantially while after straight juice fermentation by 20604, the structure of the polysaccharides were similar to the unfermented juice.

### Change in Titratable Acidity of Carrot During Fermentation

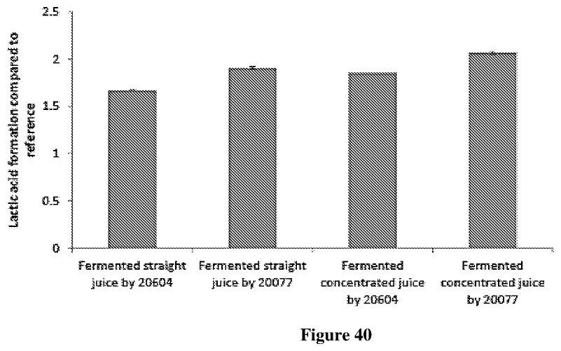

Titratable acidity is an important quality attribute, which determines the sensory quality and acceptability of beverages. As L. gasseri would produce lactic acid during fermentation, it can lead to changes in the titratable acidity of the product. The titratable acidity of juice before and after fermentation was tested and presented as the ratio of titratable acidity fermented juice to that of a reference unfermented juice (FIG. 40).

The pH of the juices decreased and their titratable acidity increased significantly after fermentation. The highest increase in titratable acidity was observed in the fermented concentrated juice by 20077 indicating that lactic acid formation was higher in concentrated juice. After fermentation, the pH of fermented straight juice and fermented concentrated juice were around 5 and 5.1, respectively. Titratable acidity measures the overall acidity of the product including the acidity from malic acid and critic acid that are naturally present in carrot juice. Fermentation by L. gasseri leads to the production of lactic acid, while the organisms also metabolise malic acid into lactic acid. Lactic acid is a monocarboxylic acid while malic acid is a dicarboxylic acid contributing twice to titratable acidity compared to lactic acid. The lower increase in acidity in straight carrot juice could be due to a higher level of malic acid conversion to lactic acid during fermentation of straight juice.

### Effect of Microwave Post-Processing on the Composition of Fermented Carrot Juice

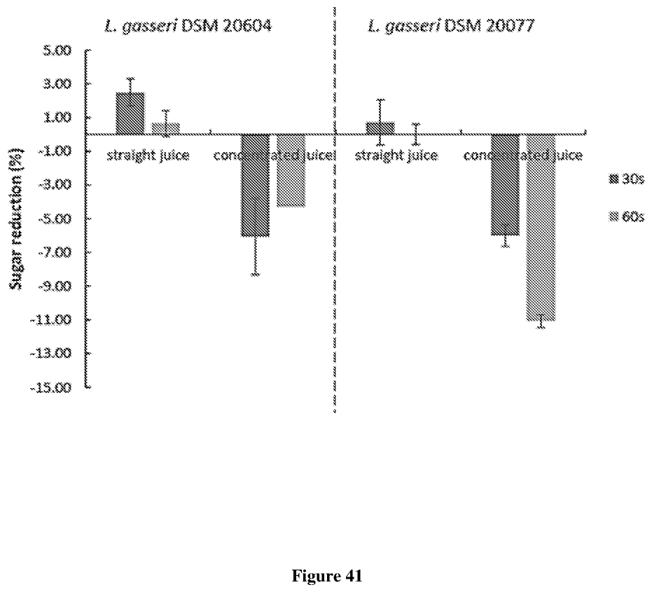

Straight carrot juice and concentrated carrot juice were fermented by L. gasseri DSM 20604 and L. gasseri DSM 20077 at 30° C. for 24 hours. After fermentation, samples were treated by microwave for 30 s and 60 s. After treatment for 30 s and 60 s, the samples temperatures were around 45° C. and 65° C., respectively. The total sugar reduction after treatment was evaluated and shown in the FIG. 41.

The present application claims priority from AU 2017904938 filed 7 Dec. 2017, the entire contents of which are incorporated herein by reference.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

All publications discussed and/or referenced herein are incorporated herein in their entirety.

Any discussion of documents, acts, materials, devices, articles or the like which has been included in the present specification is solely for the purpose of providing a context for the present invention. It is not to be taken as an admission that any or all of these matters form part of the prior art base or were common general knowledge in the field relevant to the present invention as it existed before the priority date of each claim of this application.

### REFERENCES

Da Silva et al (2014) Journal of Food Science and Technology, 51(9), 2078-2084.
Dominguez et al (2014) Food and Bioprocess Technology, 7(2), 324-337.
Dubois et al (1956) Anal Chem, 28, 350-356.
Gose et al (2016) British Journal of Nutrition, 115(8), 1498-1507.
Gunners (2016) Fruit juice is just as bad as soda. Retrieved from: https://authoritynutrition.com/fruit-juice-is-just-as-bad-as-soda/
Huang et al (2011) “Extraction and deproteinization of pumpkin polysaccharide, 62(6), 568-571.
Honorato et al (2007) World Journal of Microbiology and Biotechnology, 23(10), 1409-1415.
Malik et al (2010) Circulation, 121(11), 1356-1364.
Mattes and Campbell (2009) Journal of the American Dietetic Association, 109(3), 430-437.
McCleskey et al (1947) Journal of Bacteriology, 54(6), 697.
OECD, (2005) Guidance on objective tests to determine quality of fruits and vegetables and dry and dried produce. Retrieved from: https://www.oecd.org/tad/code/19515719.pdf
Miller et al (1959) Anal Chem, 31, 426-428.
Movasaghi et al (2007) Appl Spectrosc Rev, 42, 493-541.
Olvera et al (2007) Antonie van Leeuwenhoek, 92(1), 11-20.
Piñeiro et al (2008) Ecological Modelling, 216(3), 316-322.
Rehm et al (2016) JAMA, 315(23), 2542-2553.
Ridoutt et al (2016) National Nutrition Survey Results Disaggregated into Basic Foods,
Foods, 5 (2), DOI: 10.3390/foods5020040
Szymanska-Chargot et al (2013) Food Biophys, 8(1), 29-42.
Rodrigues et al (2003) Bioprocess and Biosystems Engineering, 26(1), 57-62.
Scalbert et al (2005) Critical Reviews in Food Science and Nutrition, 45(4), 287-306.
van Hijum et al (2006) Microbiol Mol Biol Rev, 70(1), 157-176.
Yasuda et al (2017) Journal of Food Engineering, 211, 15-21.
Zhao et al (2016) Journal of Functional foods, (20), 182-194.

1. A method of preparing a sugar reduced product from a biomass comprising:
i) treating the biomass with fermentation enzymes to reduce the sugar concentration; and
ii) post-treating the material obtained by step i) to further reduce the sugar concentration.

2. The method of claim 1, wherein step i) comprises fermentation of the biomass with one or more bacteria selected from lactic acid, acetic acid, propionic acid and bifido bacteria.

3. The method of claim 2, wherein the fermentation is anaerobic.

4. The method of claim 2 or claim 3, wherein the bacteria are removed after step i) or step ii).

5. The method of any one of claims 1 to 4, wherein the fermentation enzymes are produced by one or more of lactic acid, acetic acid, propionic and bifido bacteria cultured in biomass before step i).

6. The method of any one of claims 1 to 5, wherein post-treating comprises one or more of the following:
i) microwaving,
ii) heating,
iii) exposure to high frequency sound waves (ultrasound), and
iv) exposure to high hydrostatic pressure.

7. The method of claim 6, wherein post-treating increases the activity of the fermentation enzymes.

8. The method of claim 6, wherein heating comprises high temperature short time (HTST).

9. The method of claim 8, wherein HTST is at about 100° C. for about 5 to about 20 seconds.

10. The method of any one of claims 1 to 7, wherein the post-treating comprises microwaving for at least 1 minute.

11. The method of claim 6, wherein high hydrostatic pressure comprises treatment with 150 to 800 MPa.

12. The method of any one of claims 1 to 11, wherein the sugar in the material obtained in step i) is reduced by about 10 to about 70% compared to the biomass.

13. The method of any one of claims 1 to 12, wherein the sugar in the material obtained in step ii) is reduced by about 5 to about 50% compared to the sugar in the material obtained in step i).

14. The method of any one of claims 1 to 11, wherein the sugar in the material obtained by step ii) is reduced by at least 30%, or at least 40%, or at least 50%, or at least 60% compared to the biomass.

15. The method of any one claims 1 to 14, wherein the sugar is one or more or all of sucrose, glucose, fructose and lactose.

16. The method of any one of claims 1 to 15, wherein the sugar is sucrose.

17. The method of any one of claims 1 to 16, wherein the concentration of an oligosaccharide is increased in the material obtained by step ii) compared to the biomass.

18. The method of claim 17, wherein the oligosaccharide is selected from one or more or all of:
i) a gluco-oligosaccharide,
ii) a fructo-oligosaccharide,
iii) a isomalto-oligosaccharide; and
iv) galactoooligosaccahride.

19. The method of claim 18, wherein the isomalto-oligosaccharide is panose.

20. The method of any one of claims 1 to 19, wherein the concentration of a polysaccharide is increased in the material obtained by step ii) compared to the biomass.

21. The method of claim 20, wherein the polysaccharide is selected from one or more of: dextran, levan and inulin type fructans.

22. The method of any one of claims 1 to 21, wherein the concentration of one or more of: mannitol, isomaltose and isomaltotriose is increased in the material obtained by step ii) compared to the biomass.

23. The method of any one of claims 1 to 22, wherein the fermentation enzymes were produced by one or more of lactic acid, acetic acid, propionic acid and bifido bacteria.

24. The method of any one of claims 1 to 23, wherein fermentation enzymes comprise one or more or all of:
i) glycosyltransferase,
ii) glycosidase or aryl glycosidase,
iii) pectinase,
iv) esterase,
v) decarboxylase,
vi) tannase, and
vii) oxidoreductase.

25. The method of claim 24, wherein the glycosyltransferase is selected from one or more or all of:
i) dextransucrase,
ii) levansucrase,
iii) inulosucrase
iv) alternansucrase,
v) fructosyltransferases, and
vi) β-galactosidase.

26. The method of claim 24, wherein the oxidoreductase is mannitol dehydrogenase.

27. The method of any one of claims 1 to 26, wherein the concentration of carotenoid is increased in the material obtained by step ii) compared to the biomass.

28. The method of any one of claims 2 to 27, wherein the lactic acid bacteria is from one or more of the Genera Lactobacillus, Leuconostoc, Pediococcus, Lactococcus, Streptococcus, Aerococcus, Carnobacterium, Enterococcus, Oenococcus, Fructobacillus, Fructobacillus Sporolactobacillus, Tetragenococcus, Vagococcus and Weissella.

29. The method of claim 28, wherein the lactic acid bacteria is selected from one or more of Leuconostoc mesenteroides, Lactobacillus reuteri, Lactobacillus gasseri and Lactococus lactis.

30. The method of claim 29, wherein the lactic acid bacteria is Leuconostoc mesenteroides.

31. The method of claim 30, wherein the Leuconostoc mesenteroides is selected from:
i) ATCC 8293;
ii) NRRL B-512F;
iii) BF1 deposited under V17/021729 on 25 Sep. 2017 at the National Measurement Institute Australia; and
iv) BF2 deposited under V17/021730 on 25 Sep. 2017 at the National Measurement Institute Australia.

32. The method of any one of claims 2 to 31, wherein the acetic acid bacteria is Acetobacteraceae.

33. The method of claim 32, wherein the Acetobacteraceae is Gluconacetobacter.

34. The method of any one claims 2 to 33, wherein fermentation is for at least 24 hours.

35. The method of any one claims 2 to 34, wherein fermentation is at a pH of about 5 to about 6.

36. The method of any one of claims 1 to 35, wherein the biomass is a plant material selected from one or more of: a fruit, vegetable, grass, nut, legume or grass.

37. The method of claim 36 where the plant material is selected from one or more of: juice, juice concentrate, puree, reconstituted fruit or vegetable powder, rehydrated dried fruit pieces, sugary fraction of fruit and vegetable processing, milk, milk concentrate, whey, permeate, retentate, juice, juice concentrate, puree, whole or chopped plant material.

38. The method of any one of claims 1 to 36, wherein the biomass is selected from: animal milk, animal milk concentrate or a product produced thereof.

39. The method of claim 36 or claim 37, wherein the fruit is from a family selected from one or more of: Arecaceae, Myrtaceae, Rosaceae, Musaceae, Ericaceae, Saxifragaceae, Cucurbitaceae, Nightshade, Capparaceae, Adoxaceae, Vitaceae, Rutaceae, Actinidiaceae, Sapindaceae, Anacardiaceae, Moraceae, Oleaceae, Cactaceae, Passifloraceae, Bromeliaceae, Cactaceae, Lythraceae, Polygonaceae, Oxalidaceae and Caesalpinioideae.

40. The method of claim 39, wherein the family is Rosaceae.

41. The method of claim 40, wherein the Rosaceae is an apple.

42. The method of claim 36, wherein the fruit is grape or orange.

43. The method of claim 36 or claim 37, wherein the vegetable is from a family selected from one or more of: Brassicaceae, Amarylidaceae, Asparagaceae, Polygonaceae, Compositae, Amaranthaceae, Chenopodiacae, Cucurbitaceae, Leguminosae, Malvaceae, Convolvulaceae, Solanaceae and Umbelliferae.

44. The method of claim 36 or claim 37, wherein the grass is from the family Poaceae.

45. The method of any one of claims 1 to 44, wherein one of more of the following is added before, during or after step i):
i) calcium,
ii) nitrogen,
iii) phosphate,
iv) maltose, and
v) isomaltose.

46. The method of any one of claims 1 to 45, wherein the method does not comprise the addition of sucrose.

47. The method of any one of claims 1 to 46, further comprising pre-treating the biomass before step i).

48. The method of claim 47, wherein pre-treating comprises one or more of:
i) microwaving,
ii) heating,
iii) exposure to high frequency sound waves (ultrasound),
iv) exposure to high hydrostatic pressure,
v) pulse electric field processing, and
vi) exposure to shockwaves.

49. The method of any one of claims 1 to 48, wherein the product from step i) is combined with a juice or a juice base before step ii).

50. A method of preparing a sugar reduced product from carrot biomass comprising treating the biomass with fermentation enzymes to reduce the sugar concentration and increase the carotenoid concentration.

51. The method of claim 50, wherein the fermentation enzymes are from Leuconostoc mesenteroides or Lactobacillus gasseri.

52. The method of claim 51, wherein treating with fermentation enzymes comprises fermentation.

53. A method of preparing fermentation enzymes for reducing the sugar concentration of a biomass comprising:
i) inoculating the biomass with one or more bacteria selected from lactic acid, acetic acid, propionic acid and bifido bacteria which have previously been cultured in biomass,
ii) fermenting for a sufficient time for fermentation enzymes to be produced,
iii) removing the bacteria or isolating fermentation enzymes secreted by the bacteria or removing the bacteria.

54. A sugar reduced product produced by the method of any one of claims 1 to 52.

55. The product of claim 54, wherein the product is juice, juice concentrate, milk, milk concentrate, puree, fruit and/or vegetable pieces or a powder.

56. The product of claim 55, wherein the juice or concentrate is apple juice or apple concentrate.

57. The product of any one of claims 54 to 56, wherein the product comprises about 40 to about 80 g/L of total sugar.

58. The product of any one of claims 54 to 57, wherein the total sugar in the product is reduced by about 30% to about 60% compared to the biomass.

59. The product of any one of claims 54 to 58, wherein the product is a pro-biotic and/or pre-biotic.

60. The product of claim 59, wherein the product is a food, supplement, or animal feed.

61. The product of claim 54, wherein the product is a sweetener.

62. The product of claim 61, wherein the sweetener is low sugar.
